(19) United States
(12) Patent Application Publication
(10) Pub. No.: US 2007/0238848 A1
(43) Pub. Date: Oct. 11, 2007

(54) High impact poly (urethane urea) polysulfides

(76) Inventors: Nina V. Bojkova, Monroeville, PA (US); Robert A. Smith, Murrysville, PA (US); Robert D. Herold, Monroeville, PA (US); Chandra B. Rao, Valencia, CA (US); William H. McDonald, Mars, PA (US); Vidhu J. Nagpal, Murrysville, PA (US); Marvin J. Graham, Monroeville, PA (US); Phillip C. Yu, Murrysville, PA (US); Suresh G. Sawant, Stevenson Ranch, CA (US); Michael O. Okoroafor, Roswell, GA (US)

Correspondence Address: PPG Industries, Inc., 39th Floor, One PPG Place, Pittsburgh, PA, 15272-0001, US

(21) Appl. No.: 11/303,832

(22) Filed: Dec. 16, 2005

Related U.S. Application Data
(63) Continuation-in-part of application No. 11/141,636, filed on May 31, 2005, now abandoned.
(63) Continuation-in-part of application No. 10/287,716, filed on Nov. 5, 2002, now abandoned.
(63) Continuation-in-part of application No. 10/725,023, filed on Dec. 2, 2003, now abandoned.
(60) Provisional application No. 60/435,537, filed on Dec. 20, 2002.
(60) Provisional application No. 60/332,829, filed on Nov. 16, 2001.

(51) Int. Cl. C08G 18/00

(52) U.S. Cl. 528/44

(57) ABSTRACT

The present invention relates to a sulfur-containing polyureaurethane and a method of preparing said polyureaurethane. In an embodiment, the sulfur-containing polyureaurethane adapted to have a refractive index of at least 1.57, an Abbe number of at least 32 and a density of less than 1.3 grams/cm³, when at least partially cured.

This application is a continuation-in-part application of U.S. patent applications having Ser. Nos. 11/141,636, 10/287,716 and 10/725,023, filed on May 31, 2005, Nov. 5, 2002 and Dec. 2, 2003, respectively; and claims priority from Provisional Patent Applications having Ser. Nos. 60/435,537 and 60/332,829, filed on Dec. 20, 2002 and Nov. 16, 2001, respectively.

The present invention relates to sulfur-containing polyureaurethanes and methods for their preparation.

A number of organic polymeric materials, such as plastics, have been developed as alternatives and replacements for glass in applications such as optical lenses, fiber optics, windows and automotive, nautical and aviation transparencies. These polymeric materials can provide advantages relative to glass, including, shatter resistance, lighter weight for a given application, ease of molding and ease of dying. However, the refractive indices of many polymeric materials are generally lower than that of glass. In ophthalmic applications, the use of a polymeric material having a lower refractive index will require a thicker lens relative to a material having a higher refractive index. A thicker lens is not desirable.

Thus, there is a need in the art to develop a polymeric material having an adequate refractive index and good impact resistance/strength.

The present invention is directed to a sulfur-containing polyureaurethane when at least partially cured having a refractive index of at least 1.55, or at least 1.56, or at least 1.57, or at least 1.58, or at least 1.59, or at least 1.60, or at least 1.62, or at least 1.65; an Abbe number of at least 32 and a density of at least 1.0, or at least 1.1, or less than 1.2 grams/cm³, or less than 1.3 grams/cm³.

As used herein and the claims, curing of a polymerizable composition refers to subjecting said composition to curing conditions such as but not limited to thermal curing, leading to the reaction of the reactive end-groups of said composition, and resulting in polymerization and formation of a solid polymerizate. When a polymerizable composition is subjected to curing conditions, following polymerization and after reaction of most of the reactive end groups occurs, the rate of reaction of the remaining unreacted reactive end groups becomes progressively slower. In a non-limiting embodiment, the polymerizable composition can be subjected to curing conditions until it is at least partially cured. The term “at least partially cured” means subjecting the polymerizable composition to curing conditions, wherein reaction of at least a portion of the reactive end-groups of said composition occurs, to form a solid polymerizate, such that said polymerizate can be demolded, and cut into test pieces, or such that it may be subjected to machining operations, including optical lens processing.

In a non-limiting embodiment, the polymerizable composition can be subjected to curing conditions, such that a substantially complete cure is attained and wherein further curing results in no significant further improvement in polymer properties, such as hardness.

For the purposes of this specification, unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

In a non-limiting embodiment, the sulfur-containing polyureaurethane of the present invention can be prepared by combining polyisocyanate and/or polyisothiocyanate; active hydrogen-containing material, and amine-containing curing agent.

As used herein and the claims, the terms “isocyanate” and “isothiocyanate” include unblocked compounds capable of forming a covalent bond with a reactive group such as a thiol, hydroxyl, or amine functional group. In alternate non-limiting embodiments the polyisocyanate of the present invention can contain at least two functional groups chosen from isocyanate (NCO), the polyisothiocyanate can contain at least two functional groups chosen from isothiocyanate (NCS), and the isocyanate and isothiocyanate materials can each include combinations of isocyanate and isothiocyanate functional groups.

In alternate non-limiting embodiments, the polyureaurethane of the invention when polymerized can produce a polymerizate having a refractive index of at least 1.55, or at least 1.56, or at least 1.57, or at least 1.58, or at least 1.59, or at least 1.60, or at least 1.62, or at least 1.65. In further alternate non-limiting embodiments, the polyureaurethane of the invention when polymerized can produce a polymerizate having an Abbe number of at least 32, or at least 35, or at least 38, or at least 39, or at least 40, or at least 44. The refractive index and Abbe number can be determined by methods known in the art such as American Standard Test Method (ASTM) Number D 542-00. Further, the refractive index and Abbe number can be determined using various known instruments. In a non-limiting embodiment of the present invention, the refractive index and Abbe number can be measured in accordance with ASTM D 542-00 with the following exceptions: (i) test one to two samples/specimens instead of the minimum of three specimens specified in Section 7.3; and (ii) test the samples unconditioned instead of conditioning the samples/specimens prior to testing as specified in Section 8.1. Further, in a non-limiting embodiment, an Atago, model DR-M2 Multi-Wavelength Digital Abbe Refractometer can be used to measure the refractive index and Abbe number of the samples/specimens.

In a non-limiting embodiment, the sulfur-containing polyureaurethane of the present invention can be prepared by reacting polyisocyanate and/or polyisothiocyanate with active hydrogen-containing material selected from polyol, polythiol, or combination thereof, to form polyurethane prepolymer or sulfur-containing polyurethane prepolymer; and chain extending (i.e., reacting) said prepolymer with amine containing curing agent, wherein said amine-containing curing agent optionally includes active hydrogen-containing material selected from polyol, polythiol, or combination thereof.

In alternate non-limiting embodiments, the amount of polyisocyanate and the amount of active hydrogen-containing material used to prepare isocyanate terminated polyurethane prepolymer or sulfur-containing polyurethane prepolymer can be selected such that the equivalent ratio of (NCO):(SH+OH) can be greater than 1.0:1.0, or at least 2.0:1.0, or at least 2.5:1.0, or less than 4.5:1.0, or less than 5.5:1.0; or the amount of polyisothiocyanate and the amount of active hydrogen-containing material used to prepare isothiocyanate terminated sulfur-containing polyurethane prepolymer can be selected such that the equivalent ratio of (NCS):(SH+OH) can be greater than 1.0:1.0, or at least 2.0:1.0, or at least 2.5:1.0, or less than 4.5:1.0, or less than 5.5:1.0; or the amount of a combination of polyisothiocyanate and polyisocyanate and the amount of active hydrogen-containing material used to prepare isothiocyanate/isocyanate terminated sulfur-containing polyurethane prepolymer can be selected such that the equivalent ratio of (NCS+NCO):(SH+OH) can be greater than 1.0:1.0, or at least 2.0:1.0, or at least 2.5:1.0, or less than 4.5:1.0, or less than 5.5:1.0

In a non-limiting embodiment, the amount of isocyanate terminated polyurethane prepolymer or sulfur-containing prepolymer and the amount of amine-containing curing agent used to prepare sulfur-containing polyureaurethane can be selected such that the equivalent ratio of (NH+SH+OH):(NCO) can range from 0.80:1.0 to 1.1:1.0, or from 0.85:1.0 to 1.0:1.0, or from 0.90:1.0 to 1.0:1.0, or from 0.90:1.0 to 0.95:1.0, or from 0.95:1.0 to 1.0:1.0.

In another non-limiting embodiment, the amount of isothiocyanate or isothiocyanate/isocyanate terminated sulfur-containing polyurethane prepolymer and the amount of amine-containing curing agent used to prepare sulfur-containing polyureaurethane can be selected such that the equivalent ratio of (NH+SH+OH):(NCO+NCS) can range from 0.80:1.0 to 1.1:1.0, or from 0.85:1.0 to 1.0:1.0, or from 0.90:1.0 to 1.0:1.0, or from 0.90:1.0 to 0.95:1.0, or from 0.95:1.0 to 1.0:1.0.

Polyisocyanates and polyisothiocyanates useful in the preparation of the polyureaurethane of the present invention are numerous and widely varied. Suitable polyisocyanates for use in the present invention can include but are not limited to polymeric and C₂-C₂₀ linear, branched, cycloaliphatic and aromatic polyisocyanates. Suitable polyisothiocyanates for use in the present invention can include but are not limited to polymeric and C₂-C₂₀ linear, branched, cyclic and aromatic polyisothiocyanates. Non-limiting examples can include polyisocyanates and polyisothiocyanates having backbone linkages chosen from urethane linkages (—NH—C(O)—O—), thiourethane linkages (—NH—C(O)—S—), thiocarbamate linkages (—NH—C(S)—O—), dithiourethane linkages (—NH—C(S)—S—) and combinations thereof.

The molecular weight of the polyisocyanate and polyisothiocyanate can vary widely. In alternate non-limiting embodiments, the number average molecular weight (Mn) of each can be at least 100 grams/mole, or at least 150 grams/mole, or less than 15,000 grams/mole, or less than 5000 grams/mole. The number average molecular weight can be determined using known methods. The number average molecular weight values recited herein and the claims were determined by gel permeation chromatography (GPC) using polystyrene standards.

Non-limiting examples of suitable polyisocyanates and polyisothiocyanates can include but are not limited to polyisocyanates having at least two isocyanate groups; polyisothiocyanates having at least two isothiocyanate groups; mixtures thereof; and combinations thereof, such as a material having isocyanate and isothiocyanate functionality.

Non-limiting examples of polyisocyanates can include but are not limited to aliphatic polyisocyanates, cycloaliphatic polyisocyanates wherein one or more of the isocyanato groups are attached directly to the cycloaliphatic ring, cycloaliphatic polyisocyanates wherein one or more of the isocyanato groups are not attached directly to the cycloaliphatic ring, aromatic polyisocyanates wherein one or more of the isocyanato groups are attached directly to the aromatic ring, and aromatic polyisocyanates wherein one or more of the isocyanato groups are not attached directly to the aromatic ring. When an aromatic polyisocyanate is used, generally care should be taken to select a material that does not cause the polyureaurethane to color (e.g., yellow).

In a non-limiting embodiment of the present invention, the polyisocyanate can include but is not limited to aliphatic or cycloaliphatic diisocyanates, aromatic diisocyanates, cyclic dimers and cyclic trimers thereof, and mixtures thereof. Non-limiting examples of suitable polyisocyanates can include but are not limited to Desmodur N 3300 (hexamethylene diisocyanate trimer) which is commercially available from Bayer; Desmodur N 3400 (60% hexamethylene diisocyanate dimer and 40% hexamethylene diisocyanate trimer).

In a non-limiting embodiment, the polyisocyanate can include dicyclohexylmethane diisocyanate and isomeric mixtures thereof. As used herein and the claims, the term “isomeric mixtures” refers to a mixture of the cis-cis, trans-trans, and cis-trans isomers of the polyisocyanate. Non-limiting examples of isomeric mixtures for use in the present invention can include the trans-trans isomer of 4,4′-methylenebis(cyclohexyl isocyanate), hereinafter referred to as “PICM” (paraisocyanato cyclohexylmethane), the cis-trans isomer of PICM, the cis-cis isomer of PICM, and mixtures thereof.

In one non-limiting embodiment, three suitable isomers of 4,4′-methylenebis(cyclohexyl isocyanate) for use in the present invention are shown below.

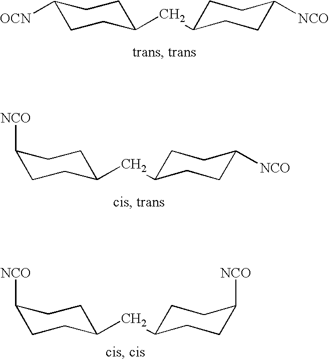

In one non-limiting embodiment, the PICM used in this invention can be prepared by phosgenating the 4,4′-methylenebis(cyclohexyl amine) (PACM) by procedures well known in the art such as the procedures disclosed in U.S. Pat. Nos. 2,644,007 and 2,680,127 which are incorporated herein by reference. The PACM isomer mixtures, upon phosgenation, can produce PICM in a liquid phase, a partially liquid phase, or a solid phase at room temperature. The PACM isomer mixtures can be obtained by the hydrogenation of methylenedianiline and/or by fractional crystallization of PACM isomer mixtures in the presence of water and alcohols such as methanol and ethanol.

In a non-limiting embodiment, the isomeric mixture can contain from 10-100 percent of the trans,trans isomer of 4,4′-methylenebis(cyclohexyl isocyanate)(PICM).

Additional aliphatic and cycloaliphatic diisocyanates that can be used in alternate non-limiting embodiments of the present invention include 3-isocyanato-methyl-3,5,5-trimethyl cyclohexyl-isocyanate (“IPDI”) which is commercially available from Arco Chemical, and meta-tetramethylxylylene diisocyanate (1,3-bis(1-isocyanato-1-methylethyl)-benzene) which is commercially available from Cytec Industries Inc. under the tradename TMXDI® (Meta) Aliphatic Isocyanate.

As used herein and the claims, the terms aliphatic and cycloaliphatic diisocyanates refer to 6 to 100 carbon atoms linked in a straight chain or cyclized having two diisocyanate reactive end groups. In a non-limiting embodiment of the present invention, the aliphatic and cycloaliphatic diisocyanates for use in the present invention can include TMXDI and compounds of the formula R—(NCO)₂ wherein R represents an aliphatic group or a cycloaliphatic group.

Further non-limiting examples of suitable polyisocyanates and polyisothiocyanates can include but are not limited to aliphatic polyisocyanates and polyisothiocyanates; ethylenically unsaturated polyisocyanates and polyisothiocyanates; alicyclic polyisocyanates and polyisothiocyanates; aromatic polyisocyanates and polyisothiocyanates wherein the isocyanate groups are not bonded directly to the aromatic ring, e.g., α,α′-xylylene diisocyanate; aromatic polyisocyanates and polyisothiocyanates wherein the isocyanate groups are bonded directly to the aromatic ring, e.g., benzene diisocyanate; aliphatic polyisocyanates and polyisothiocyanates containing sulfide linkages; aromatic polyisocyanates and polyisothiocyanates containing sulfide or disulfide linkages; aromatic polyisocyanates and polyisothiocyanates containing sulfone linkages; sulfonic ester-type polyisocyanates and polyisothiocyanates, e.g., 4-methyl-3-isocyanatobenzenesulfonyl-4′-isocyanato-phenol ester; aromatic sulfonic amide-type polyisocyanates and polyisothiocyanates; sulfur-containing heterocyclic polyisocyanates and polyisothiocyanates, e.g., thiophene-2,5-diisocyanate; halogenated, alkylated, alkoxylated, nitrated, carbodiimide modified, urea modified and biuret modified derivatives of polycyanates thereof; and dimerized and trimerized products of polycyanates thereof.

In a further non-limiting embodiment, a material of the following general formula (I) can be used: 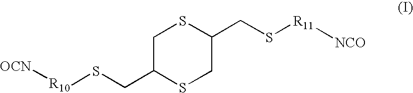
wherein R₁₀ and R₁₁ are each independently C₁ to C₃ alkyl.

Further non-limiting examples of aliphatic polyisocyanates can include ethylene diisocyanate, trimethylene diisocyanate, tetramethylene diisocyanate, hexamethylene diisocyanate, octamethylene diisocyanate, nonamethylene diisocyanate, 2,2′-dimethylpentane diisocyanate, 2,2,4-trimethylhexane diisocyanate, decamethylene diisocyanate, 2,4,4,-trimethylhexamethylene diisocyanate, 1,6,11-undecanetriisocyanate, 1,3,6-hexamethylene triisocyanate, 1,8-diisocyanato-4-(isocyanatomethyl)octane, 2,5,7-trimethyl-1,8-diisocyanato-5-(isocyanatomethyl)octane, bis(isocyanatoethyl)-carbonate, bis(isocyanatoethyl)ether, 2-isocyanatopropyl-2,6-diisocyanatohexanoate, lysinediisocyanate methyl ester and lysinetriisocyanate methyl ester.

Examples of ethylenically unsaturated polyisocyanates can include but are not limited to butene diisocyanate and 1,3-butadiene-1,4-diisocyanate. Alicyclic polyisocyanates can include but are not limited to isophorone diisocyanate, cyclohexane diisocyanate, methylcyclohexane diisocyanate, bis(isocyanatomethyl)cyclohexane, bis(isocyanatocyclohexyl)methane, bis(isocyanatocyclohexyl)-2,2-propane, bis(isocyanatocyclohexyl)-1,2-ethane, 2-isocyanatomethyl-3-(3-isocyanatopropyl)-5-isocyanatomethyl-bicyclo[2.2.1]-heptane, 2-isocyanatomethyl-3-(3-isocyanatopropyl)-6-isocyanatomethyl-bicyclo[2.2.1]-heptane, 2-isocyanatomethyl-2-(3-isocyanatopropyl)-5-isocyanatomethyl-bicyclo[2.2.1]-heptane, 2-isocyanatomethyl-2-(3-isocyanatopropyl)-6-isocyanatomethyl-bicyclo[2.2.1]-heptane, 2-isocyanatomethyl-3-(3-isocyanatopropyl)-6-(2-isocyanatoethyl)-bicyclo[2.2.1]-heptane, 2-isocyanatomethyl-2-(3-isocyanatopropyl)-5-(2-isocyanatoethyl)-bicyclo[2.2.1]-heptane and 2-isocyanatomethyl-2-(3-isocyanatopropyl)-6-(2-isocyanatoethyl)-bicyclo[2.2.1]-heptane.

Examples of aromatic polyisocyanates wherein the isocyanate groups are not bonded directly to the aromatic ring can include but are not limited to bis(isocyanatoethyl)benzene, α,α,α′,α′-tetramethylxylylene diisocyanate, 1,3-bis(1-isocyanato-1-methylethyl)benzene; bis(isocyanatobutyl)benzene, bis(isocyanatomethyl)naphthalene, bis(isocyanatomethyl)diphenyl ether, bis(isocyanatoethyl) phthalate, mesitylene triisocyanate and 2,5-di(isocyanatomethyl)furan, and meta-xylylene diisocyanate. Aromatic polyisocyanates having isocyanate groups bonded directly to the aromatic ring can include but are not limited to phenylene diisocyanate, ethylphenylene diisocyanate, isopropylphenylene diisocyanate, dimethylphenylene diisocyanate, diethylphenylene diisocyanate, diisopropylphenylene diisocyanate, trimethylbenzene triisocyanate, benzene triisocyanate, naphthalene diisocyanate, methylnaphthalene diisocyanate, biphenyl diisocyanate, ortho-toluidine diisocyanate, ortho-tolylidine diisocyanate, ortho-tolylene diisocyanate, 4,4′-diphenylmethane diisocyanate, bis(3-methyl-4-isocyanatophenyl)methane, bis(isocyanatophenyl)ethylene, 3,3′-dimethoxy-biphenyl-4,4′-diisocyanate, triphenylmethane triisocyanate, polymeric 4,4′-diphenylmethane diisocyanate, naphthalene triisocyanate, diphenylmethane-2,4,4′-triisocyanate, 4-methyldiphenylmethane-3,5,2′,4′,6′-pentaisocyanate, diphenylether diisocyanate, bis(isocyanatophenylether)ethyleneglycol, bis(isocyanatophenylether)-1,3-propyleneglycol, benzophenone diisocyanate, carbazole diisocyanate, ethylcarbazole diisocyanate and dichlorocarbazole diisocyanate.

Further non-limiting examples of aliphatic and cycloaliphatic diisocyanates that can be used in the present invention include 3-isocyanato-methyl-3,5,5-trimethyl cyclohexyl-isocyanate (“IPDI”) which is commercially available from Arco Chemical, and meta-tetramethylxylene diisocyanate (1,3-bis(1-isocyanato-1-methylethyl)-benzene) which is commercially available from Cytec. Industries Inc. under the tradename TMXDI® (Meta) Aliphatic Isocyanate.

In a non-limiting embodiment of the present invention, the aliphatic and cycloaliphatic diisocyanates for use in the present invention can include TMXDI and compounds of the formula R—(NCO)₂ wherein R represents an aliphatic group or a cycloaliphatic group.

Non-limiting examples of polyisocyanates can include aliphatic polyisocyanates containing sulfide linkages such as thiodiethyl diisocyanate, thiodipropyl diisocyanate, dithiodihexyl diisocyanate, dimethylsulfone diisocyanate, dithiodimethyl diisocyanate, dithiodiethyl diisocyanate, dithiodipropyl diisocyanate and dicyclohexylsulfide-4,4′-diisocyanate. Non-limiting examples of aromatic-polyisocyanates containing sulfide or disulfide linkages include but are not limited to diphenylsulfide-2,4′-diisocyanate, diphenylsulfide-4,4′-diisocyanate, 3,3′-dimethoxy-4,4′-diisocyanatodibenzyl thioether, bis(4-isocyanatomethylbenzene)-sulfide, diphenyldisulfide-4,4′-diisocyanate, 2,2′-dimethyldiphenyldisulfide-5,5′-diisocyanate, 3,3′-dimethyldiphenyldisulfide-5,5′-diisocyanate, 3,3′-dimethyldiphenyldisulfide-6,6′-diisocyanate, 4,4′-dimethyldiphenyldisulfide-5,5′-diisocyanate, 3,3′-dimethoxydiphenyldisulfide-4,4′-diisocyanate and 4,4′-dimethoxydiphenyldisulfide-3,3′-diisocyanate.

Non-limiting examples polyisocyanates can include aromatic polyisocyanates containing sulfone linkages such as diphenylsulfone-4,4′-diisocyanate, diphenylsulfone-3,3′-diisocyanate, benzidinesulfone-4,4′-diisocyanate, diphenylmethanesulfone-4,4′-diisocyanate, 4-methyldiphenylmethanesulfone-2,4′-diisocyanate, 4,4′-dimethoxydiphenylsulfone-3,3′-diisocyanate, 3,3′-dimethoxy-4,4′-diisocyanatodibenzylsulfone, 4,4′-dimethyldiphenylsulfone-3,3′-diisocyanate, 4,4′-di-tert-butyl-diphenylsulfone-3,3′-diisocyanate and 4,4′-dichlorodiphenylsulfone-3,3′-diisocyanate.

Non-limiting examples of aromatic sulfonic amide type polyisocyanates for use in the present invention can include 4-methyl-3-isocyanato-benzene-sulfonylanilide-3′-methyl-4′-isocyanate, dibenzenesulfonyl-ethylenediamine-4,4′-diisocyanate, 4,4′-methoxybenzenesulfonyl-ethylenediamine-3,3′-diisocyanate and 4-methyl-3-isocyanato-benzene-sulfonylanilide-4-ethyl-3′-isocyanate.

In alternate non-limiting embodiments, the polyisothiocyanate can include aliphatic polyisothiocyanates; alicyclic polyisothiocyanates, such as but not limited to cyclohexane diisothiocyanates; aromatic polyisothiocyanates wherein the isothiocyanate groups are not bonded directly to the aromatic ring, such as but not limited to α,α′-xylylene diisothiocyanate; aromatic polyisothiocyanates wherein the isothiocyanate groups are bonded directly to the aromatic ring, such as but not limited to phenylene diisothiocyanate; heterocyclic polyisothiocyanates, such as but not limited to 2,4,6-triisothicyanato-1,3,5-triazine and thiophene-2,5-diisothiocyanate; carbonyl polyisothiocyanates; aliphatic polyisothiocyanates containing sulfide linkages, such as but not limited to thiobis(3-isothiocyanatopropane); aromatic polyisothiocyanates containing sulfur atoms in addition to those of the isothiocyanate groups; halogenated, alkylated, alkoxylated, nitrated, carbodiimide modified, urea modified and biuret modified derivatives of these polyisothiocyanates; and dimerized and trimerized products of these polyisothiocyanates.

Non-limiting examples of aliphatic polyisothiocyanates include 1,2-diisothiocyanatoethane, 1,3-diisothiocyanatopropane, 1,4-diisothiocyanatobutane and 1,6-diisothiocyanatohexane. Non-limiting examples of aromatic polyisothiocyanates having isothiocyanate groups bonded directly to the aromatic ring can include but are not limited to 1,2-diisothiocyanatobenzene, 1,3-diisothiocyanatobenzene, 1,4-diisothiocyanatobenzene, 2,4-diisothiocyanatotoluene, 2,5-diisothiocyanato-m-xylene, 4,4′-diisothiocyanato-1,1′-biphenyl, 1,1′-methylenebis(4-isothiocyanatobenzene), 1,1′-methylenebis(4-isothiocyanato-2-methylbenzene), 1,1′-methylenebis(4-isothiocyanato-3-methylbenzene), 1,1′-(1,2-ethane-diyl)bis(4-isothiocyanatobenzene), 4,4′-diisothiocyanatobenzophenenone, 4,4′-diisothiocyanato-3,3′-dimethylbenzophenone, benzanilide-3,4′-diisothiocyanate, diphenylether-4,4′-diisothiocyanate and diphenylamine-4,4′-diisothiocyanate.

Suitable carbonyl polyisothiocyanates can include but are not limited to hexane-dioyl diisothiocyanate, nonanedioyl diisothiocyanate, carbonic diisothiocyanate, 1,3-benzenedicarbonyl diisothiocyanate, 1,4-benzenedicarbonyl diisothiocyanate and (2,2′-bipyridine)-4,4′-dicarbonyl diisothiocyanate. Non-limiting examples of aromatic polyisothiocyanates containing sulfur atoms in addition to those of the isothiocyanate groups, can include but are not limited to 1-isothiocyanato-4-[(2-isothiocyanato)sulfonyl]benzene, thiobis(4-isothiocyanatobenzene), sulfonylbis(4-isothiocyanatobenzene), sulfinylbis(4-isothiocyanatobenzene), dithiobis(4-isothiocyanatobenzene), 4-isothiocyanato-1-[(4-isothiocyanatophenyl)-sulfonyl]-2-methoxybenzene, 4-methyl-3-isothicyanatobenzene-sulfonyl-4′-isothiocyanate phenyl ester and 4-methyl-3-isothiocyanatobenzene-sulfonylanilide-3′-methyl-4′-isothiocyanate.

Non-limiting examples of materials having isocyanate and isothiocyanate groups can include materials having aliphatic, alicyclic, aromatic or heterocyclic groups and which optionally contain sulfur atoms in addition to those of the isothiocyanate groups. Non-limiting examples of such materials can include but are not limited to 1-isocyanato-3-isothiocyanatopropane, 1-isocyanato-5-isothiocyanatopentane, 1-isocyanato-6-isothiocyanatohexane, isocyanatocarbonyl isothiocyanate, 1-isocyanato-4-isothiocyanatocyclohexane, 1-isocyanato-4-isothiocyanatobenzene, 4-methyl-3-isocyanato-1-isothiocyanatobenzene, 2-isocyanato-4,6-diisothiocyanato-1,3,5-triazine, 4-isocyanato-4′-isothiocyanato-diphenyl sulfide and 2-isocyanato-2′-isothiocyanatodiethyl disulfide.

In further alternate non limiting embodiments, the polyisocyanate can include meta-tetramethylxylylene diisocyanate (1,3-bis(1-isocyanato-1-methylethyl-benzene); 3-isocyanato-methyl-3,5,5,-trimethyl-cyclohexyl isocyanate; 4,4-methylene bis(cyclohexyl isocyanate); meta-xylylene diisocyanate; and mixtures thereof.

In a non-limiting embodiment, the polyisocyanate and/or polyisothiocyanate can be reacted with an active hydrogen-containing material to form a polyurethane prepolymer. Active hydrogen-containing materials are varied and known in the art. Non-limiting examples can include hydroxyl-containing materials such as but not limited to polyols; sulfur-containing materials such as but not limited to hydroxyl functional polysulfides, and SH-containing materials such as but not limited to polythiols; and materials having both hydroxyl and thiol functional groups.

Suitable hydroxyl-containing materials for use in the present invention can include a wide variety of materials known in the art. Non-limiting examples can include but are not limited to polyether polyols, polyester polyols, polycaprolactone polyols, polycarbonate polyols, polyurethane polyols, poly vinyl alcohols, polymers containing hydroxy functional acrylates, polymers containing hydroxy functional methacrylates, polymers containing allyl alcohols and mixtures thereof.

Polyether polyols and methods for their preparation are known to one skilled in the art. Many polyether polyols of various types and molecular weight are commercially available from various manufacturers. Non-limiting examples of polyether polyols can include but are not limited to polyoxyalkylene polyols, and polyalkoxylated polyols. Polyoxyalkylene polyols can be prepared in accordance with known methods. In a non-limiting embodiment, a polyoxyalkylene polyol can be prepared by condensing an alkylene oxide, or a mixture of alkylene oxides, using acid or base-catalyzed addition with a polyhydric initiator or a mixture of polyhydric initiators, such as but not limited to ethylene glycol, propylene glycol, glycerol, and sorbitol. Non-limiting examples of alkylene oxides can include ethylene oxide, propylene oxide, butylene oxide, amylene oxide, aralkylene oxides, such as but not limited to styrene oxide, mixtures of ethylene oxide and propylene oxide. In a further non-limiting embodiment, polyoxyalkylene polyols can be prepared with mixtures of alkylene oxide using random or step-wise oxyalkylation. Non-limiting examples of such polyoxyalkylene polyols include polyoxyethylene, such as but not limited to polyethylene glycol, polyoxypropylene, such as but not limited to polypropylene glycol.

In a non-limiting embodiment, polyalkoxylated polyols can be represented by the following general formula: 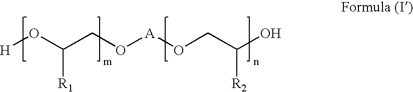
wherein m and n can each be a positive integer, the sum of m and n being from 5 to 70; R₁ and R₂ are each hydrogen, methyl or ethyl; and A is a divalent linking group such as a straight or branched chain alkylene which can contain from 1 to 8 carbon atoms, phenylene, and C₁ to C₉ alkyl-substituted phenylene. The chosen values of m and n can, in combination with the chosen divalent linking group, determine the molecular weight of the polyol. Polyalkoxylated polyols can be prepared by methods that are known in the art. In a non-limiting embodiment, a polyol such as 4,4′-isopropylidenediphenol can be reacted with an oxirane-containing material such as but not limited to ethylene oxide, propylene oxide and butylene oxide, to form what is commonly referred to as an ethoxylated, propoxylated or butoxylated polyol having hydroxyl functionality. Non-limiting examples of polyols suitable for use in preparing polyalkoxylated polyols can include those polyols described in U.S. Pat. No. 6,187,444 B1 at column 10, lines 1-20, which disclosure is incorporated herein by reference.

As used herein and the claims, the term “polyether polyols” can include the generally known poly(oxytetramethylene) diols prepared by the polymerization of tetrahydrofuran in the presence of Lewis acid catalysts such as but not limited to boron trifluoride, tin (IV) chloride and sulfonyl chloride. Also included are the polyethers prepared by the copolymerization of cyclic ethers such as but not limited to ethylene oxide, propylene oxide, trimethylene oxide, and tetrahydrofuran with aliphatic diols such as but not limited to ethylene glycol, 1,3-butanediol, 1,4-butanediol, diethylene glycol, dipropylene glycol, 1,2-propylene glycol and 1,3-propylene glycol. Compatible mixtures of polyether polyols can also be used. As used herein, “compatible” means that two or more materials are mutually soluble in each other so as to essentially form a single phase.

A variety of polyester polyols for use in the present invention are known in the art. Suitable polyester polyols can include but are not limited to polyester glycols. Polyester glycols for use in the present invention can include the esterification products of one or more dicarboxylic acids having from four to ten carbon atoms, such as but not limited to adipic, succinic or sebacic acids, with one or more low molecular weight glycols having from two to ten carbon atoms, such as but not limited to ethylene glycol, propylene glycol, diethylene glycol, 1,4-butanediol, neopentyl glycol, 1,6-hexanediol and 1,10-decanediol. Esterification procedures for producing polyester polyols is described, for example, in the article D. M. Young, F. Hostettler et al., “Polyesters from Lactone,” Union Carbide F-40, p. 147.

In a non-limiting embodiment, the polyol for use in the present invention can include polycaprolactone polyols. Suitable polycaprolactone polyols are varied and know in the art. In a non-limiting embodiment, polycaprolactone polyols can be prepared by condensing caprolactone in the presence of difunctional active hydrogen material such as but not limited to water or low molecular weight glycols such as but not limited to ethylene glycol and propylene glycol. Non-limiting examples of suitable polycaprolactone polyols can include commercially available materials designated as the CAPA series from Solvay Chemical which includes but is not limited to CAPA 2047A, and the TONE series from Dow Chemical such as but not limited to TONE 0201.

Polycarbonate polyols for use in the present invention are varied and known to one skilled in the art. Suitable polycarbonate polyols can include those commercially available (such as but not limited to Ravecarb™ 107 from Enichem S.p.A.). In a non-limiting embodiment, the polycarbonate polyol can be produced by reacting diol, such as described herein, and a dialkyl carbonate, such as described in U.S. Pat. No. 4,160,853. In a non-limiting embodiment, the polyol can include polyhexamethyl carbonate such as HO—(CH₂)₆—[O—C(O)—O—(CH₂)₆]ₙ—OH, wherein n is an integer from 4 to 24, or from 4 to 10, or from 5 to 7.

Further non-limiting examples of active hydrogen-containing materials can include low molecular weight di-functional and higher functional polyols and mixtures thereof. In a non-limiting embodiment, these low molecular weight materials can have a number average molecular weight of less than 500 grams/mole. In a further non-limiting embodiment, the amount of low molecular weight material chosen can be such to avoid a high degree of cross-linking in the polyurethane. The di-functional polyols typically contain from 2 to 16, or from 2 to 6, or from 2 to 10, carbon atoms. Non-limiting examples of such difunctional polyols can include but are not limited to ethylene glycol, propylene glycol, diethylene glycol, triethylene glycol, tetraethylene glycol, dipropylene glycol, tripropylene glycol, 1,2-, 1,3- and 1,4-butanediol, 2,2,4-trimethyl-1,3-pentanediol, 2-methyl-1,3-pentanediol, 1,3- 2,4- and 1,5-pentanediol, 2,5- and 1,6-hexanediol, 2,4-heptanediol, 2-ethyl-1,3-hexanediol, 2,2-dimethyl-1,3-propanediol, 1,8-octanediol, 1,9-nonanediol, 1,10-decanediol, 1,4-cyclohexanediol, 1,4-cyclohexanedimethanol, 1,2-bis(hydroxyethyl)-cyclohexane and mixtures thereof. Non-limiting examples of trifunctional or tetrafunctional polyols can include glycerin, tetramethylolmethane, pentaerythritol, trimethylolethane, trimethylolpropane, alkoxylated polyols such as but not limited to ethoxylated trimethylolpropane, propoxylated trimethylolpropane, ethoxylated trimethylolethane; and mixtures thereof.

In alternate non-limiting embodiments, the active hydrogen-containing material can have a number average molecular weight of at least 200 grams/mole, or at least 400 grams/mole, or at least 1000 grams/mole, or at least 2000 grams/mole. In alternate non-limiting embodiments, the active hydrogen-containing material can have a number average molecular weight of less than 5,000 grams/mole, or less than 10,000 grams/mole, or less than 15,000 grams/mole, or less than 20,000 grams/mole, or less than 32,000 grams/mole.

In a non-limiting embodiment, the active hydrogen-containing material can comprise block polymers including blocks of ethylene oxide-propylene oxide and/or ethylene oxide-butylene oxide. In a non-limiting embodiment, the active hydrogen-containing material can comprise a block copolymer of the following chemical formula:
HO—(CHR₁CHR₂—O)ₐ—(CHR₃CHR₄—O)_{b}—(CHR₅CHR₆—O)_{c}—H (I″)
wherein R₁ through R₆ can each independently represent hydrogen or methyl; a, b, and c can each be independently an integer from 0 to 300. wherein a, b and c are chosen such that the number average molecular weight of the polyol does not exceed 32,000 grams/mole, as determined by GPC. In another non-limiting embodiment, a, b, and c can be chosen such that the number average molecular weight of the polyol does not exceed 10,000 grams/mole, as determined by GPC. In another non-limiting embodiment, a, b, and c each can be independently an integer from 1 to 300. In a non-limiting embodiment, R₁, R₂, R₅, and R₆ can be hydrogen, and R₃ and R₄ each can be independently chosen from hydrogen and methyl, with the proviso that R₃ and R₄ are different from one another. In another non-limiting embodiment, R₃ and R₄ can be hydrogen, and R₁ and R₂ each can be independently chosen from hydrogen and methyl, with the proviso that R₁ and R₂ are different from one another, and R₅ and R₆ each can be independently chosen from hydrogen and methyl, with the proviso that R₅ and R₆ are different from one another.

In further alternate non-limiting embodiments, Pluronic R, Pluronic L62D, Tetronic R or Tetronic, which are commercially available from BASF, can be used as active hydrogen-containing material in the present invention.

Non-limiting examples of suitable polyols for use in the present invention can include straight or branched chain alkane polyols, such as but not limited to 1,2-ethanediol, 1,3-propanediol, 1,2-propanediol, 1,4-butanediol, 1,3-butanediol, glycerol, neopentyl glycol, trimethylolethane, trimethylolpropane, di-trimethylolpropane, erythritol, pentaerythritol and di-pentaerythritol; alkoxylated polyols such as but not limited to ethoxylated trimethylolpropane, propoxylated trimethylolpropane or ethoxylated trimethylolethane; polyalkylene glycols, such as but not limited to diethylene glycol, dipropylene glycol and higher polyalkylene glycols such as but not limited to polyethylene glycols which can have number average molecular weights of from 200 grams/mole to 2,000 grams/mole; cyclic alkane polyols, such as but not limited to cyclopentanediol, cyclohexanediol, cyclohexanetriol, cyclohexanedimethanol, hydroxypropylcyclohexanol and cyclohexanediethanol; aromatic polyols, such as but not limited to dihydroxybenzene, benzenetriol, hydroxybenzyl alcohol and dihydroxytoluene; bisphenols, such as, 4,4′-isopropylidenediphenol; 4,4′-oxybisphenol, 4,4′-dihydroxybenzophenone, 4,4′-thiobisphenol, phenolphthlalein, bis(4-hydroxyphenyl)methane, 4,4′-(1,2-ethenediyl)bisphenol and 4,4′-sulfonylbisphenol; halogenated bisphenols, such as but not limited to 4,4′-isopropylidenebis(2,6-dibromophenol), 4,4′-isopropylidenebis(2,6-dichlorophenol) and 4,4′-isopropylidenebis(2,3,5,6-tetrachlorophenol); alkoxylated bisphenols, such as but not limited to alkoxylated 4,4′-isopropylidenediphenol which can have from 1 to 70 alkoxy groups, for example, ethoxy, propoxy, α-butoxy and β-butoxy groups; and biscyclohexanols, which can be prepared by hydrogenating the corresponding bisphenols, such as but not limited to 4,4′-isopropylidene-biscyclohexanol, 4,4′-oxybiscyclohexanol, 4,4′-thiobiscyclohexanol and bis(4-hydroxycyclohexanol)methane and mixtures thereof.

In a further non-limiting embodiment, the polyol can be a polyurethane prepolymer having two or more hydroxy functional groups. Such polyurethane prepolymers can be prepared from any of the polyols and polyisocyanates previously described herein. In a non-limiting embodiment, the OH:NCO equivalent ratio can be chosen such that essentially no free NCO groups are produced in preparing the polyurethane prepolymer. In alternate non-limiting embodiments, the equivalent ratio of OH to NCO (i.e., isocyanate) present in the polyurethane prepolymer can be an amount of from 2.0 to less than 5.5 OH/1.0 NCO.

In alternate non-limiting embodiments, the polyurethane prepolymer can have a number average molecular weight (Mn) of less than 50,000 grams/mole, or less than 20,000 grams/mole, or less than 10,000 grams/mole, or less than 5,000 grams/mole, or greater than 1,000 grams/mole or greater than 2,000 grams/mole.

In a non-limiting embodiment, the active hydrogen-containing material for use in the present invention can include sulfur-containing materials such as SH-containing materials, such as but not limited to polythiols having at least two thiol groups. Non-limiting examples of suitable polythiols can include but are not limited to aliphatic polythiols, cycloaliphatic polythiols, aromatic polythiols, heterocyclic polythiols, polymeric polythiols, oligomeric polythiols and mixtures thereof. The sulfur-containing active hydrogen-containing material can have linkages including but not limited to ether linkages (—O—), sulfide linkages (—S—), polysulfide linkages (—Sₓ—, wherein x is at least 2, or from 2 to 4) and combinations of such linkages. As used herein and the claims, the terms “thiol,” “thiol group,” “mercapto” or “mercapto group” refer to an —SH group which is capable of forming a thiourethane linkage, (i.e., —NH—C(O)—S—) with an isocyanate group or a dithioruethane linkage (i.e., —NH—C(S)—S—) with an isothiocyanate group.

Non-limiting examples of suitable polythiols can include but are not limited to 2,5-dimercaptomethyl-1,4-dithiane, dimercaptoethylsulfide, pentaerythritol tetrakis(3-mercaptopropionate), pentaerythritol tetrakis(2-mercaptoacetate), trimethylolpropane tris(3-mercaptopropionate), trimethylolpropane tris(2-mercaptoacetate), 4-mercaptomethyl-3,6-dithia-1,8-octanedithiol, 4-tert-butyl-1,2-benzenedithiol, 4,4′-thiodibenzenethiol, ethanedithiol, benzenedithiol, ethylene glycol di(2-mercaptoacetate), ethylene glycol di(3-mercaptopropionate), poly(ethylene glycol) di(2-mercaptoacetate) and poly(ethylene glycol) di(3-mercaptopropionate), and mixtures thereof.

In a non-limiting embodiment, the polythiol can be chosen from materials represented by the following general formula, 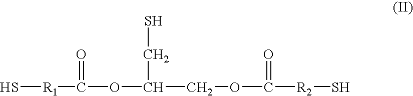
wherein R₁ and R₂ can each be independently chosen from straight or branched chain alkylene, cyclic alkylene, phenylene and C₁-C₉ alkyl substituted phenylene. Non-limiting examples of straight or branched chain alkylene can include but are not limited to methylene, ethylene, 1,3-propylene, 1,2-propylene, 1,4-butylene, 1,2-butylene, pentylene, hexylene, heptylene, octylene, nonylene, decylene, undecylene, octadecylene and icosylene. Non-limiting examples of cyclic alkylenes can include but are not limited to cyclopentylene, cyclohexylene, cycloheptylene, cyclooctylene, and alkyl-substituted derivatives thereof. In a non-limiting embodiment, the divalent linking groups R₁ and R₂ can be chosen from phenylene and alkyl-substituted phenylene, such as methyl, ethyl, propyl, isopropyl and nonyl substituted phenylene. In a further non-limiting embodiment, R₁ and R₂ each independently can be methylene or ethylene.

The polythiol represented by general formula II can be prepared by any known method. In a non-limiting embodiment, the polythiol of formula (II) can be prepared from an esterification or transesterification reaction between 3-mercapto-1,2-propanediol (Chemical Abstract Service (CAS) Registry No. 96-27-5) and a thiol functional carboxylic acid or carboxylic acid ester in the presence of a strong acid catalyst, such as but not limited to methane sulfonic acid, with essentially concurrent removal of water or alcohol from the reaction mixture.

In a non-limiting embodiment, the polythiol represented by general formula II can be thioglycerol bis(2-mercaptoacetate). As used herein and the claims, the term “thioglycerol bis(2-mercaptoacetate)” includes all related co-products and residual starting materials. In a non-limiting embodiment, oxidative coupling of thiol groups can occur when the reaction mixture of 3-mercapto-1,2-propanediol and a thiol functional carboxylic acid such as but not limited to 2-mercaptoacetic acid, is washed with excess base such as but not limited to aqueous ammonia. Such oxidative coupling can result in the formation of oligomeric polythiol species having disulfide linkages such as but not limited to —S—S— linkages.

Non-limiting examples of a co-product oligomeric polythiol species can include materials represented by the following general formula: 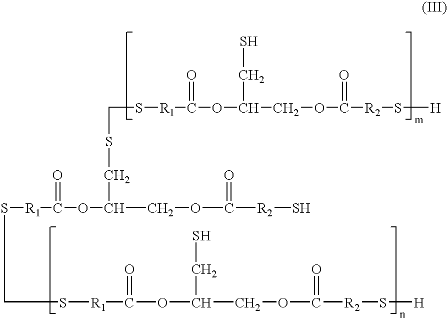
wherein R₁ and R₂ can be as described above, n and m each can be independently an integer from 0 to 21 and (n+m) can be at least 1.

In alternate non-limiting embodiments, suitable polythiols for use in the present invention can include but are not limited to polythiol oligomers having disulfide linkages, which can be prepared from the reaction of polythiol having at least two thiol groups and sulfur in the presence of basic catalyst. In a non-limiting embodiment, the equivalent ratio of polythiol monomer to sulfur can be from m to (m−1) wherein m can represent an integer from 2 to 21. The polythiol can be chosen from those previously disclosed herein, such as but not limited to 2,5-dimercaptomethyl-1,4-dithiane. In alternate non-limiting embodiments, the sulfur can be in the form of crystalline, colloidal, powder or sublimed sulfur, and can have a purity of at least 95 percent or at least 98 percent.

In another non-limiting embodiment, the polythiol oligomer can have disulfide linkages and can include materials represented by the following general formula IV, 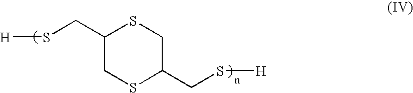
wherein n can represent an integer from 1 to 21. In a non-limiting embodiment, the polythiol oligomer represented by general formula IV can be prepared by the reaction of 2,5-dimeracaptomethyl-1,4-dithiane with sulfur in the presence of basic catalyst, as described previously herein. The nature of the SH group of polythiols is such that oxidative coupling can occur readily, leading to formation of disulfide linkages. Various oxidizing agents can lead to such oxidative coupling. The oxygen in the air can in some cases lead to such oxidative coupling during storage of the polythiol. It is believed that a possible mechanism for the coupling of thiol groups involves the formation of thiyl radicals, followed by coupling of said thiyl radicals, to form disulfide linkage. It is further believed that formation of disulfide linkage can occur under conditions that can lead to the formation of thiyl radical, including but not limited to reaction conditions involving free radical initiation.

In a non-limiting embodiment, the polythiol for use in the present invention can include species containing disulfide linkage formed during storage.

In another non-limiting embodiment, the polythiol for use in the present invention can include species containing disulfide linkage formed during synthesis of said polythiol.

In a non-limiting embodiment, the polythiol for use in the present invention, can include at least one polythiol represented by the following structural formulas.

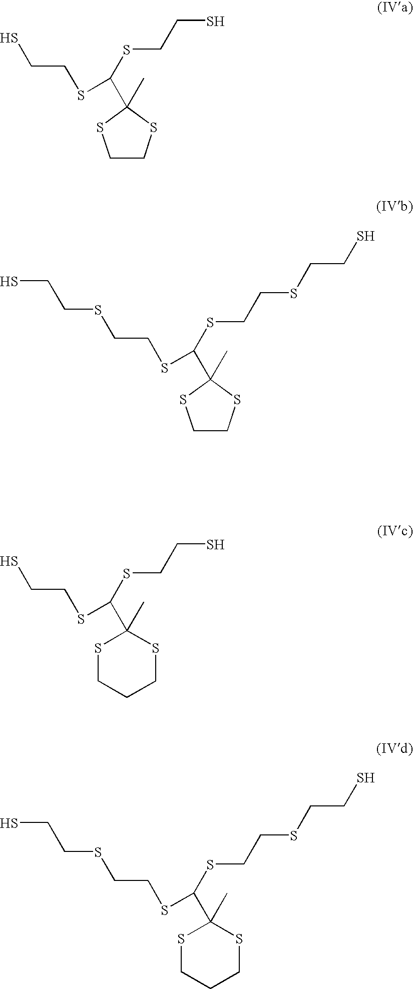

The sulfide-containing polythiols comprising 1,3-dithiolane (e.g., formulas IV′a and b) or 1,3-dithiane (e.g., formulas IV′c and d) can be prepared by reacting asym-dichloroacetone with polymercaptan, and then reacting the reaction product with polymercaptoalkylsulfide, polymercaptan or mixtures thereof.

Non-limiting examples of suitable polymercaptans for use in the reaction with asym-dichloroacetone can include but are not limited to materials represented by the following formula, 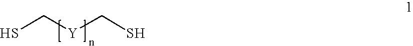
wherein Y can represent CH₂ or (CH₂—S—CH₂), and n can be an integer from 0 to 5. In a non-limiting embodiment, the polymercaptan for reaction with asym-dichloroacetone in the present invention can be chosen from ethanedithiol, propanedithiol, and mixtures thereof.

The amount of asym-dichloroacetone and polymercaptan suitable for carrying out the above reaction can vary. In a non-limiting embodiment, asym-dichloroacetone and polymercaptan can be present in the reaction mixture in an amount such that the molar ratio of dichloroacetone to polymercaptan can be from 1:1 to 1:10.

Suitable temperatures for reacting asym-dichloroacetone with polymercaptan can vary. In a non-limiting embodiment, the reaction of asym-dichloroacetone with polymercaptan can be carried out at a temperature within the range of from 0 to 100° C.

Non-limiting examples of suitable polymercaptans for use in the reaction with the reaction product of the asym-dichloroacetone and polymercaptan, can include but are not limited to materials represented by the above general formula 1, aromatic polymercaptans, cycloalkyl polymercaptans, heterocyclic polymercaptans, branched polymercaptans, and mixtures thereof.

Non-limiting examples of suitable polymercaptoalkylsulfides for use in the reaction with the reaction product of the asym-dichloroacetone and polymercaptan, can include but are not limited to materials represented by the following formula, 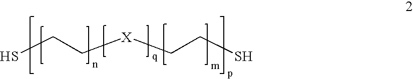
wherein X can represent O, S or Se, n can be an integer from 0 to 10, m can be an integer from 0 to 10, p can be an integer from 1 to 10, q can be an integer from 0 to 3, and with the proviso that (m+n) is an integer from 1 to 20.

Non-limiting examples of suitable polymercaptoalkylsulfides for use in the present invention can include branched polymercaptoalkylsulfides.

In a non-limiting embodiment, the polymercaptoalkylsulfide for use in the present invention can be dimercaptoethylsulfide.

The amount of polymercaptan, polymercaptoalkylsulfide, or mixtures thereof, suitable for reacting with the reaction product of asym-dichloroacetone and polymercaptan, can vary. In a non-limiting embodiment, polymercaptan, polymercaptoalkylsulfide, or a mixture thereof, can be present in the reaction mixture in an amount such that the equivalent ratio of reaction product to polymercaptan, polymercaptoalkylsulfide, or a mixture thereof, can be from 1:1.01 to 1:2. Moreover, suitable temperatures for carrying out this reaction can vary. In a non-limiting embodiment, the reaction of polymercaptan, polymercaptoalkylsulfide, or a mixture thereof, with the reaction product can be carried out at a temperature within the range of from 0 to 100° C.

In a non-limiting embodiment, the reaction of asym-dichloroacetone with polymercaptan can be carried out in the presence of acid catalyst. The acid catalyst can be selected from a wide variety known in the art, such as but not limited to Lewis acids and Bronsted acids. Non-limiting examples of suitable acid catalysts can include those described in Ullmann's Encyclopedia of Industrial Chemistry, 5^{th} Edition, 1992, Volume A21, pp. 673 to 674. in further alternate non-limiting embodiments, the acid catalyst can be chosen from boron trifluoride etherate, hydrogen chloride, toluenesulfonic acid, and mixtures thereof.

The amount of acid catalyst can vary. In a non-limiting embodiment, a suitable amount of acid catalyst can be from 0.01 to 10 percent by weight of the reaction mixture.

In another non-limiting embodiment, the reaction product of asym-dichloroacetone and polymercaptan can be reacted with polymercaptoalkylsulfide, polymercaptan or mixtures thereof, in the presence of base. The base can be selected from a wide variety known in the art, such as but not limited to Lewis bases and Bronsted bases. Non-limiting examples of suitable bases can include those described in Ullmann's Encyclopedia of Industrial Chemistry, 5^{th} Edition, 1992, Volume A21, pp. 673 to 674. In a further non-limiting embodiment, the base can be sodium hydroxide.

The amount of base can vary. In a non-limiting embodiment, a suitable equivalent ratio of base to reaction product of the first reaction, can be from 1:1 to 10:1.

In another non-limiting embodiment, the preparation of these sulfide-containing polythiols can include the use of a solvent. The solvent can be selected from a wide variety known in the art.

In a further non-limiting embodiment, the reaction of asym-dichloroacetone with polymercaptan can be carried out in the presence of a solvent. The solvent can be selected from a wide variety of known materials. In a non-limiting embodiment, the solvent can be selected from but is not limited to organic solvents, including organic inert solvents. Non-limiting examples of suitable solvents can include but are not limited to chloroform, dichloromethane, 1,2-dichloroethane, diethyl ether, benzene, toluene, acetic acid and mixtures thereof. In still a further embodiment, the reaction of asym-dichloroacetone with polymercaptan can be carried out in the presence of toluene as solvent.

In another embodiment, the reaction product of asym-dichloroacetone and polymercaptan can be reacted with polymercaptoalkylsulfide, polymercaptan or mixtures thereof, in the presence of a solvent, wherein the solvent can be selected from but is not limited to organic solvents including organic inert solvents. Non-limiting examples of suitable organic and inert solvents can include alcohols such as but not limited to methanol, ethanol and propanol; aromatic hydrocarbon solvents such as but not limited to benzene, toluene, xylene; ketones such as but not limited to methyl ethyl ketone; water and mixtures thereof. In a further non-limiting embodiment, this reaction can be carried out in the presence of a mixture of toluene and water as solvent. In another non-limiting embodiment, this reaction can be carried out in the presence of ethanol as solvent.

The amount of solvent can widely vary. In a non-limiting embodiment, a suitable amount of solvent can be from 0 to 99 percent by weight of the reaction mixture. In a further non-limiting embodiment, the reaction can be carried out neat, i.e., without solvent.

In another non-limiting embodiment, the reaction of asym-dichloroacetone with polyercaptan can be carried out in the presence of dehydrating reagent. The dehydrating reagent can be selected from a wide variety known in the art. Suitable dehydrating reagents for use in this reaction can include but are not limited to magnesium sulfate. The amount of dehydrating reagent can vary widely according to the stoichiometry of the dehydrating reaction.

In a non-limiting embodiment, sulfide-containing polythiol of the present invention can be prepared by reacting 1,1-dichloroacetone with 1,2-ethanedithiol to produce 2-methyl-2-dichloromethyl-1,3-dithiolane, as shown below.

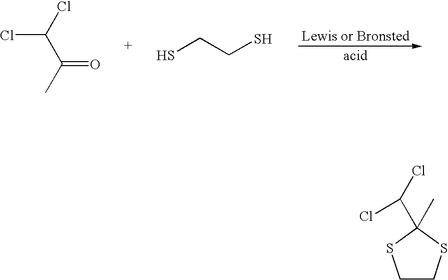

In a further non-limiting embodiment, 1,1-dichloroacetone can be reacted with 1,3-propanedithiol to produce 2-methyl-2-dichloromethyl-1,3-dithiane, as shown below.

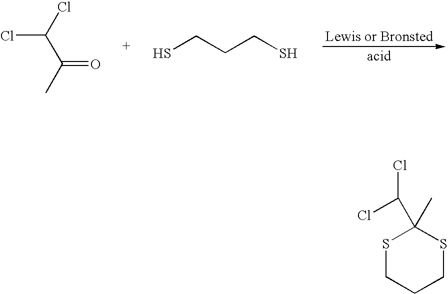

In another non-limiting embodiment, 2-methyl-2-dichloromethyl-1,3-dithiolane can be reacted with dimercaptoethylsulfide to produce dimercapto 1,3-dithiolane derivative of the present invention, as shown below.

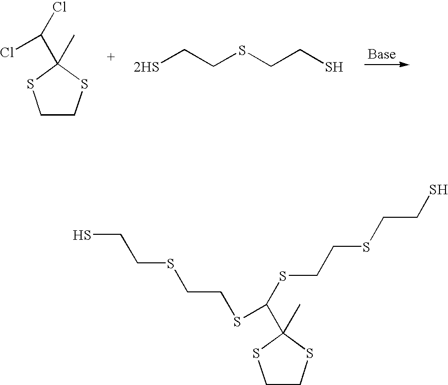

In another non-limiting embodiment, 2-methyl-2-dichloromethyl-1,3-dithiolane can be reacted with 1,2-ethanedithiol to produce dimercapto 1,3-dithiolane derivative of the present invention, as shown below.

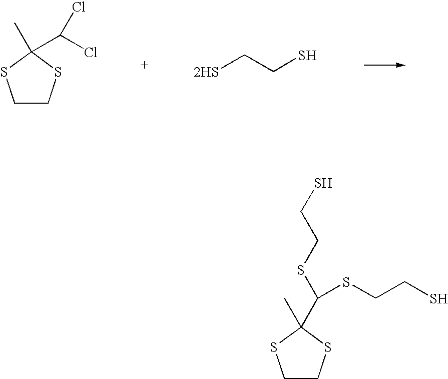

In another non-limiting embodiment, 2-methyl-2-dichloromethyl-1,3-dithiane can be reacted with dimercaptoethylsulfide to produce dimercapto 1,3-dithiane derivative of the present invention as shown below.

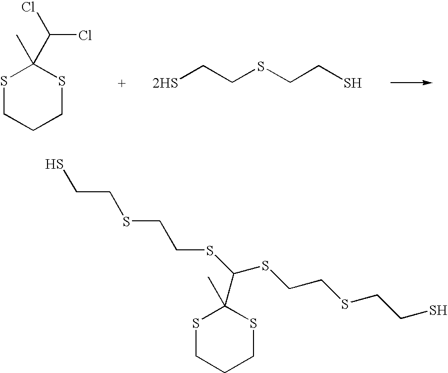

In another non-limiting embodiment, 2-methyl-2-dichloromethyl-1,3-dithiane can be reacted with 1,2-ethanedithiol to produce dimercapto 1,3-dithiane derivative of the present invention as shown below.

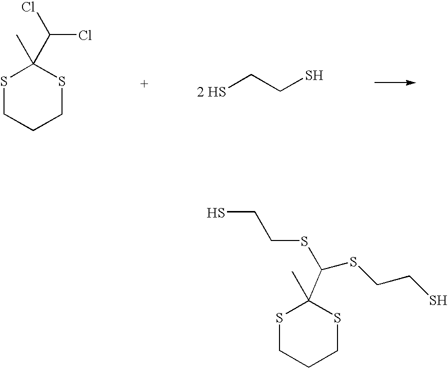

In another non-limiting embodiment, the polythiol for use in the present invention can include at least one oligomeric polythiol prepared by reacting asym-dichloro derivative with polymercaptoalkylsulfide as follows. 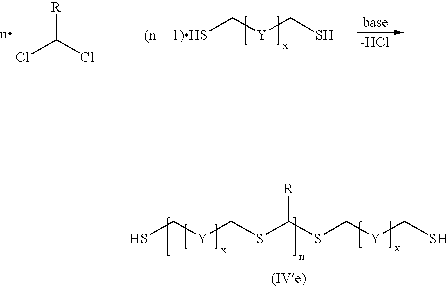
wherein R can represent CH₃, CH₃CO, C₁ to C₁₀ alkyl, C₃-C₁₄ cycloalkyl, C₆-C₁₄ aryl alkyl, or C₁-C₁₀ alkyl-CO; Y can represent C₁ to C₁₀ alkyl, C₃-C₁₄ cycloalkyl, C₆ to C₁₄ aryl, (CH₂)ₚ(S)ₘ(CH₂)_{q}, (CH₂)ₚ(Se)ₘ(CH₂)_{q}, (CH₂)ₚ(Te)ₘ(CH₂)_{q} wherein m can be an integer from 1 to 5 and, p and q can each independently be an integer from 1 to 10; n can be an integer from 1 to 20; and x can be an integer from 0 to 10.

In a further non-limiting embodiment, polythioether oligomeric dithiol can be prepared by reacting asym-dichloroacetone with polymercaptoalkylsulfide in the presence of base. Non-limiting examples of suitable polymercaptoalkylsulfides for use in this reaction can include but are not limited to those materials represented by general formula 2 as previously recited herein. Suitable bases for use in this reaction can include those previously recited herein.

Further non-limiting examples of suitable polymercaptoalkylsulfides for use in the present invention can include branched polymercaptoalkylsulfides. In a non-limiting embodiment, the polymercaptoalkylsulfide can be dimercaptoethylsulfide.

In a non-limiting embodiment, the reaction of asym-dichloro derivative with polymercaptoalkylsulfide can be carried out in the presence of base. Non-limiting examples of suitable bases can include those previously recited herein.

In another non-limiting embodiment, the reaction of asym-dichloro derivative with polymercaptoalkylsulfide can be carried out in the presence of phase transfer catalyst. Suitable phase transfer catalysts for use in the present invention are known and varied. Non-limiting examples can include but are not limited to tetraalkylammonium salts and tetraalkylphosphonium salts. In a further non-limiting embodiment, this reaction can be carried out in the presence of tetrabutylphosphonium bromide as phase transfer catalyst. The amount of phase transfer catalyst can vary widely. In alternate non-limiting embodiments, the amount of phase transfer catalyst to polymercaptosulfide reactants can be from 0 to 50 equivalent percent, or from 0 to 10 equivalent percent, or from 0 to 5 equivalent percent.

In another non-limiting embodiment, the preparation of polythioether oligomeric dithiol can include the use of solvent. Non-limiting examples of suitable solvents can include but are not limited to those previously recited herein.

In a non-limiting embodiment, “n” moles of 1,1-dichloroacetone can be reacted with “n+1” moles of polymercaptoethylsulfide wherein n can represent an integer of from 1 to 20, to produce polythioether oligomeric dithiol as follows.

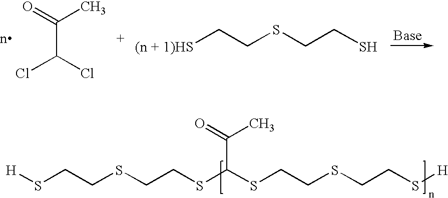

In a further non-limiting embodiment, polythioether oligomeric dithiol of the present invention can be prepared by introducing “n” moles of 1,1-dichloroethane and “n+1” moles of polymercaptoethylsulfide as follows: 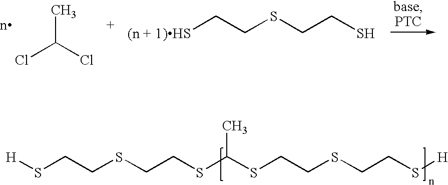
wherein n can represent an integer from 1 to 20.

In a non-limiting embodiment, polythiol for use in the present invention can include polythiol oligomer formed by the reaction of dithiol with diene, via thiol-ene type reaction of SH groups of said dithiol with double bond groups of said diene.

In a non-limiting embodiment, polythiol for use in the present invention can include at least one oligomeric polythiol as follows: 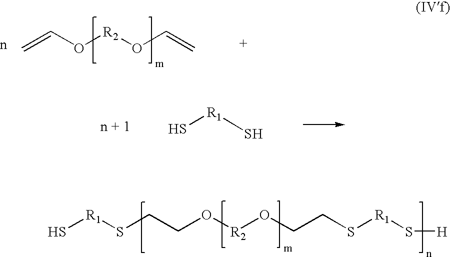
wherein R₁, can be C₂ to C₆ n-alkylene; C₃ to C₆ alkylene unsubstituted or substituted wherein substituents can be hydroxyl, methyl, ethyl, methoxy or ethoxy; or C₆ to C₈ cycloalkylene; R₂ can be C₂ to C₆ n-alkylene, C₂ to C₆ branched alkylene, C₆ to C₈ cycloalkyl-ene, C₆ to C₁₀ alkylcycloalkylene or —[(CH₂—)ₚ—O—]_{q}—(—CH₂—)ᵣ—; m can be a rational number from 0 to 10, n can be an integer from 1 to 20, p can be an integer from 2 to 6, q can be an integer from 1 to 5, and r can be an integer from 2 to 10.

Various methods of preparing the polythiol of formula (IV′f) are described in detail in U.S. Pat. No. 6,509,418B1, column 4, line 52 through column 8, line 25, which disclosure is herein incorporated by reference. In general, this polythiol can be prepared by combining reactants comprising one or more polyvinyl ether monomer, and one or more polythiol. Useful polyvinyl ether monomers can include, but are not limited to divinyl ethers represented by structural formula (V):
CH₂═CH—O—(—R₂—O—)ₘ—CH═CH₂ (V′)
wherein R₂ can be C₂ to C₆ n-alkylene, C₂ to C₆ branched alkylene, C₆ to C₈ cycloalkylene, C₆ to C₁₀ alkylcycloalkylene or —[(CH₂—)ₚ—O—]_{q}—(—CH₂—)ᵣ—, m is a rational number ranging from 0 to 10, p is an integer from 2 to 6, q is an integer from 1 to 5 and r is an integer from 2 to 10.

In a non-limiting embodiment, m can be two (2).

Non-limiting examples of suitable polyvinyl ether monomers for use can include divinyl ether monomers, such as but not limited to ethylene glycol divinyl ether, diethylene glycol divinyl ether, butane diol divinyl ether and mixtures thereof.

In alternate non-limiting embodiments, the polyvinyl ether monomer can constitute from 10 to less than 50 mole percent of the reactants used to prepare the polythiol, or from 30 to less than 50 mole percent.

The divinyl ether of formula (V′) can be reacted with polythiol such as but not limited to dithiol represented by the formula (VI′):
HS—R₁—SH (VI′)
wherein R₁ can be C₂ to C₆ n-alkylene group; C₃ to C₆ branched alkylene group, having one or more pendant groups which can include but are not limited to hydroxyl, alkyl such as methyl or ethyl; alkoxy, or C₆ to C₈ cycloalkylene.

Further non-limiting examples of suitable polythiols for reaction with Formula (V′) can include those polythiols represented by Formula 2 herein.

Non-limiting examples of suitable polythiols for reaction with Formula (V′) can include but are not limited to dithiols such as 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide (DMDS), methyl-substituted dimercaptodiethylsulfide, dimethyl-substituted dimercaptodiethylsulfide, dimercaptodioxaoctane, 1,5-dimercapto-3-oxapentane and mixtures thereof.

In a non-limiting embodiment, the polythiol for reaction with Formula (V′) can have a number average molecular weight ranging from 90 to 1000 grams/mole, or from 90 to 500 grams/mole. In a further non-limiting embodiment, the stoichiometric ratio of polythiol to divinyl ether can be less than one equivalent of polyvinyl ether to one equivalent of polythiol.

In a non-limiting embodiment, the polythiol and divinyl ether mixture can further include one or more free radical initiators. Non-limiting examples of suitable free radical initiators can include azo compounds, such as azobis-nitrile compounds such as but not limited to azo(bis)isobutyronitrile (AIBN); organic peroxides such as but

The divinyl ether of formula (V′) can be reacted with polythiol such as but not limited to dithiol represented by the formula (VI′):
HS—R₁—SH (VI′)
wherein R₁, can be C₂ to C₆ n-alkylene group; C₃ to C₆ branched alkylene group, having one or more pendant groups which can include but are not limited to hydroxyl, alkyl such as methyl or ethyl; alkoxy, or C₆ to C₈ cycloalkylene.

Further non-limiting examples of suitable polythiols for reaction with Formula (V′) can include those polythiols represented by Formula 2 herein.

Non-limiting examples of suitable polythiols for reaction with Formula (V′) can include but are not limited to dithiols such as 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide (DMDS), methyl-substituted dimercaptodiethylsulfide, dimethyl-substituted dimercaptodiethylsulfide, dimercaptodioxaoctane, 1,5-dimercapto-3-oxapentane and mixtures thereof.

In a non-limiting embodiment, the polythiol for reaction with Formula (V′) can have a number average molecular weight ranging from 90 to 1000 grams/mole, or from 90 to 500 grams/mole. In a further non-limiting embodiment, the stoichiometric ratio of polythiol to divinyl ether can be less than one equivalent of polyvinyl ether to one equivalent of polythiol.

In a non-limiting embodiment, the polythiol and divinyl ether mixture can further include one or more free radical initiators. Non-limiting examples of suitable free radical initiators can include azo compounds, such as azobis-nitrile compounds such as but not limited to azo(bis)isobutyronitrile (AIBN); organic peroxides such as but not limited to benzoyl peroxide and t-butyl peroxide; inorganic peroxides and similar free-radical generators.

In alternate non-limiting embodiments, the reaction to produce the material represented by Formula (IV′f) can include irradiation with ultraviolet light either with or without a photoinitiator.

In a non-limiting embodiment, the polythiol for use in the present invention can include material represented by the following structural formula and prepared by the following reaction: 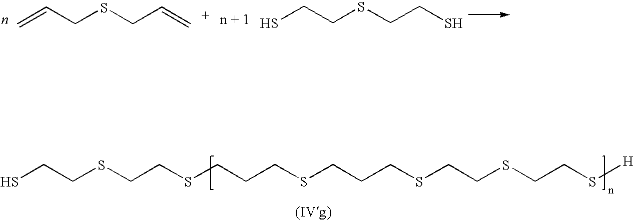
wherein n can be an integer from 1 to 20.

Various methods of preparing the polythiol of formula (IV′g) are described in detail in WO 03/042270, page 2, line 16 to page 10, line 7, which disclosure is incorporated herein by reference. In general, the polythiol can have number average molecular weight of from 100 to 3000 grams/mole. The polythiol can be prepared by ultraviolet (UV) initiated free radical polymerization in the presence of suitable photoinitiator. Suitable photoinitiators in usual amounts as known to one skilled in the art can be used for this process. In a non-limiting embodiment, 1-hydroxycyclohexyl phenyl ketone (Irgacure 184) can be used in an amount of from 0.05% to 0.10% by weight, based on the total weight of the polymerizable monomers in the mixture.

In a non-limiting embodiment, the polythiol represented by formula (IV′g) can be prepared by reacting “n” moles of allyl sulfide and “n+1” moles of dimercaptodiethylsulfide as shown above.

In a non-limiting embodiment, the polythiol for use in the present invention can include a material represented by the following structural formula and prepared by the following reaction: 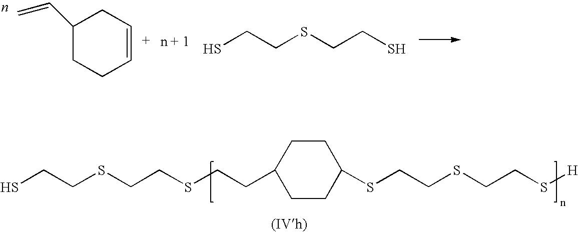
wherein n can be an integer from 1 to 20.

Various methods for preparing the polythiol of formula (IV′h) are described in detail in WO/01/66623A1, from page 3, line 19 to page 6, line 11, the disclosure of which is incorporated herein by reference. In general, polythiols can be prepared by reaction of thiol such as dithiol, and aliphatic, ring-containing non-conjugated diene in the presence of radical initiator. Non-limiting examples of suitable thiols can include but are not limited to lower alkylene thiols such as ethanedithiol, vinylcyclohexyldithiol, dicyclopentadienedithiol, dipentene dimercaptan, and hexanedithiol; polyol esters of thioglycolic acid and thiopropionic acid; and mixtures thereof and mixtures thereof.

Non-limiting examples of suitable cyclodienes can include but are not limited to vinylcyclohexene, dipentene, dicyclopentadiene, cyclododecadiene, cyclooctadiene, 2-cyclopenten-1-yl-ether, 5-vinyl-2-norbornene and norbornadiene.

Non-limiting examples of suitable radical initiators for the reaction can include azo or peroxide free radical initiators such as azobisalkylenenitrile which is commercially available from DuPont under the trade name VAZO™.

In a further non-limiting embodiment, “n+1” moles of dimercaptoethylsulfide can be reacted with “n” moles of 4-vinyl-1-cyclohexene, as shown above, in the presence of VAZO-52 radical initiator.

In a non-limiting embodiment, the polythiol for use in the present invention can include a material represented by the following structural formula and reaction scheme: 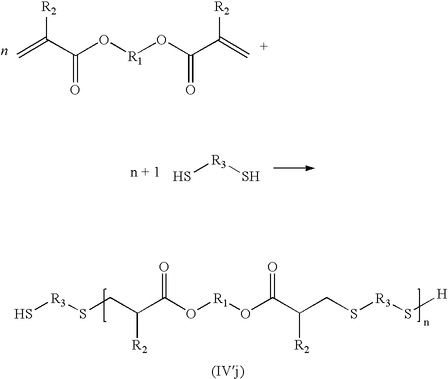
wherein R₁ and R₃ each can be independently C₁ to C₆ n-alkylene, C₂ to C₆ branched alkylene, C₆ to C₈ cycloalkylene, C₆ to C₁₀ alkylcycloalkylene, C₆ to C₈ aryl, C₆ to C₁₀ alkyl-aryl, C₁-C₁₀ alkyl containing ether linkages or thioether linkages or ester linkages or thioester linkages or combinations thereof, —[(CH₂—)ₚ—X—]_{q}—(—CH₂—)ᵣ—, wherein X can be O or S, p can be an integer from 2 to 6, q can be an integer from 1 to 5, r can be an integer from 0 to 10; R₂ can be hydrogen or methyl; and n can be an integer from 1 to 20.

In general, the polythiol of formula (IV′j) can be prepared by reacting di(meth)acrylate monomer and one or more polythiols. Non-limiting examples of suitable di(meth)acrylate monomers can vary widely and can include those known in the art, such as but not limited to ethylene glycol di(meth(acrylate, 1,3-butylene glycol di(meth)acrylate, 1,4-butanediol di(meth)acrylate, 2,3-dimethylpropane 1,3-di(meth)acrylate, 1,6-hexanediol di(meth)acrylate, propylene glycol di(meth)acrylate, dipropylene glycol di(meth)acrylate, tripropylene glycol di(meth)acrylate, tetrapropylene glycol di(meth)acrylate, ethoxylated hexanediol di(meth)acrylate, propoxylated hexanediol di(meth)acrylate, neopentyl glycol di(meth)acrylate, alkoxylated neopentyl glycol di(meth)acrylate, hexylene glycol di(meth)acrylate, diethylene glycol di(meth)acrylate, polyethylene glycol di(meth)acrylate, polybutadiene di(meth)acrylate, thiodiethyleneglycol di(meth)acrylate, trimethylene glycol di(meth)acrylate, triethylene glycol di(meth)acrylate, alkoxylated hexanediol di(meth)acrylate, alkoxyolated neopentyl glycol di(meth)acrylate, pentanediol di(meth)acrylate, cyclohexane dimethanol di(meth)acrylate, ethoxylated bis-phenol A di(meth)acrylate.

Non-limiting examples of suitable polythiols for use as reactants in preparing polythiol of Formula (IV′j) can vary widely and can include those known in the art, such as but not limited to 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide (DMDS), methyl-substituted dimercaptodiethylsulfide, dimethyl-substituted dimercaptodiethylsulfide, dimercaptodioxaoctane, 3,6-dioxa, 1,8-octanedithiol, 2-mercaptoethyl ether, 1,5-dimercapto-3-oxapentane, 2,5-dimercaptomethyl-1,4-dithiane (DMMD), ethylene glycol di(2-mercaptoacetate), ethylene glycol di(3-mercaptopropionate), and mixtures thereof.

In a non-limiting embodiment, the di(meth)acrylate used to prepare the polythiol of formula (IV′j) can be ethylene glycol di(meth)acrylate.

In another non-limiting embodiment, the polythiol used to prepare the polythiol of formula (IV′j) can be dimercaptodiethylsulfide (DMDS).

In a non-limiting embodiment, the reaction to produce the polythiol of formula (IV′j) can be carried out in the presence of base catalyst. Suitable base catalysts for use in this reaction can vary widely and can be selected from those known in the art. Non-limiting examples can include but are not limited to tertiary amine bases such as 1,8-diazabicyclo[5.4.0]undec-7-ene (DBU) and N,N-dimethylbenzylamine. The amount of base catalyst used can vary widely. In a non-limiting embodiment, base catalyst can be present in an amount of from 0.001 to 5.0% by weight of the reaction mixture.

Not intending to be bound by any particular theory, it is believed that as the mixture of polythiol, di(meth)acrylate monomer, and base catalyst is reacted, the double bonds can be at least partially consumed by reaction with the SH groups of the polythiol. In a non-limiting embodiment, the mixture can be reacted for a period of time such that the double bonds are substantially consumed and a pre-calculated theoretical value for SH content is achieved. In a non-limiting embodiment, the mixture can be reacted for a time period of from 1 hour to 5 days. In another non-limiting embodiment, the mixture can be reacted at a temperature of from 20° C. to 100° C. In a further non-limiting embodiment, the mixture can be reacted until a theoretical value for SH content of from 0.5% to 20% is achieved.

The number average molecular weight (Mₙ) of the resulting polythiol can vary widely. In a non-limiting embodiment, the number average molecular weight (Mₙ) of polythiol can be determined by the stoichiometry of the reaction. In alternate non-limiting embodiments, the Mₙ of polythiol can be at least 400 g/mole, or less than or equal to 5000 g/mole, or from 1000 to 3000 g/mole.

In a non-limiting embodiment, the polythiol for use in the present invention can include a material represented by the following structural formula and reaction scheme: 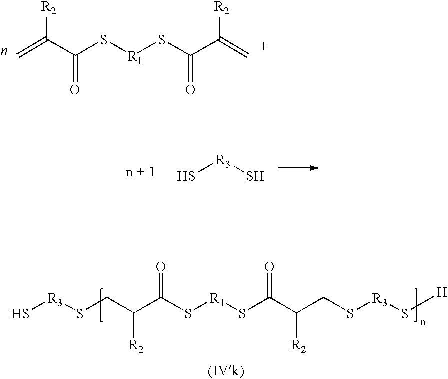
wherein R₁ and R₃ each can be independently C₁ to C₆ n-alkylene, C₂ to C₆ branched alkylene, C₆ to C₈ cycloalkylene, C₆ to C₁₀ alkylcycloalkylene, C₆ to C₈ aryl, C₆ to C₁₀ alkyl-aryl, C₁-C₁₀ alkyl containing ether linkages or thioether linkages or ester linkages or thioester linkages or combinations thereof, —[(CH₂—)ₚ—X—]_{q}—(—CH₂—)ᵣ—, wherein X can be O or S, p can be an integer from 2 to 6, q can be an integer from 1 to 5, r can be an integer from 0 to 10; R₂ can be hydrogen or methyl, and n can be an integer from 1 to 20.

In general, the polythiol of formula (IV′k) can be prepared by reacting polythio(meth)acrylate monomer, and one or more polythiols. Non-limiting examples of suitable polythio(meth)acrylate monomers can vary widely and can include those known in the art such as but not limited to di(meth)acrylate of 1,2-ethanedithiol including oligomers thereof, di(meth)acrylate of dimercaptodiethyl sulfide (i.e., 2,2′-thioethanedithiol di(meth)acrylate) including oligomers thereof, di(meth)acrylate of 3,6-dioxa-1,8-octanedithiol including oligomers thereof, di(meth)acrylate of 2-mercaptoethyl ether including oligomers thereof, di(meth)acrylate of 4,4′-thiodibenzenethiol, and mixtures thereof.

The polythio(meth)acrylate monomer can be prepared from polythiol using methods known to those skilled in the art, including but not limited to those methods disclosed in U.S. Pat. No. 4,810,812, U.S. Pat. No. 6,342,571; and WO 03/011925. Non-limiting examples of suitable polythiol for use as reactant(s) in preparing polythiols can include a wide variety of polythiols known in the art, such as but not limited to 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide, methyl-substituted dimercaptodiethylsulfide, dimethyl-substituted dimercaptodiethylsulfide, dimercaptodioxaoctane, 3,6-dioxa,1,8-octanedithiol, 2-mercaptoethyl ether, 1,5-dimercapto-3-oxapentane, 2,5-dimercaptomethyl-1,4-dithiane (DMMD), ethylene glycol di(2-mercaptoacetate), ethylene glycol di(3-mercaptopropionate), and mixtures thereof.

In a non-limiting embodiment, the polythio(meth)acrylate used to prepare the polythiol of formula (IV′k) can be di(meth)acrylate of dimercaptodiethylsulfide, i.e., 2,2′-thiodiethanethiol dimethacrylate. In another non-limiting embodiment, the polythiol used to prepare the polythiol of formula (IV′k) can be dimercaptodiethylsulfide (DMDS).

In a non-limiting embodiment, this reaction can be carried out in the presence of base catalyst. Non-limiting examples of suitable base catalysts for use can vary widely and can be selected from those known in the art. Non-limiting examples can include but are not limited to tertiary amine bases such as 1,8-diazabicyclo[5.4.0]undec-7-ene (DBU) and N,N-dimethylbenzylamine.

The amount of base catalyst used can vary widely. In a non-limiting embodiment, the base catalyst can be present in an amount of from 0.001 to 5.0% by weight of the reaction mixture. In a non-limiting embodiment, the mixture can be reacted for a time period of from 1 hour to 5 days. In another non-limiting embodiment, the mixture can be reacted at a temperature of from 20° C. to 100° C. In a further non-limiting embodiment, the mixture can be heated until a precalculated theoretical value for SH content of from 0.5% to 20% is achieved.

The number average molecular weight (Me) of the resulting polythiol can vary widely. In a non-limiting embodiment, the number average molecular weight (Me) of polythiol can be determined by the stoichiometry of the reaction. In alternate non-limiting embodiments, the Mₙ of polythiol can be at least 400 g/mole, or less than or equal to 5000 g/mole, or from 1000 to 3000 g/mole.

In a non-limiting embodiment, the polythiol for use in the present invention can include a material represented by the following structural formula and reaction: 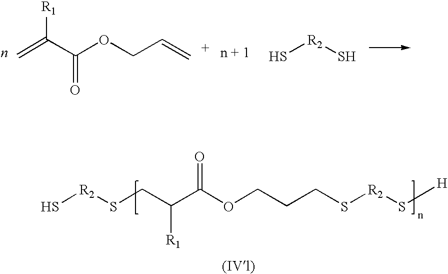
wherein R₁ can be hydrogen or methyl, and R₂ can be C₁ to C₆ n-alkylene, C₂ to C₆ branched alkylene, C₆ to C₈ cycloalkylene, C₆ to C₁₀ alkylcycloalkylene, C₆ to C₈ aryl, C₆ to C₁₀ alkyl-aryl, C₁-C₁₀ alkyl containing ether linkages or thioether linkages or ester linkages or thioester linkages or combinations thereof, or —[(CH₂—)ₚ—X—]_{q}—(—CH₂—)ᵣ—, wherein X can be O or S, p can be an integer from 2 to 6, q can be an integer from 1 to 5, r can be an integer from 0 to 10; and n can be an integer from 1 to 20.

In general, the polythiol of formula (IV′l) can be prepared by reacting allyl(meth)acrylate, and one or more polythiols.

Non-limiting examples of suitable polythiols for use as reactant(s) in preparing polythiols can include a wide variety of known polythiols such as but not limited to 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide, methyl-substituted dimercaptodiethylsulfide, dimethyl-substituted dimercaptodiethylsulfide, dimercaptodioxaoctane, 3,6-dioxa,1,8-octanedithiol, 2-mercaptoethyl ether, 1,5-dimercapto-3-oxapentane, 2,5-dimercaptomethyl-1,4-dithiane,ethylene glycol di(2-mercaptoacetate), ethylene glycol di(3-mercaptopropionate), and mixtures thereof.

In a non-limiting embodiment, the polythiol used to prepare the polythiol of formula (IV′l) can be dimercaptodiethylsulfide (DMDS).

In a non-limiting embodiment, the (meth)acrylic double bonds of allyl (meth)acrylate can be first reacted with polythiol in the presence of base catalyst. Non-limiting examples of suitable base catalysts can vary widely and can be selected from those known in the art. Non-limiting examples can include but are not limited to tertiary amine bases such as 1,8-diazabicyclo[5.4.0]undec-7-ene (DBU) and N,N-dimethylbenzylamine. The amount of base catalyst used can vary widely. In a non-limiting embodiment, base catalyst can be present in an amount of from 0.001 to 5.0% by weight of the reaction mixture. In a non-limiting embodiment, the mixture can be reacted for a time period of from 1 hour to 5 days. In another non-limiting embodiment, the mixture can be reacted at a temperature of from 20° C. to 100° C. In a further non-limiting embodiment, following the reaction of the SH groups of the polythiol with substantially all of the available (meth)acrylate double bonds of the allyl (meth)acrylate, the allyl double bonds can then be reacted with the remaining SH groups in the presence of radical initiator.

Not intending to be bound by any particular theory, it is believed that as the mixture is heated, the allyl double bonds can be at least partially consumed by reaction with the remaining SH groups. Non-limiting examples of suitable radical initiators can include but are not limited to azo or peroxide type free-radical initiators such as azobisalkylenenitriles. In a non-limiting embodiment, the free-radical initiator can be azobisalkylenenitrile which is commercially available from DuPont under the trade name VAZO™. In alternate non-limiting embodiments, VAZO-52, VAZO-64, VAZO-67, or VAZO-88 can be used as radical initiators.

In a non-limiting embodiment, the mixture can be heated for a period of time such that the double bonds are substantially consumed and a desired pre-calculated theoretical value for SH content is achieved. In a non-limiting embodiment, the mixture can be heated for a time period of from 1 hour to 5 days. In another non-limiting embodiment, the mixture can be heated at a temperature of from 40° C. to 100° C. In a further non-limiting embodiment, the mixture can be heated until a theoretical value for SH content of from 0.5% to 20% is achieved.

The number average molecular weight (Mₙ) of the resulting polythiol can vary widely. In a non-limiting embodiment, the number average molecular weight (Mₙ) of polythiol can be determined by the stoichiometry of the reaction. In alternate non-limiting embodiments, the Mₙ of polythiol can be at least 400 g/mole, or less than or equal to 5000 g/mole, or from 1000 to 3000 g/mole.

In a non-limiting embodiment, the polythiol for use in the present invention can include polythiol oligomer produced by the reaction of at least two or more different dienes with one or more dithiol; wherein the stoichiometric ratio of the sum of the number of equivalents of dithiol present to the sum of the number of equivalents of diene present is greater than 1.0:1.0. As used herein and the claims when referring to the dienes used in this reaction, the term “different dienes” can include the following embodiments:

at least one non-cyclic diene and at least one cyclic diene which can be selected from non-aromatic ring-containing dienes including but not limited to non-aromatic monocyclic dienes, non-aromatic polycyclic dienes or combinations thereof, and/or aromatic ring-containing dienes;

at least one aromatic ring-containing diene and at least one diene selected from the non-aromatic cyclic dienes described above;

at least one non-aromatic monocyclic diene and at least one non-aromatic polycyclic diene.

In a further non-limiting embodiment, the molar ratio of polythiol to diene in the reaction mixture can be (n+1) to (n) wherein n can represent an integer from 2 to 30.

The two or more different dienes can each be independently chosen from non-cyclic dienes, including straight chain and/or branched aliphatic non-cyclic dienes, non-aromatic ring-containing dienes, including non-aromatic ring-containing dienes wherein the double bonds can be contained within the ring or not contained within the ring or any combination thereof, and wherein said non-aromatic ring-containing dienes can contain non-aromatic monocyclic groups or non-aromatic polycyclic groups or combinations thereof; aromatic ring-containing dienes; or heterocyclic ring-containing dienes; or dienes containing any combination of such non-cyclic and/or cyclic groups, and wherein said two or more different dienes can optionally contain thioether, disulfide, polysulfide, sulfone, ester, thioester, carbonate, thiocarbonate, urethane, or thiourethane linkages, or halogen substituents, or combinations thereof; with the proviso that said dienes contain double bonds capable of undergoing reaction with SH groups of polythiol, and forming covalent C—S bonds, and two or more of said dienes are different from one another; and the one or more dithiol can each be independently chosen from dithiols containing straight chain and/or branched non-cyclic aliphatic groups, cycloaliphatic groups, aryl groups, aryl-alkyl groups, heterocyclic groups, or combinations or mixtures thereof, and wherein said one or more dithiol can each optionally contain thioether, disulfide, polysulfide, sulfone, ester, thioester, carbonate, thiocarbonate, urethane, or thiourethane linkages, or halogen substituents, or combinations thereof; and wherein the stoichiometric ratio of the sum of the number of equivalents of all dithiols present to the sum of the number of equivalents of all dienes present is greater than 1:1. In non-limiting embodiments, said ratio can be within the range of from greater than 1:1 to 3:1, or from 1.01:1 to 3:1, or from 1.01:1 to 2:1, or from 1.05:1 to 2:1, or from 1.1:1 to 1.5:1, or from 1.25:1 to 1.5:1. As used herein and in the claims, the term “number of equivalents” refers to the number of moles of a particular diene or polythiol, multiplied by the average number of thiol groups or double bond groups per molecule of said diene or polythiol, respectively.

The reaction mixture that consists of the group of two or more different dienes and the group of one or more dithiol and the corresponding number of equivalents of each diene and dithiol that is used to prepare the polythiol oligomer can be depicted as shown in Scheme I below:
d₁D₁+d₂D₂+ . . . +dₓDₓ+t₁T₁+ . . . +t_{y}T_{y}→polythiol oligomer; Scheme I.
wherein D₁ through Dₓ represent two or more different dienes, x is an integer greater than or equal to 2, that represents the total number of different dienes that are present; d₁ through dₓ represent the number of equivalents of each corresponding diene; T₁ through T_{y} represent one or more dithiol; and t₁ through t_{y} represent the number of equivalents of each corresponding dithiol; and y is an integer greater than or equal to 1 that represents the total number of dithiols present.

In a non-limiting embodiment, a group of two or more different dienes and the corresponding number of equivalents of each diene can be described by the term dᵢDᵢ (such as d₁D₁ through dₓDₓ as shown in Scheme I above), wherein Dᵢ represents the i^{th} diene and dᵢ represents the number of equivalents of Dᵢ, being can be an integer ranging from 1 to x, wherein x is an integer, greater than or equal to 2, that defines the total number of different dienes that are present. Furthermore, the sum of the number of equivalents of all dienes present can be represented by the term d, defined according to Expression (I),

$$d = {\sum }_{i = 1}^{x} {d}_{i} \qquad Expression ( I )$$

wherein i, x, and dᵢ are as defined above.

Similarly, the group of one or more dithiol and the corresponding number of equivalents of each dithiol can be described by the term tⱼTⱼ (such as t₁T₁ through t_{y}T_{y}, as shown in Scheme I above), wherein Tⱼ represents the j^{th} dithiol and tⱼ represents the number of equivalents of the corresponding dithiol Tⱼ, j being an integer ranging from 1 to y, wherein y is an integer that defines the total number of dithiols present, and y has a value greater than or equal to 1. Furthermore, the sum of the number of equivalents of all dithiols present can be represented by the term t, defined according to Expression (II),

$$t = {\sum }_{j = 1}^{y} {t}_{j} \qquad Expression ( II )$$

wherein j, y, and tⱼ are as defined above.

The ratio of the sum of the number of equivalents of all dithiols present to the sum of the number of equivalents of all dienes present can be characterized by the term t:d, wherein t and d are as defined above. The ratio t:d can have values greater than 1:1. In non-limiting embodiments, the ratio t:d can have values within the range of from greater than 1:1 to 3:1, or from 1.01:1 to 3:1, or from 1.01:1 to 2:1, or from 1.05:1 to 2:1, or from 1.1:1 to 1.5:1, or from 1.25:1 to 1.5:1.

As is known in the art, for a given set of dienes and dithiols, a statistical mixture of oligomer molecules with varying molecular weights are formed during the reaction in which the polythiol oligomer is prepared, where the number average molecular weight of the resulting mixture can be calculated and predicted based upon the molecular weights of the dienes and dithiols, and the relative equivalent ratio or mole ratio of the dienes and dithiols present in the reaction mixture that is used to prepare said polythiol oligomer. As is also known to those skilled in the art, the above parameters can be varied in order to adjust the number average molecular weight of the polythiol oligomer. The following is a hypothetical example: if the value of x as defined above is 2, and the value of y is 1; and diene₁ has a molecular weight (MW) of 100, diene₂ has a molecular weight of 150, dithiol has a molecular weight of 200; and diene₁, diene₂, and dithiol are present in the following molar amounts: 2 moles of diene₁, 4 moles of diene₂, and 8 moles of dithiol; then the number average molecular weight (Mₙ) of the resulting polythiol oligomer is calculated as follows:
Mₙ={(moles_{diene1}×MW_{diene1})+(moles_{diene2}×MW_{diene2})+(moles_{dithiol}×MW_{dithiol})}/m;
wherein m is the number of moles of the material that is present in the smallest molar amount.

$$\begin{matrix}= \{ ( 2 \times 100 ) + ( 4 \times 150 ) + ( 8 \times 200 ) \} / 2 \\ = 1200 g \text{/} mole\end{matrix}$$

As used herein and in the claims when referring to the group of two or more different dienes used in the preparation of the polythiol oligomer, the term “different dienes” refers to dienes that can be different from one another in various aspects. In non-limiting embodiments, the “different dienes” can be different from one another as follows: a) non-cyclic vs. cyclic; b) aromatic ring-containing vs. non-aromatic ring-containing; or c) monocyclic non-aromatic vs. polycyclic non-aromatic ring-containing; whereby non-limiting embodiments of this invention can include the following:

a) at least one non-cyclic diene and at least one cyclic diene selected from non-aromatic ring-containing dienes, including but not limited to dienes containing non-aromatic monocyclic groups or dienes containing non-aromatic polycyclic groups, or combinations thereof, and/or aromatic ring-containing dienes; or

b) at least one aromatic ring-containing diene and at least one diene selected from non-aromatic cyclic dienes, as described above; or

c) at least one non-aromatic diene containing non-aromatic monocyclic group, and at least one non-aromatic diene containing polycyclic non-aromatic group.

In a non-limiting embodiment, the polythiol oligomer can be as depicted in Formula (AA′) in Scheme II below, produced from the reaction of Diene₁ and Diene₂ with a dithiol; wherein R₂, R₄, R₆, and R₇ can be independently chosen from H, methyl, or ethyl, and R₁ and R₃ can be independently chosen from straight chain and/or branched aliphatic non-cyclic moieties, non-aromatic ring-containing moieties, including non-aromatic monocyclic moieties or non-aromatic polycyclic moieties or combinations thereof; aromatic ring-containing moieties; or heterocyclic ring-containing moieties; or moieties containing any combination of such non-cyclic and/or cyclic groups; with the proviso that Diene₁ and Diene₂ are different from one another, and contain double bonds capable of undergoing reaction with SH groups of dithiol, and forming covalent C—S bonds; and wherein R₅ can be chosen from divalent groups containing straight chain and/or branched non-cyclic aliphatic groups, cycloaliphatic groups, aryl groups, aryl-alkyl groups, heterocyclic groups, or combinations or mixtures thereof; and wherein R₁, R₃, and R₅ can optionally contain ether, thioether, disulfide, polysulfide, sulfone, ester, thioester, carbonate, thiocarbonate, urethane, or thiourethane linkages, or halogen substituents, or combinations thereof; and n is an integer ranging from 1 to 20.

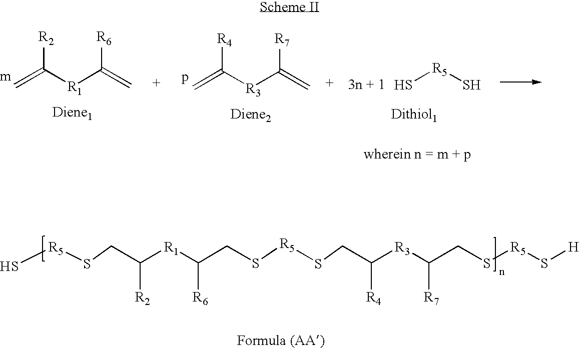

In a second non-limiting embodiment, the polythiol oligomer can be as depicted in Formula (AA″) in Scheme III below, produced from the reaction of Diene₁ and 5-vinyl-2-norbornene (VNB) with a dithiol; wherein R₂ and R₄ can be independently chosen from H, methyl, or ethyl, and R₁, can be chosen from straight chain and/or branched aliphatic non-cyclic moieties, non-aromatic monocyclic ring-containing moieties; aromatic ring-containing moieties; or heterocyclic ring-containing moieties; or include moieties containing any combination of such non-cyclic and/or cyclic groups; with the proviso that Diene₁ is different from VNB, and contains double bonds capable of reacting with SH groups of dithiol, and forming covalent C—S bonds; and wherein R₃ can be chosen from divalent groups containing straight chain and/or branched non-cyclic aliphatic groups, cycloaliphatic groups, aryl groups, aryl-alkyl groups, heterocyclic groups, or combinations or mixtures thereof, and wherein R₁ and R₃ can optionally contain ether, thioether, disulfide, polysulfide, sulfone, ester, thioester, carbonate, thiocarbonate, urethane, or thiourethane linkages, or halogen substituents, or combinations thereof; and n is an integer ranging from 1 to 20.

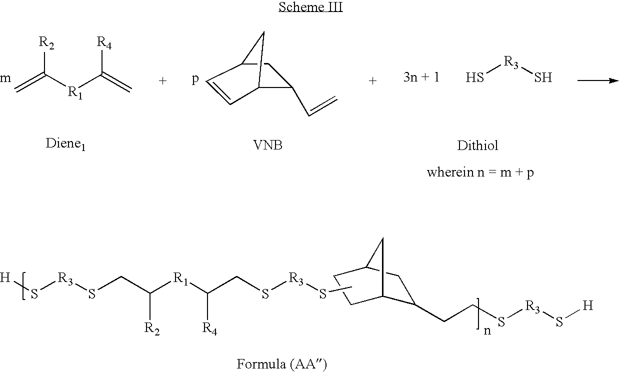

In a third non-limiting embodiment, the polythiol oligomer can be as depicted in Formula (AA′″) in Scheme IV below, produced from the reaction of Diene₁ and 4-vinyl-1-cyclohexene (VCH) with a dithiol; wherein R₂ and R₄ can be independently chosen from H, methyl, or ethyl, and R₁ can be chosen from straight chain and/or branched aliphatic non-cyclic moieties, non-aromatic polycyclic ring-containing moieties; aromatic ring-containing moieties; or heterocyclic ring-containing moieties; or moieties containing any combination of such non-cyclic and/or cyclic groups; with the proviso that Diene₁ is different from VCH, and contains double bonds capable of reacting with SH group of dithiol, and forming covalent C—S bonds; and wherein R₃ can be chosen from divalent groups containing straight chain and/or branched non-cyclic aliphatic groups, cycloaliphatic groups, aryl groups, aryl-alkyl groups, heterocyclic groups, or combinations or mixtures thereof, and wherein R₁, and R₃ can optionally contain thioether, disulfide, polysulfide, sulfone, ester, thioester, carbonate, thiocarbonate, urethane, or thiourethane linkages, or halogen substituents, or combinations thereof; and n is an integer ranging from 1 to 20.

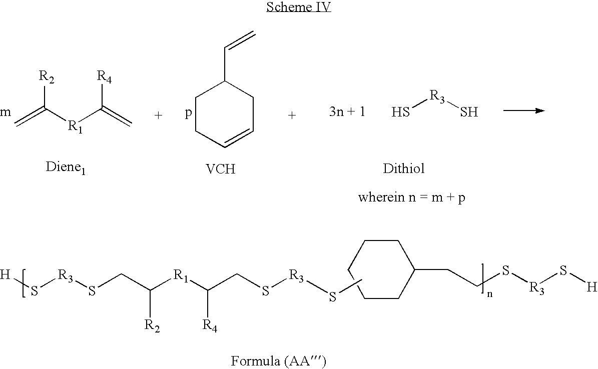

In a further non-limiting embodiment, the polythiol for use in the present invention can include polythiol oligomer produced by the reaction of at least two or more different dienes with at least one or more dithiol, and, optionally, one or more trifunctional or higher functional polythiol; wherein the stoichiometric ratio of the sum of the number of equivalents of polythiol present to the sum of the number of equivalents of diene present is greater than 1.0:1.0; and wherein the two or more different dienes can each be independently chosen from non-cyclic dienes, including straight chain and/or branched aliphatic non-cyclic dienes; non-aromatic ring-containing dienes, including non-aromatic ring-containing dienes wherein the double bonds can be contained within the ring or not contained within the ring or any combination thereof, and wherein said non-aromatic ring-containing dienes can contain non-aromatic monocyclic groups or non-aromatic polycyclic groups or combinations thereof; aromatic ring-containing dienes; heterocyclic ring-containing dienes; or dienes containing any combination of such non-cyclic and/or cyclic groups, and wherein said two or more different dienes can optionally contain thioether, disulfide, polysulfide, sulfone, ester, thioester, carbonate, thiocarbonate, urethane, or thiourethane linkages, or halogen substituents, or combinations thereof; with the proviso that said dienes contain double bonds capable of undergoing reaction with SH groups of polythiol, and forming covalent C—S bonds, and at least two or more of said dienes are different from one another; the one or more dithiol can each be independently chosen from dithiols containing straight chain and/or branched non-cyclic aliphatic groups, cycloaliphatic groups, aryl groups, aryl-alkyl groups, heterocyclic groups, or combinations or mixtures thereof, and wherein said one or more dithiol can each optionally contain thioether, disulfide, polysulfide, sulfone, ester, thioester, carbonate, thiocarbonate, urethane, or thiourethane linkages, or halogen substituents, or combinations thereof; the trifunctional or higher functional polythiol can be chosen from polythiols containing non-cyclic aliphatic groups, cycloaliphatic groups, aryl groups, aryl-alkyl groups, heterocyclic groups, or combinations or mixtures thereof, and wherein said trifunctional or higher functional polythiol can each optionally contain thioether, disulfide, polysulfide, sulfone, ester, thioester, carbonate, thiocarbonate, urethane, or thiourethane linkages, or halogen substituents, or combinations thereof.

Suitable dithiols for use in preparing the polythiol oligomer can be selected from a wide variety known in the art. Non-limiting examples can include those disclosed herein. Further non-limiting examples of suitable dithiols for use in preparing the polythiol oligomer can include but are not limited to 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), 2-mercaptoethylsulfide (DMDS), methyl-substituted 2-mercaptoethylsulfide, dimethyl-substituted 2-mercaptoethylsulfide, 1,8-dimercapto-3,6-dioxaoctane and 1,5-dimercapto-3-oxapentane. In alternate non-limiting embodiments, the dithiol can be 2,5-dimercaptomethyl-1,4-dithiane, ethylene glycol di(2-mercaptoacetate), ethylene glycol di(3-mercaptopropionate), poly(ethylene glycol) di(2-mercaptoacetate), poly(ethylene glycol) di(3-mercaptopropionate), dipentene dimercaptan (DPDM), and mixtures thereof.

Suitable trifunctional and higher-functional polythiols for use in preparing the polythiol oligomer can be selected from a wide variety known in the art. Non-limiting examples can include those disclosed herein. Further non-limiting examples of suitable trifunctional and higher-functional polythiols for use in preparing the polythiol oligomer can include but are not limited to pentaerythritol tetrakis (2-mercaptoacetate), pentaerythritol tetrakis (3-mercaptopropionate), trimethylolpropane tris(2-mercaptoacetate), trimethylolpropane tris(3-mercaptopropionate), thioglycerol bis(2-mercaptoacetate), and mixtures thereof.

Suitable dienes for use in preparing the polythiol oligomer can vary widely and can be selected from those known in the art. Non-limiting examples of suitable dienes can include but are not limited to acyclic non-conjugated dienes, acyclic polyvinyl ethers, allyl- and vinyl-acrylates, allyl- and vinyl-methacrylates, diacrylate and dimethacrylate esters of linear diols and dithiols, diacrylate and dimethacrylate esters of poly(alkyleneglycol) diols, monocyclic aliphatic dienes, polycyclic aliphatic dienes, aromatic ring-containing dienes, diallyl and divinyl esters of aromatic ring dicarboxylic acids, and mixtures thereof.

Non-limiting examples of acyclic non-conjugated dienes can include those represented by the following general formula: 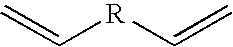
wherein R can represent C₂ to C₃₀ linear branched divalent saturated alkylene radical, or C₂ to C₃₀ divalent organic radical containing at least one element selected from the group consisting of sulfur, oxygen and silicon in addition to carbon and hydrogen atoms.

In alternate non-limiting embodiments, the acyclic non-conjugated dienes can be selected from 1,5-hexadiene, 1,6-heptadiene, 1,7-octadiene and mixtures thereof.

Non-limiting examples of suitable acyclic polyvinyl ethers can include but are not limited to those represented by structural formula (V′):
CH₂═CH—O—(—R²—O—)ₘ—CH═CH₂ (V′)
wherein R² can be C₂ to C₆ n-alkylene, C₂ to C₆ branched alkylene group, or —[(CH₂—)ₚ—O—]_{q}—(—CH₂—)ᵣ—, m can be a rational number from 0 to 10, p can be an integer from 2 to 6, q can be an integer from 1 to 5 and r can be an integer from 2 to 10.

In a non-limiting embodiment, m can be two (2).

Non-limiting examples of suitable polyvinyl ether monomers for use can include divinyl ether monomers, such as but not limited to ethylene glycol divinyl ether, diethylene glycol divinyl ether, triethyleneglycol divinyl ether, and mixtures thereof.

Non-limiting examples of suitable allyl- and vinyl-acrylates and methacrylates can include but are not limited to those represented by the following formulas: 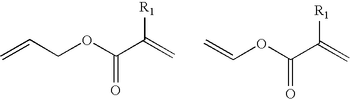
wherein R₁ each independently can be hydrogen or methyl.

In a non-limiting embodiment, the acrylate and methacrylate monomers can include monomers such as but not limited to allyl methacrylate, allyl acrylate and mixtures thereof.

Non-limiting examples of diacrylate and dimethacrylate esters of linear diols can include but are not limited to those represented by the following structural formula: 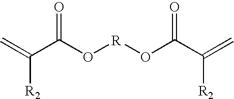
wherein R can represent C₁ to C₃₀ divalent saturated alkylene radical; branched divalent saturated alkylene radical; or C₂ to C₃₀ divalent organic radical containing at least one element selected from sulfur, oxygen and silicon in addition to carbon and hydrogen atoms; and R₂ can represent hydrogen or methyl.

In alternate non-limiting embodiments, the diacrylate and dimethacrylate esters of linear diols can include ethanediol dimethacrylate, 1,3-propanediol diacrylate, 1,3-propanediol dimethacrylate, 1,2-propanediol diacrylate, 1,2-propanediol dimethacrylate, 1,4-butanediol diacrylate, 1,4-butanediol dimethacrylate, 1,3-butanediol diacrylate, 1,3-butanediol dimethacrylate, 1,2-butanediol diacrylate, 1,2-butanediol dimethacrylate, and mixtures thereof.

Non-limiting examples of diacrylate and dimethacrylate esters of poly(alkyleneglycol) diols can include but are not limited to those represented by the following structural formula: 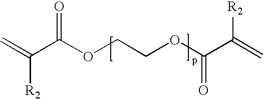
wherein R₂ can represent hydrogen or methyl and p can represent an integer from 1 to 5.

In alternate non-limiting embodiments, the diacrylate and dimethacrylate esters of poly(alkyleneglycol) diols can include ethylene glycol dimethacrylate, ethylene glycol diacrylate, diethylene glycol dimethacrylate, diethylene glycol diacrylate, and mixtures thereof.

Further non-limiting examples of suitable dienes can include monocyclic aliphatic dienes such as but not limited to those represented by the following structural formulas: 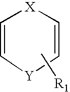
wherein X and Y each independently can represent C₁₋₁₀ divalent saturated alkylene radical; or C₁₋₅ divalent saturated alkylene radical, containing at least one element selected from the group of sulfur, oxygen and silicon in addition to the carbon and hydrogen atoms; and R₁ can represent H, or C₁-C₁₀ alkyl; and 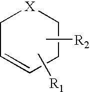
wherein X and R₁ can be as defined above and R₂ can represent C₂-C₁₀ alkenyl.

In alternate non-limiting embodiments, the monocyclic aliphatic dienes can include 1,4-cyclohexadiene, 4-vinyl-1-cyclohexene, dipentene and terpinene.

Non-limiting examples of polycyclic aliphatic dienes can include but are not limited to 5-vinyl-2-norbornene; 2,5-norbornadiene; dicyclopentadiene and mixtures thereof.

Non-limiting examples of aromatic ring-containing dienes can include but are not limited to those represented by the following structural formula: 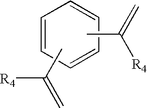
wherein R₄ can represent hydrogen or methyl.

In alternate non-limiting embodiments, the aromatic ring-containing dienes can include monomers such as 1,3-diispropenyl benzene, divinyl benzene and mixtures thereof.

Non-limiting examples of diallyl esters of aromatic ring dicarboxylic acids can include but are not limited to those represented by the following structural formula: 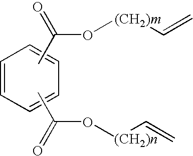
wherein m and n each independently can be an integer from 0 to 5.

In alternate non-limiting embodiments, the diallyl esters of aromatic ring dicarboxylic acids can include o-diallyl phthalate, m-diallyl phthalate, p-diallyl phthalate and mixtures thereof.

In a non-limiting embodiment, reaction of at least one polythiol with two or more different dienes can be carried out in the presence of radical initiator. Suitable radical initiators for use in the present invention can vary widely and can include those known to one of ordinary skill in the art. Non-limiting examples of radical initiators can include but are not limited to azo or peroxide type free-radical initiators such as azobisalkalenenitriles. In a non-limiting embodiment, the free-radical initiator can be azobisalkalenenitrile which is commercially available from DuPont under the trade name VAZO™. In alternate non-limiting embodiments, VAZO-52, VAZO-64, VAZO-67, VAZO-88 and mixtures thereof can be used as radical initiators.

In a non-limiting embodiment, selection of the free-radical initiator can depend on reaction temperature. In a non-limiting embodiment, the reaction temperature can vary from room temperature to 100° C. In further alternate non-limiting embodiments, Vazo 52 can be used at a temperature of from 50-60° C., or Vazo 64 or Vazo 67 can be used at a temperature of 60° C. to 75° C., or Vazo 88 can be used at a temperature of 75-100° C.

The reaction of at least one polythiol and two or more different dienes can be carried out under a variety of reaction conditions. In alternate non-limiting embodiments, limited to vinyl ethers, aliphatic dienes and cycloaliphatic dienes.

Not intending to be bound by any particular theory, it is believed that as the mixture of polythiol, dienes and radical intiator is heated, the double bonds are at least partially consumed by reaction with the SH groups of the polythiol. The mixture can be heated for a sufficient period of time such that the double bonds are essentially consumed and a pre-calculated theoretical value for SH content is reached. In a non-limiting embodiment, the mixture can be heated for a time period of from 1 hour to 5 days. In another non-limiting embodiment, the mixture can be heated at a temperature of from 40° C. to 100° C. In a further non-limiting embodiment, the mixture can be heated until a theoretical value for SH content of from 0.7% to 17% is reached.

The number average molecular weight (Mₙ) of the resulting polythiol oligomer can vary widely. The number average molecular weight (Mₙ) of polythiol oligomer can be predicted based on the stoichiometry of the reaction. In alternate non-limiting embodiments, the Mₙ of polythiol oligomer can vary from 400 to 10,000 g/mole, or from 1000 to 3000 g/mole.

The viscosity of the resulting polythiol oligomer can vary widely. In alternate non-limiting embodiments, the viscosity can be from 40 cP to 4000 cP at 73° C., or from 40 cP to 2000 cP at 73° C., or from 150 cP to 1500 cP at 73° C.

In a non-limiting embodiment, vinylcyclohexene (VCH) and 1,5-hexadiene (1,5-HD) can be combined together, and 2-mercaptoethylsulfide (DMDS) and a radical initiator (such as Vazo 52) can be mixed together, and this mixture can be added dropwise to the mixture of dienes at a rate such that a temperature of 60° C. is not exceeded. After the addition is completed, the mixture can be heated to maintain a temperature of 60° C. until the double bonds are essentially consumed and the pre-calculated theoretical value for SH content is reached.

In alternate non-limiting embodiments, polythiol oligomer can be prepared from the following combinations of dienes and polythiol:
(a) 5-vinyl-2-norbornene (VNB), diethylene glycol divinyl ether (DEGDVE) and DMDS;
(b) VNB, butanediol divinylether (BDDVE), DMDS;
(c) VNB, DEGDVE, BDDVE, DMDS;
(d) 1,3-diisopropenylbenzene (DIPEB), DEGDVE and DMDS;
(e) DIPEB, VNB and DMDS;
(f) DIPEB, 4-vinyl-1-cyclohexene (VCH), DMDS; (g) allylmethacrylate (AM), VNB, and DMDS;
(h) VCH, VNB, and DMDS;
(i) Limonene (L), VNB and DMDS
(j) Ethylene glycol dimethacrylate (EGDM), VCH and DMDS;
(k) Diallylphthalate (DAP), VNB, DMDS;
(l) Divinylbenzene (DVB), VNB, DMDS; and
(m) DVB, VCH, DMDS

In an alternate non-limiting embodiment, the polythiol for use in the present invention can be polythiol oligomer prepared by reacting one or more dithiol and, optionally; one or more trifunctional or higher functional polythiol with two or more dienes, wherein said dienes can be selected such that at least one diene has refractive index of at least 1.52 and at least one other diene has Abbe number of at least 40, wherein said dienes contain double bonds capable of reacting with SH groups of polythiol, and forming covalent C—S bonds; and wherein the stoichiometric ratio of the sum of the number of equivalents of all polythiols present to the sum of the number of equivalents of all dienes present is greater than 1.0:1.0. In a further non-limiting embodiment, the diene with refractive index of at least 1.52 can be selected from dienes containing at least one aromatic ring, and/or dienes containing at least one sulfur-containing substituent, with the proviso that said diene has refractive index of at least 1.52; and the diene with Abbe number of at least 40 can be selected from cyclic or non-cyclic dienes not containing an aromatic ring, with the proviso that said diene has Abbe number of at least 40. In yet a further non-limiting embodiment, the diene with refractive index of at least 1.52 can be selected from diallylphthalate and 1,3-diisopropenyl benzene; and the diene with Abbe number of at least 40 can be selected from 5-vinyl-2-norbornene, 4-vinyl-1-cyclohexene, limonene, diethylene glycol divinyl ether, and allyl methacrylate.

As previously stated herein, the nature of the SH group of polythiols is such that oxidative coupling can occur readily, leading to formation of disulfide linkages. Various oxidizing agents can lead to such oxidative coupling. The oxygen in the air can in some cases lead to such oxidative coupling during storage of the polythiol. It is believed that a possible mechanism for the coupling of thiol groups involves the formation of thiyl radicals, followed by coupling of said thiyl radicals, to form disulfide linkage. It is further believed that formation of disulfide linkage can occur under conditions that can lead to the formation of thiyl radical, including but not limited to reaction conditions involving free radical initiation.

In a non-limiting embodiment, the polythiol oligomer for use in the present invention can contain disulfide linkages present in the dithiols and/or polythiols used to prepare said polythiol oligomer. In another non-limiting embodiment, the polythiol oligomer for use in the present invention can contain disulfide linkage formed during the synthesis of said polythiol oligomer. In another non-limiting embodiment, the polythiol oligomer for use in the present invention can contain disulfide linkages formed during storage of said polythiol oligomer.

In another non-limiting embodiment, polythiol for use in the present invention can include a material represented by the following structural formula and reaction scheme: 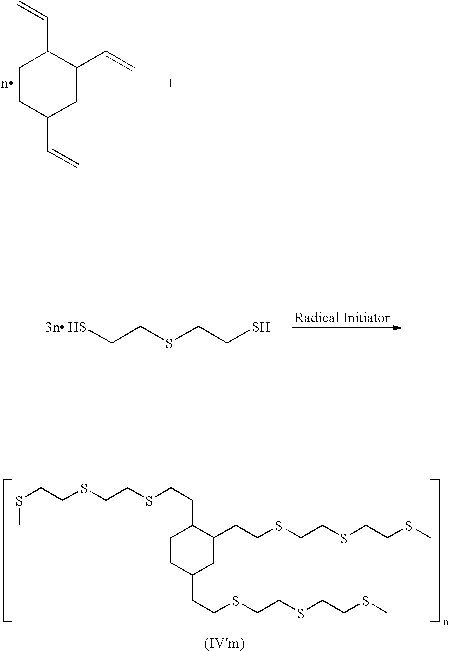
where n can be an integer from 1 to 20.

In a non-limiting embodiment, the polythiol of formula (IV′m) can be prepared by reacting “n” moles of 1,2,4-trivinylcyclohexane with “3n” moles of dimercaptodiethylsulfide (DMDS), and heating the mixture in the presence of a suitable free radical initiator, such as but not limited to VAZO 64.

In another non-limiting embodiment, the polythiol for use in the present invention can include a material represented by the following structural formula: 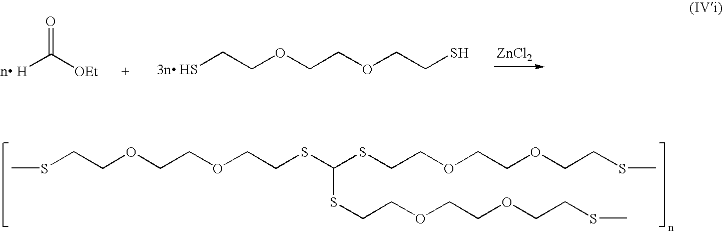
wherein n can be an integer from 1 to 20.

Various methods of preparing the polythiol of the formula (IV′i) are described in detail in U.S. Pat. No. 5,225,472, from column 2, line 8 to column 5, line 8.

In a non-limiting embodiment, “3n” moles of 1,8-dimercapto-3,6-dioxaooctane (DMDO) can be reacted with “n” moles of ethyl formate, as shown above, in the presence of anhydrous zinc chloride.

In alternate non-limiting embodiments, the active hydrogen-containing material for use in the present invention can be chosen from polyether glycols and polyester glycols having a number average molecular weight of at least 200 grams/mole, or at least 300 grams/mole, or at least 750 grams/mole; or no greater than 1,500 grams/mole, or no greater than 2,500 grams/mole, or no greater than 4,000 grams/mole.

Non-limiting examples of suitable active hydrogen-containing materials having both hydroxyl and thiol groups can include but are not limited to 2-mercaptoethanol, 3-mercapto-1,2-propanediol, glycerin bis(2-mercaptoacetate), glycerin bis(3-mercaptopropionate), 1-hydroxy-4-mercaptocyclohexane, 1,3-dimercapto-2-propanol, 2,3-dimercapto-1-propanol, 1,2-dimercapto-1,3-butanediol, trimethylolpropane bis(2-mercaptoacetate), trimethylolpropane bis(3-mercaptopropionate), pentaerythritol mono(2-mercaptoacetate), pentaerythritol bis(2-mercaptoacetate), pentaerythritol tris(2-mercaptoacetate), pentaerythritol mono(3-mercaptopropionate), pentaerythritol bis(3-mercaptopropionate), pentaerythritol tris(3-mercaptopropionate), hydroxymethyl-tris(mercaptoethylthiomethyl)methane, dihydroxyethyl sulfide mono(3-mercaptopropionate, and mixtures thereof. The sulfur-containing polyureaurethane of the present invention can be prepared using a variety of techniques known in the art. In a non-limiting embodiment of the present invention, polyisocyanate, polyisothiocyanate or mixtures thereof and at least one active hydrogen-containing material can be reacted to form polyurethane prepolymer, and the polyurethane prepolymer can be reacted with an amine-containing curing agent. In a further non-limiting embodiment, the active hydrogen-containing material can include at least one material chosen from polyol, polythiol, polythiol oligomer and mixtures thereof. In still a further non-limiting embodiment, the polyurethane prepolymer can be reacted with amine-containing curing agent. In a further non-limiting embodiment, said amine-containing curing agent can comprise a combination of amine-containing material and active hydrogen-containing material chosen from polyol, polythiol, polythiol oligomer and mixtures thereof.

In a further non-limiting embodiment, said active hydrogen-containing material can further comprise material containing both hydroxyl and SH groups.

In a non-limiting embodiment, said polyurethane prepolymer can contain disulfide linkages due to disulfide linkages contained in polythiol and/or polythiol oligomer used to prepare the polyurethane prepolymer.

In another non-limiting embodiment, polyisocyanate, polyisothiocyanate, or mixtures thereof, at least one active hydrogen-containing material and amine-containing curing agent can be reacted together in a “one pot” process. In a further non-limiting embodiment, the active hydrogen-containing material can include at least one material chosen from polyol, polythiol, polythiol oligomer and mixtures thereof.

In further alternate non-limiting embodiments, the polyisocyanate, can include meta-tetramethylxylylene diisocyanate (1,3-bis(1-isocyanato-1-methylethyl-benzene); 3-isocyanato-methyl-3,5,5,-trimethyl-cyclohexyl isocyanate 4,4-methylene bis(cyclohexyl isocyanate); meta-xylylene diisocyanate; and mixtures thereof.

Amine-containing curing agents for use in the present invention are numerous and widely varied. Non-limiting examples of suitable amine-containing curing agents can include but are not limited to aliphatic polyamines, cycloaliphatic polyamines, aromatic polyamines and mixtures thereof. In alternate non-limiting embodiments, the amine-containing curing agent can include polyamine having at least two functional groups independently chosen from primary amine (—NH₂), secondary amine (—NH—) and combinations thereof. In a further non-limiting embodiment, the amine-containing curing agent can have at least two primary amine groups. In another non-limiting embodiment, the amine-containing curing agent can comprise a mixture of a polyamine and at least one material selected from polythiol, polyol and mixtures thereof. Non-limiting examples of suitable polythiols and polyols include those previously recited herein.

In another non-limiting embodiment, the amine-containing curing agent can be a sulfur-containing amine-containing curing agent. A non-limiting example of a sulfur-containing amine-containing curing agent can include Ethacure 300 which is commercially available from Albemarle Corporation.

In an embodiment wherein it is desirable to produce a polyureaurethane having low color, the amine-curing agent can be chosen such that it has relatively low color and/or it can be manufactured and/or stored in a manner as to prevent the amine from developing color (e.g., yellow).

Suitable amine-containing curing agents for use in the present invention can include but are not limited to materials having the following chemical formula: 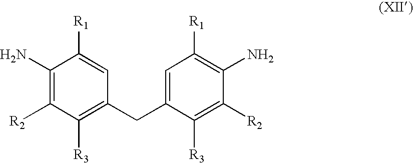
wherein R₁ and R₂ can each be independently chosen from methyl, ethyl, propyl, and isopropyl groups, and R₃ can be chosen from hydrogen and chlorine. Non-limiting examples of amine-containing curing agents for use in the present invention include the following compounds, manufactured by Lonza Ltd. (Basel, Switzerland):

LONZACURE® M-DIPA: R₁═C₃H₇; R₂═C₃H₇; R₃═H

LONZACURE® M-DMA: R₁═CH₃; R₂═CH₃; R₃═H

LONZACURE® M-MEA: R₁═CH₃; R₂═C₂ Hs; R₃═H

LONZACURE® M-DEA: R₁═C₂H₅; R₂═C₂H₅; R₃═H

LONZACURE® M-MIPA: R₁═CH₃; R₂═C₃H₇; R₃═H

LONZACURE® M-CDEA: R₁═C₂H₅; R₂═C₂H₅; R₃=Cl

wherein R₁, R₂ and R₃ correspond to Formula (XII′).

In a non-limiting embodiment, the amine-containing curing agent can include but is not limited to diamine curing agent such as 4,4′-methylenebis(3-chloro-2,6-diethylaniline), (Lonzacure® M-CDEA), which is available from Air Products and Chemical, Inc. (Allentown, Pa.). In alternate non-limiting embodiments, the amine-containing curing agent for use in the present invention can include 2,4-diamino-3,5-diethyl-toluene, 2,6-diamino-3,5-diethyl-toluene and mixtures thereof (collectively “diethyltoluenediamine” or “DETDA”) which is commercially available from Albemarle Corporation under the trade name Ethacure 100; dimethylthiotoluenediamine (DMTDA) which is commercially available from Albemarle Corporation under the trade name Ethacure 300; 4,4′-methylene-bis-(2-chloroaniline) which is commercially available from Kingyorker Chemicals under the trade name MOCA and mixtures thereof. In a non-limiting embodiment, DETDA can be a liquid at room temperature with a viscosity of 156 cPs at 25° C. In another non-limiting embodiment, DETDA can be isomeric, with the 2,4-isomer range being from 75 to 81 percent while the 2,6-isomer range can be from 18 to 24 percent.

In a non-limiting embodiment, the color stabilized version of Ethacure 100 (i.e., formulation which contains an additive to reduce yellow color), which is available under the name Ethacure 100S may be used in the present invention.

In a non-limiting embodiment, the amine-containing curing agent can act as catalyst in the polymerization reaction and can be incorporated into the resulting polymerizate.

Further, non-limiting examples of suitable amine-containing curing agents can include ethyleneamines such as but not limited to ethylenediamine (EDA), diethylenetriamine (DETA), triethylenetetramine (TETA), tetraethylenepentamine (TEPA), pentaethylenehexamine (PEHA), piperazine, morpholine, substituted morpholine, piperidine, substituted piperidine, diethylenediamine (DEDA), 2-amino-1-ethylpiperazine and mixtures thereof. In alternate non-limiting embodiments, the amine-containing curing agent can be chosen from one or more isomers of C₁-C₃ dialkyl toluenediamine such as but not limited to 3,5-dimethyl-2,4-toluenediamine, 3,5-dimethyl-2,6-toluenediamine, 3,5-diethyl-2,4-toluenediamine, 3,5-diethyl-2,6-toluenediamine, 3,5-diisopropyl-2,4-toluenediamine, 3,5-diisopropyl-2,6-toluenediamine, and mixtures thereof. In alternate non-limiting embodiments, the amine-containing curing agent can be methylene dianiline or trimethyleneglycol di(para-aminobenzoate) or mixtures thereof.

In alternate non-limiting embodiments of the present invention, the amine-containing curing agent can include at least one of the following general structures:

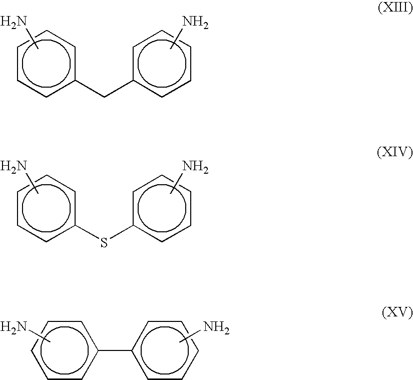

In further alternate non-limiting embodiments, the amine-containing curing agent can include one or more methylene bis anilines which can be represented by the general formulas XVI-XX, one or more aniline sulfides which can be represented by the general formulas XXI-XXV, and/or one or more bianilines which can be represented by the general formulas XXVI-XXVIX. 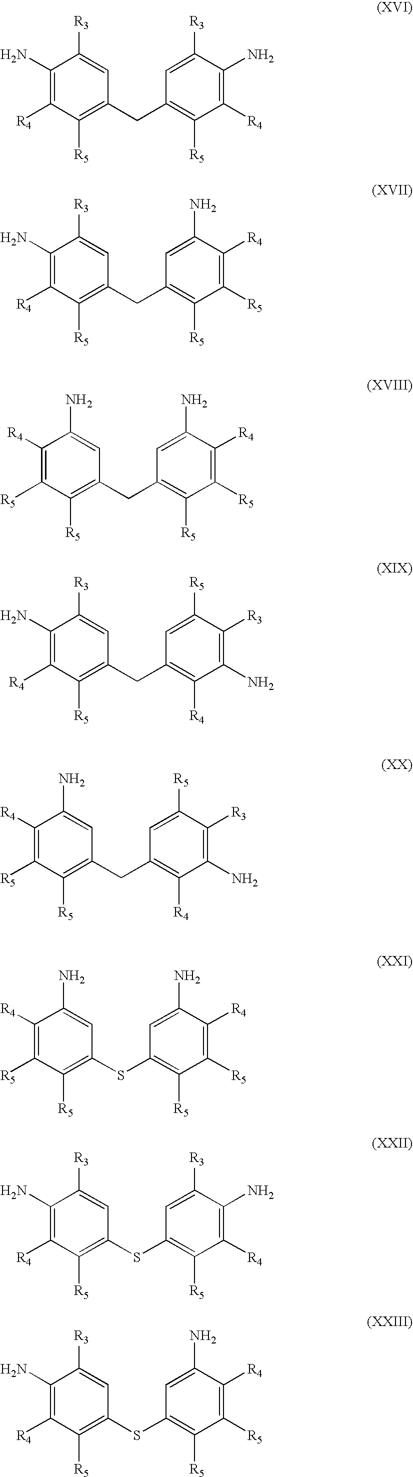 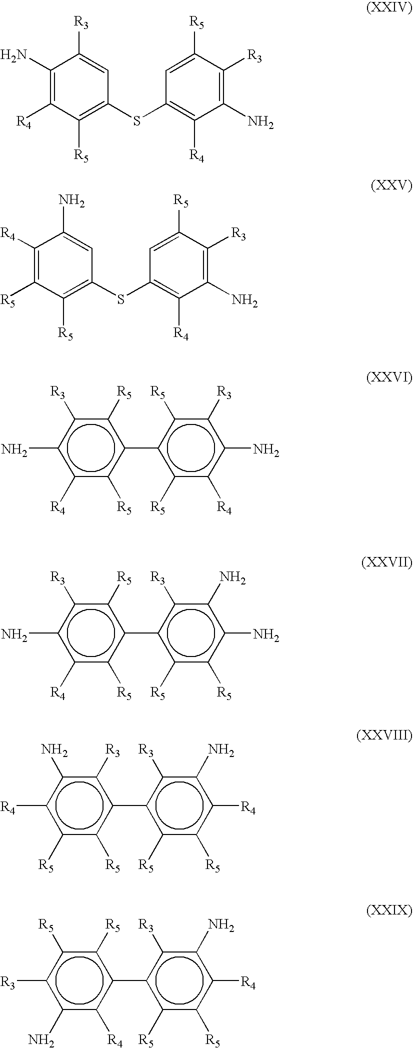
wherein R₃ and R₄ can each independently represent C₁ to C₃ alkyl, and R₅ can be chosen from hydrogen and halogen, such as but not limited to chlorine and bromine.

Non-limiting examples of suitable diamines for use in the present invention can include 4,4′-methylene-bis(dialkylaniline), 4,4′-methylene-bis(2,6-dimethylaniline), 4,4′-methylene-bis(2,6-diethylaniline), 4,4′-methylene-bis(2-ethyl-6-methylaniline), 4,4′-methylene-bis(2,6-diisopropylaniline), 4,4′-methylene-bis(2-isopropyl-6-methylaniline), 4,4′-methylene-bis(2,6-diethyl-3-chloroaniline), and mixtures thereof.

In a further non-limiting embodiment, the amine-containing curing agent can include materials which can be represented by the following general structure (XXX): 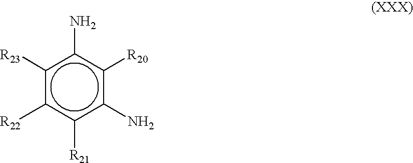
where R₂₀, R₂₁, R₂₂, and R₂₃ can be each independently chosen from H, C₁ to C₃ alkyl, CH₃—S— and halogen, such as but not, limited to chlorine or bromine. In a non-limiting embodiment of the present invention, the amine-containing curing agent represented by formula XXX can be diethyl toluene diamine (DETDA) wherein R₂₃ is methyl, R₂₀ and R₂₁ are each ethyl and R₂₂ is hydrogen. In a further non-limiting embodiment, the amine-containing curing agent can be 4,4′-methylenedianiline.

In another non-limiting embodiment, the amine-containing curing agent can include a combination of polyamine and material selected from polyol, polythiol, polythiol oligomer, materials containing both hydroxyl and SH groups, and mixtures thereof. Non-limiting examples of suitable polyamines, polythiols, polythiol oligomers, polyols, and/or materials containing both hydroxyl and SH groups for use in the curing agent mixture can include those previously recited herein. In a further non-limiting embodiment, the amine-containing curing agent for use in the present invention can be a combination of polyamine and polythiol and/or polythiol oligomer.

The sulfur-containing polyureaurethane of the present invention can be polymerized using a variety of techniques known in the art. In a non-limiting embodiment, the polyureaurethane can be prepared by combining polyisocyanate, polyisothiocyanate, or mixtures thereof and active hydrogen-containing material to form polyurethane prepolymer, and then introducing amine-containing curing agent, and polymerizing the resulting mixture.

In a non-limiting embodiment, the prepolymer and the amine-containing curing agent each can be degassed (e.g. under vacuum) prior to mixing them and carrying out the polymerization. The amine-containing curing agent can be mixed with the prepolymer using a variety of methods and equipment, such as but not limited to an impeller or extruder.

In another non-limiting embodiment, wherein the sulfur-containing polyureaurethane can be prepared by a one-pot process, the polyisocyanate and/or polyisothiocyanate, active hydrogen-containing material, amine-containing curing agent and optionally catalyst can be degassed and then combined, and the mixture then can be polymerized.

Suitable catalysts can be selected from those known in the art. Non-limiting examples can include but are not limited to tertiary amine catalysts or tin compounds or mixtures thereof. In alternate non-limiting embodiments, the catalysts can be dimethyl cyclohexylamine or dibutyl tin dilaurate or mixtures thereof. In further non-limiting embodiments, degassing can take place prior to or following addition of catalyst.

In another non-limiting embodiment, wherein a lens can be formed, the mixture, which can be optionally degassed, can be introduced into a mold and the mold can be heated (i.e., using a thermal cure cycle) using a variety of conventional techniques known in the art. The thermal cure cycle can vary depending on the reactivity and molar ratio of the reactants, and the presence of catalyst(s). In a non-limiting embodiment, the thermal cure cycle can include heating the mixture of polyurethane prepolymer and amine-containing curing agent, wherein said curing agent can include primary diamine or mixture of primary diamine and trifunctional or higher functional polyamine and optionally polyol and/or polythiol and/or polythiol oligomer; or heating the mixture of polyisocyanate and/or polyisothiocyanate, polyol and/or polythiol and/or polythiol oligomer, and amine-containing material; from room temperature to a temperature of 200° C. over a period of from 0.5 hours to 120 hours; or from 80 to 150° C. for a period of from 5 hours to 72 hours.

In a non-limiting embodiment, a urethanation catalyst can be used in the present invention to enhance the reaction of the polyurethane-forming materials. Suitable urethanation catalysts can vary; for example, suitable urethanation catalysts can include those catalysts that are useful for the formation of urethane by reaction of the NCO and OH-containing materials and/or the reaction of the NCO and SH-containing materials. Non-limiting examples of suitable catalysts can be chosen from the group of Lewis bases, Lewis acids and insertion catalysts as described in Ullmann's Encyclopedia of Industrial Chemistry, 5^{th} Edition, 1992, Volume A21, pp. 673 to 674. In a non-limiting embodiment, the catalyst can be a stannous salt of an organic acid, such as but not limited to stannous octoate, dibutyl tin dilaurate, dibutyl tin diacetate, dibutyl tin mercaptide, dibutyl tin dimaleate, dimethyl tin diacetate, dimethyl tin dilaurate, 1,4-diazabicyclo[2.2.2]octane, and mixtures thereof. In alternate non-limiting embodiments, the catalyst can be zinc octoate, bismuth, or ferric acetylacetonate.

Further non-limiting examples of suitable catalysts can include tin compounds such as but not limited to dibutyl tin dilaurate, phosphines, tertiary ammonium salts and tertiary amines such as but not limited to triethylamine, triisopropylamine, dimethyl cyclohexylamine, N,N-dimethylbenzylamine and mixtures thereof. Such suitable tertiary amines are disclosed in U.S. Pat. No. 5,693,738 at column 10, lines 6-38, the disclosure of which is incorporated herein by reference.

In non-limiting embodiments, sulfur-containing polyureaurethane of the present invention can be prepared the various combinations of ingredients shown in Table A bellow:

TABLE A

| | | | | Amine-Containing Curing | | |
|---|---|---|---|---|---|---|
| | Prepolymer Ingredients | | | Agent Ingredients | | |
| Embod- | Dithiol | | Diiso- | Di- | Dithiol | Poly- |
| iment # | Oligomer | Polyol | cyanates | amine | Oligomers | thiols |
| 1 | A | — | Des W | DETDA | A | — |
| 2 | A | — | Des W | DETDA | A | HITT |
| 3 | A | — | Des W | DETDA | A | HITT, |
| | | | | | | PTMA |
| 4 | B | — | Des W | DETDA | D | — |
| 5 | B | — | Des W | DETDA | — | HITT |
| 6 | B | — | Des W | DETDA | D | HITT |
| 7 | B | TMP | Des W | DETDA | B | — |
| 8 | B | TMP | Des W | DETDA | D | — |
| 9 | C | — | Des W | DETDA | D | — |
| 10 | C | — | Des W | DETDA | C, D | — |
| 11 | C | — | Des W, | DETDA | D | — |
| | | | IPDI | | | |
| 12 | C | — | Des W, | DETDA | C, D | — |
| | | | IPDI | | | |
| 13 | C | — | Des W, | DETDA | D | — |
| | | | TMXDI | | | |
| 14 | C | TMP | Des W, | DETDA | D | — |
| | | | IPDI | | | |
| 15 | C | TMP | Des W, | DETDA | D | — |
| | | | TMXDI | | | |

A = dithiol oligomer made from DMDS + VNB + DEGDVE
B = dithiol oligomer made from DMDS + DIPEB + DEGDVE
C = dithiol oligomer made from DMDS + DIPEB + VNB
D = dithiol oligomer made from DMDS + DIPEB
VNB = 5-vinyl-2-norbornene
DEGDVE = di(ethylene glycol) divinyl ether
DIPEB = 1,3-diisopropenylbenzene
DMDS = dimercaptodiethyll sulfide
HITT = polythiol made by reacting “3n” moles DMDS with “n” moles of 1,2,4-trivinylcyclohexane
(formula IV′m)
PTMA = pentaerythritol tetrakis(2-mercaptoacetate)
TMP = trimethylolpropane
Des W = 4,4′-methylene bis(cyclohexyl isocyanate)
IPDI = 3-isocyanato-methyl-3,5,5-trimethyl-cycolohexyl isocyanate
TMXDI = meta-tetramethylxylylene diisocyanate (1,3-bis(1-isocyanato-1-methylethyl-benzene))
DETDA = mixture of 2,4-diamino-3,5-diethyltoluene/2,6-diamino-3,5-diethyltoluene

In a non-limiting embodiment, wherein the sulfur-containing polyureaurethane can be prepared by introducing together a polyurethane prepolymer and an amine-containing curing agent, the polyurethane prepolymer can be reacted with at least one episulfide-containing material prior to being introduced together with amine-containing curing agent. Suitable episulfide-containing materials can vary, and can include but are not limited to materials having at least one, or two, or more episulfide functional groups. In a non-limiting embodiment, the episulfide-containing material can have two or more moieties represented by the following general formula: 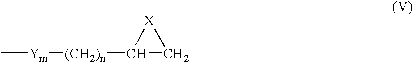
wherein X can be S or O; Y can be C₁-C₁₀ alkyl, O, or S; m can be an integer from 0 to 2, and n can be an integer from 0 to 10. In a non-limiting embodiment, the numerical ratio of S is 50% or more, on the average, of the total amount of S and O constituting a three-membered ring.

The episulfide-containing material having two or more moieties represented by the formula (V) can be attached to an acyclic and/or cyclic skeleton. The acyclic skeleton can be branched or unbranched, and it can contain sulfide and/or ether linkages. In a non-limiting embodiment, the episulfide-containing material can be obtained by replacing the oxygen in an epoxy ring-containing acyclic material using sulfur, thiourea, thiocyanate, triphenylphosphine sulfide or other such reagents known in the art. In a further non-limiting embodiment, alkylsulfide-type episulfide-containing materials can be obtained by reacting various known acyclic polythiols with epichlorohydrin in the presence of an alkali to obtain an alkylsulfide-type epoxy material; and then replacing the oxygen in the epoxy ring as described above.

In alternate non-limiting embodiments, the cyclic skeleton can include the following materials:

(a) an episulfide-containing material wherein the cyclic skeleton can be an alicyclic skeleton,

(b) an episulfide-containing material wherein the cyclic skeleton can be an aromatic skeleton, and

(c) an episulfide-containing material wherein the cyclic skeleton can be a heterocyclic skeleton including a sulfur atom as a hetero-atom.

In further non-limiting embodiments, each of the above materials can contain a linkage of a sulfide, an ether, a sulfone, a ketone, and/or an ester.

Non-limiting examples of suitable episulfide-containing materials having an alicyclic skeleton can include but are not limited to 1,3- and 1,4-bis(β-epithiopropylthio)cyclohexane, 1,3- and 1,4-bis(β-epithiopropylthiomethyl)cyclohexane, bis[4-(β-epithiopropylthio)cyclohexyl]methane, 2,2-bis[4-(β-epithiopropylthio)cyclohexyl]propane, bis[4-(β-epithiopropylthio)cyclohexyl]sulfide, 4-vinyl-1-cyclohexene diepisulfide, 4-epithioethyl-1-cyclohexene sulfide, 4-epoxy-1,2-cyclohexene sulfide, 2,5-bis(β-epithiopropylthio)-1,4-dithiane, and 2,5-bis(β-epithiopropylthioethylthiomethyl)-1,4-dithiane.

Non-limiting examples of suitable episulfide-containing materials having an aromatic skeleton can include but are not limited to 1,3- and 1,4-bis(β-epithiopropylthio)benzene, 1,3- and 1,4-bis(β-epithiopropylthiomethyl)benzene, bis[4-(β-epithiopropylthio)phenyl]methane, 2,2-bis[4-(β-epithiopropylthio)phenyl]propane, bis[4-(β-epithiopropylthio)phenyl]sulfide, bis[4-(β-epithiopropylthio)phenyl]sulfone, and 4,4-bis(β-epithiopropylthio)biphenyl.

Non-limiting examples of suitable episulfide-containing materials having a heterocyclic skeleton including the sulfur atom as the hetero-atom can include but are not limited to the materials represented by the following general formulas: 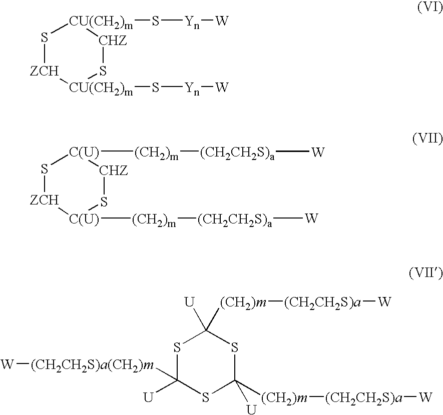
wherein m can be an integer from 1 to 5; n can be an integer from 0 to 4; a can be an integer from 0 to 5; U can be a hydrogen atom or an alkyl group haying 1 to 5 carbon atoms; Y can be —(CH₂CH₂S)—; Z can be chosen from a hydrogen atom, an alkyl group having 1 to 5 carbon atoms or —(CH₂)ₘSYₙW; W can be an epithiopropyl group represented by the following formula: 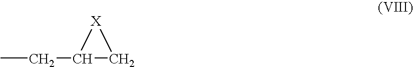
wherein X can be O or S.

Additional non-limiting examples of suitable episulfide-containing materials can include but are not limited to 2,5-bis(β-epithiopropylthiomethyl)-1,4-dithiane; 2,5-bis(β-epithiopropylthioethylthiomethyl)-1,4-dithiane; 2,5-bis(β-epithiopropylthioethyl)-1,4-dithiane; 2,3,5-tri(β-epithiopropylthioethyl)-1,4-dithiane; 2,4,6-tris(β-epithiopropylmethyl)-1,3,5-trithiane; 2,4,6-tris(β-epithiopropylthioethyl)-1,3,5-trithiane; 2,4,6-tris(β-epithiopropylthiomethyl)-1,3,5-trithiane; 2,4,6-tris(β-epithiopropylthioethylthioethyl)-1,3,5-trithiane;

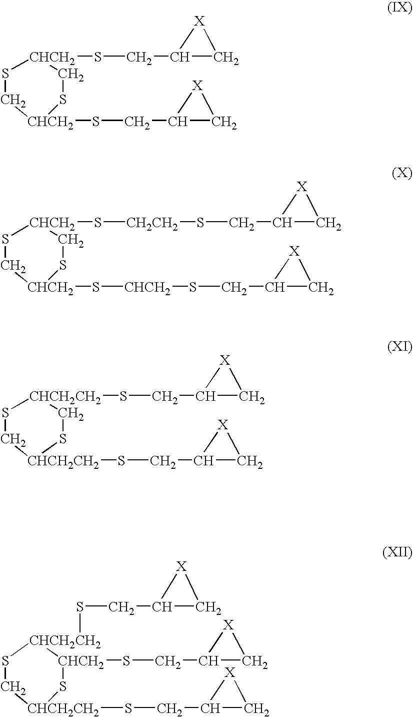

wherein X can be as defined above. In a non-limiting embodiment, the polyurethane prepolymer can be reacted with an episulfide-containing material of the structural formula XXXII:

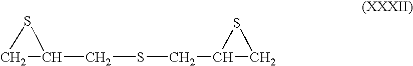

In alternate non-limiting embodiments, various known additives can be incorporated into the sulfur-containing polyureaurethane of the present invention. Such additives can include but are not limited to light stabilizers, heat stabilizers, antioxidants, ultraviolet light absorbers, mold release agents, static (non-photochromic) dyes, pigments and flexibilizing additives, such as but not limited to alkoxylated phenol benzoates and poly(alkylene glycol) dibenzoates. Non-limiting examples of anti-yellowing additives can include 3-methyl-2-butenol, organo pyrocarbonates and triphenyl phosphite (CAS registry no. 101-02-0). Such additives can be present in an amount such that the additive constitutes less than 10 percent by weight, or less than 5 percent by weight, or less than 3 percent by weight, based on the total weight of the prepolymer. In alternate non-limiting embodiments, the aforementioned optional additives can be mixed with the polyisocyanate and/or polyisothiocyanate. In a further non-limiting embodiment, the optional additives can be mixed with active hydrogen-containing material.

In a non-limiting embodiment, the resulting sulfur-containing polyureaurethane of the present invention when at least partially cured can be solid and essentially transparent such that it is suitable for optical or ophthalmic applications. In alternate non-limiting embodiments, the sulfur-containing polyureaurethane can have a refractive index of at least 1.55, or at least 1.56, or at least 1.57, or at least 1.58, or at least 1.59, or at least 1.60, or at least 1.62, or at least 1.65. In further alternate non-limiting embodiments, the sulfur-containing polyureaurethane can have an Abbe number of at least 32, or at least 35, or at least 38, or at least 39, or at least 40, or at least 44.

In a non-limiting embodiment, the sulfur-containing polyureaurethane when polymerized and at least partially cured can demonstrate good impact resistance/strength. Impact resistance can be measured using a variety of conventional methods known to one skilled in the art. In a non-limiting embodiment, the impact resistance is measured using the Impact Energy Test which consists of testing a flat sheet sample of polymerizate having a thickness of 3 mm, and cut into a square piece approximately 4 cm×4 cm. The flat sheet sample of polymerizate is supported on a flat O-ring which is attached to top of the pedestal of a steel holder, as defined below. The O-ring is constructed of neoprene having a hardness of 40±5 Shore A durometer, a minimum tensile strength of 8.3 MPa, and a minimum ultimate elongation of 400 percent, and has an inner diameter of 25 mm, an outer diameter of 31 mm, and a thickness of 2.3 mm. The steel holder consists of a steel base, with a mass of approximately 12 kg, and a steel pedestal affixed to the steel base. The shape of said steel pedestal is approximated by the solid shape which would result from adjoining onto the top of a cylinder, having an outer diameter of 75 mm and a height of 10 mm, the frustum of a right circular cone, having a bottom diameter of 75 mm, a top diameter of 25 mm, and a height of 8 mm, wherein the center of said frustum coincides with the center of said cylinder. The bottom of said steel pedestal is affixed to said steel base, and the neoprene O-ring is affixed to the top of the steel pedestal, with the center of said O-ring coinciding with the center of the steel pedestal. The flat sheet sample of polymerizate is set on top of the O-ring with the center of said flat sheet sample coinciding with the center of said O-ring. The Impact Energy Test is carried out by dropping steel balls of increasing weight from a distance of 50 inches (1.27 meters) onto the center of the flat sheet sample. The sheet is determined to have passed the test if the sheet does not fracture. The sheet is determined to have failed the test when the sheet fractures. As used herein, the term “fracture” refers to a crack through the entire thickness of the sheet into two or more separate pieces, or detachment of one or more pieces of material from the backside of the sheet (i.e., the side of the sheet opposite the side of impact). The impact strength of the sheet is reported as the impact energy that corresponds to the highest level (i.e., largest-ball) at which the sheet passes the test, and it is calculated according to the following formula:
E=mgd
wherein E represent impact energy in Joules (J), m represents mass of the ball in kilograms (kg), g represents acceleration due to gravity (i.e., 9.80665 m/sec²) and d represents the distance of the ball drop in meters (i.e., 1.27 m). In an alternate non-limiting embodiment, using the Impact Energy Test as described herein, the impact strength can be at least 2.0 joules, or at least 4.95 joules.

In another non-limiting embodiment; the sulfur-containing polyureaurethane of the present invention when at least partially cured can have low density. In alternate non-limiting embodiments, the density can be at least 1.0, or at least 1.1 g/cm³, or less than 1.3, or less than 1.25, or less than 1.2 g/cm³, or from 1.0 to 1.2 grams/cm³, or from 1.0 to 1.25 grams/cm³, or from 1.0 to less than 1.3 grams/cm³. In a non-limiting embodiment, the density is measured using a DensiTECH instrument manufactured by Tech Pro, Incorporated in accordance with ASTM D297.

Solid articles that can be prepared using the sulfur-containing polyureaurethane of the present invention include but are not limited to optical lenses, such as plano and ophthalmic lenses, sun lenses, windows, automotive transparencies, such as windshields, sidelights and backlights, and aircraft transparencies.

In a non-limiting embodiment, the sulfur-containing polyureaurethane polymerizate of the present invention can be used to prepare photochromic articles, such as lenses. In a further embodiment, the polymerizate can be transparent to that portion of the electromagnetic spectrum which activates the photochromic substance(s), i.e., that wavelength of ultraviolet (UV) light that produces the colored or open form of the photochromic substance and that portion of the visible spectrum that includes the absorption maximum wavelength of the photochromic substance in its UV activated form, i.e., the open form.

A wide variety of photochromic substances can be used in the present invention. In a non-limiting embodiment, organic photochromic compounds or substances can be used. In alternate non-limiting embodiments, the photochromic substance can be incorporated, e.g., dissolved, dispersed or diffused into the polymerizate, or applied as a coating thereto.

In a non-limiting embodiment, the organic photochromic substance can have an activated absorption maximum within the visible range of greater than 590 nanometers. In a further non-limiting embodiment, the activated absorption maximum within the visible range can be between greater than 590 to 700 nanometers. These materials can exhibit a blue, bluish-green, or bluish-purple color when exposed to ultraviolet light in an appropriate solvent or matrix. Non-limiting examples of such substances that are useful in the present invention include but are not limited to spiro(indoline)naphthoxazines and spiro(indoline)benzoxazines. These and other suitable photochromic substances are described in U.S. Pat Nos. 3,562,172; 3,578,602; 4,215,010; 4,342,668; 5,405,958; 4,637,698; 4,931,219; 4,816,584; 4,880,667; 4,818,096.

In another non-limiting embodiment, the organic photochromic substances can have at least one absorption maximum within the visible range of between 400 and less than 500 nanometers. In a further non-limiting embodiment, the substance can have two absorption maxima within this visible range. These materials can exhibit a yellow-orange color when exposed to ultraviolet light in an appropriate solvent or matrix. Non-limiting examples of such materials can include certain chromenes, such as but not limited to benzopyrans and naphthopyrans. Many of such chromenes are described in U.S. Pat. Nos. 3,567,605; 4,826,977; 5,066,818; 4,826,977; 5,066,818; 5,466,398; 5,384,077; 5,238,931; and 5,274,132.

In another non-limiting embodiment, the photochromic substance can have an absorption maximum within the visible range of between 400 to 500 nanometers and an absorption maximum within the visible range of between 500 to 700 nanometers. These materials can exhibit color(s) ranging from yellow/brown to purple/gray when exposed to ultraviolet light in an appropriate solvent or matrix. Non-limiting examples of these substances can include certain benzopyran compounds having substituents at the 2-position of the pyran ring and a substituted or unsubstituted heterocyclic ring, such as a benzothieno or benzofurano ring fused to the benzene portion of the benzopyran. Further non-limiting examples of such materials are disclosed in U.S. Pat. No. 5,429,774.

In a non-limiting embodiment, the photochromic substance for use in the present invention can include photochromic organo-metal dithizonates, such as but not limited to (arylazo)-thioformic arylhydrazidates, such as but not limited to mercury dithizonates which are described, for example, in U.S. Pat. No. 3,361,706. Fulgides and fulgimides, such as but not limited to 3-furyl and 3-thienyl fulgides and fulgimides which are described in U.S. Pat. No. 4,931,220 at column 20, line 5 through column 21, line 38, can be used in the present invention.

The relevant portions of the aforedescribed patents are incorporated herein by reference.

In alternate non-limiting embodiments, the photochromic articles of the present invention can include one photochromic substance or a mixture of more than one photochromic substances. In further alternate non-limiting embodiment, various mixtures of photochromic substances can be used to attain activated colors such as a near neutral gray or brown.

The amount of photochromic substance employed can vary. In alternate non-limiting embodiments, the amount of photochromic substance and the ratio of substances (for example, when mixtures are used) can be such that the polymerizate to which the substance is applied or in which it is incorporated exhibits a desired resultant color, e.g., a substantially neutral color such as shades of gray or brown when activated with unfiltered sunlight, i.e., as near a neutral color as possible given the colors of the activated photochromic substances. In a non-limiting embodiment, the amount of photochromic substance used can depend upon the intensity of the color of the activated species and the ultimate color desired.

In alternate non-limiting embodiments, the photochromic substance can be applied to or incorporated into the polymerizate by various methods known in the art. In a non-limiting embodiment, the photochromic substance can be dissolved or dispersed within the polymerizate. In a further non-limiting embodiment, the photochromic substance can be imbibed into the polymerizate by methods known in the art. The term “imbibition” or “imbibe” includes permeation of the photochromic substance alone into the polymerizate, solvent assisted transfer absorption of the photochromic substance into a porous polymer, vapor phase transfer, and other such transfer mechanisms. In a non-limiting embodiment, the imbibing method can include coating the photochromic article with the photochromic substance; heating the surface of the photochromic article; and removing the residual coating from the surface of the photochromic article. In alternate non-limiting embodiments, the imbibtion process can include immersing the polymerizate in a hot solution of the photochromic substance or by thermal transfer.

In alternate non-limiting embodiments, the photochromic substance can be a separate layer between adjacent layers of the polymerizate, e.g., as a part of a polymer film; or the photochromic substance can be applied as a coating or as part of a coating placed on the surface of the polymerizate.

The amount of photochromic substance or composition containing the same applied to or incorporated into the polymerizate can vary. In a non-limiting embodiment, the amount can be such that a photochromic effect discernible to the naked eye upon activation is produced. Such an amount can be described in general as a photochromic amount. In alternate non-limiting embodiments, the amount used can depend upon the intensity of color desired upon irradiation thereof and the method used to incorporate or apply the photochromic substance. In general, the more photochromic substance applied or incorporated, the greater the color intensity. In a non-limiting embodiment, the amount of photochromic substance incorporated into or applied onto a photochromic optical polymerizate can be from 0.15 to 0.35 milligrams per square centimeter of surface to which the photochromic substance is incorporated or applied.

In another embodiment, the photochromic substance can be added to the sulfur-containing polyureaurethane prior to polymerizing and/or cast curing the material. In this embodiment, the photochromic substance used can be chosen such that it is resistant to potentially adverse interactions with, for example, the isocyanate, isothiocyanate and amine groups present. Such adverse interactions can result in deactivation of the photochromic substance, for example, by trapping them in either an open or closed form.

Further non-limiting examples of suitable photochromic substances for use in the present invention can include photochromic pigments and organic photochromic substances encapsulated in metal oxides such as those disclosed in U.S. Pat. Nos. 4,166,043 and 4,367,170; organic photochromic substances encapsulated in an organic polymerizate such as those disclosed in U.S. Pat. No. 4,931,220.

### EXAMPLES

In the following examples, unless otherwise stated, the 1H NMR and 13C NMR were measured on a Varian Unity Plus (200 MHz) machine; the Mass Spectra were measured on a Mariner Bio Systems apparatus; the refractive index and Abbe number were measured on a multiple wavelength Abbe Refractometer Model DR-M2 manufactured by ATAGO Co., Ltd.; the refractive index and Abbe number of liquids were measured in accordance with ASTM-D1218; the refractive index and Abbe number of solids was measured in accordance with ASTM-D542; the refractive index (e-line or d-line) was measured at a temperature of 20° C.; the density of solids was measured in accordance with ASTM-D792; and the viscosity was measured using a Brookfield CAP 2000+Viscometer.

### Example 1

### Preparation of Reactive Polyisocyanate Prepolymer 1 (RP1)

In a reaction vessel equipped with a paddle blade type stirrer, thermometer, gas inlet, and addition funnel, 11721 grams (89.30 equivalents of NCO) of Desmodur W obtained from Bayer Corporation, 5000 grams (24.82 equivalents of OH) of a 400 MW polycaprolactone diol (CAPA 2047A obtained from Solvay), 1195 grams (3.22 equivalents of OH) of 750 MW polycaprolactone diol (CAPA 2077A obtained from Solvay), and 217.4 grams (4.78 equivalents of OH) of trimethylol propane (TMP) obtained from Aldrich were charged. Desmodur W (4,4′-methylenebis(cyclohexyl isocyanate) containing 20% of the trans,trans isomer and 80% of the cis,cis and cis, trans isomers) was obtained from Bayer Corporation. The contents of the reactor were stirred at a rate of 150 rpm and a nitrogen blanket was applied as the reactor contents were heated to a temperature of 120° C. at which time the reaction mixture began to exotherm. The heat was removed and the temperature rose to a peak of 140° C. for 30 minutes and then began to cool. Heat was applied to the reactor when the temperature reached 120° C. and was maintained at that temperature for 4 hours to form the prepolymer (Component A). The reaction mixture was sampled and analyzed for % NCO according to the method described below. The analytical result showed 13.1. % NCO groups. Before pouring out the contents of the reactor, 45.3 g of Irganox 1010 (thermal stabilizer obtained from Ciba Specialty Chemicals) and 362.7 g of Cyasorb 5411 (UV stabilizer obtained from Cytec) were mixed into the prepolymer (Component A).

THE NCO concentration of the prepolymer (Component A) was determined by reaction with an excess of n-dibutylamine (DBA) to form the corresponding urea followed by titration of the unreacted DBA with HCl in accordance with ASTM-2572-97.

Reagents
1. Tetrahydrofuran (THF), reagent grade.
2. 80/20 THF/propylene glycol (PG) mix. This solution was prepared in-lab by mixing 800 mls PG with 3.2 Liters of THF in 4 Liter bottle.
3. DBA certified ACS.
4. DBA/THF solution. 150 mL of dibutylamine (DBA) was combined with 750 mL tetrahydrofuran (THF); it was mixed well and transferred to an amber bottle.
5. Hydrochloric acid, concentrated. ACS certified.
6. Isopropanol, technical grade.
7. Alcoholic hydrochloric acid, 0.2N. 75-ml of concentrated hydrochloric acid was slowly added to a 4-liter bottle of technical grade isopropanol, while stirring with a magnetic stirrer. It was mixed for a minimum of 30-minutes. This solution was standardized using THAM (Tris hydroxyl methyl amino methane) as follows: Into a glass 100-mL beaker, was weighed approximately 0.6 g (HOCH₂)₃CNH₂ primary standard to the nearest 0.1 mg and the weight was recorded. 100-mL DI water was added and mixed to dissolve and titrated with the prepared alcoholic HCl. This procedure was repeated a minimum of one time and the values averaged using the calculation below.

$$Normality HCL = \frac{( Standard wt . , grams )}{( mLs HCl ) ( 0.12114 )}$$

Equipment
1. Polyethylene beakers, 200-mL, Falcon specimen breakers, No. 354020.
2. Polyethylene lids for above, Falcon No. 354017.
3. Magnetic stirrer and stirring bars.
4. Brinkmann dosimeter for dispensing or 10-mL pipet.
5. Autotitrator equipped with pH electrode.
   25-mL, 50-mL dispensers for solvents or
   25-mL and 50-mL pipets.

Procedure—
1. Blank determination: Into a 220-mL polyethylene beaker was added 50 mL THF followed by 10.0 mL-DBA/THF-solution. The solution was capped and allowed to mix with magnetic stirring for 5 minutes. 50 mL of the 80/20 THF/PG mix was added and titrated using the standardized alcoholic HCl solution and this volume was recorded. This procedure was repeated and these values averaged for use as the blank value.
2. In a polyethylene beaker was weighed 1.0 gram of the prepolymer sample and this weight was recorded to the nearest 0.1 mg. 50 mL THF was added, the sample was capped and allowed to dissolve with magnetic stirring.
3. 10.0 mL DBA/THF solution was added, the sample was capped and allowed to react with stirring for 15 minutes.
4. 50 mL 80/20 THF/PG solution was added.
5. The beaker was placed on the titrator and the titration was started. This procedure was repeated.

$$\begin{matrix}\underline{CALCULATIONS} - \\ \% NCO = \frac{( mls Blank - mls Sample ) \times ( Normality HCl ) \times ( 4.2018 )}{Sample weight , g} \\ IEW = \frac{( Sample wt . , grams ) \times ( 1000 )}{( mls Blank - mls Sample ) \times ( Normality HCl )} \\ IEW = Isocyanate Equivalent Weight\end{matrix}$$

### Example 2

### Preparation of Reactive Polyisocyanate Prepolymer 2 (RP2)

In a reactor vessel containing a nitrogen blanket, 450 grams of 400 MW polycaprolactone, 109 grams of 750 MW polycaprolactone, 114.4 grams of trimethylol propane, 3000 grams of Pluronic L62D, and 2698 grams of Desmodur W, were mixed together at room temperature to obtain NCO/OH equivalent ratio of 2.86. Desmodur W (4,4′-methylenebis(cyclohexyl isocyanate) containing 20% of the trans,trans isomer and 80% of the cis,cis and cis, trans isomers) was obtained from Bayer Corporation. Pluronic L62D (a polyethylene oxide-polypropylene oxide block polyether diol) was obtained from BASF. The reaction mixture was heated to a temperature of 65° C. and then 30 ppm of dibutyltindilaurate catalyst, (obtained from Aldrich) was added and the heat source was removed. The resulting exotherm raised the temperature of the mixture to 112° C. The reaction was then allowed to cool to a temperature of 100° C., and 131 grams of UV absorber Cyasorb 5411 (obtained from American Cyanamid/Cytec) and 32.66 grams of Irganox 1010 (obtained from Ciba Geigy) were added with 0.98 grams of one weight percent solution of Exalite Blue 78-13 (obtained from Exciton) dissolved in Desmodur W (4,4′-methylenebis(cylohexylisocyanate)). The mixture was stirred for an additional two hours at 100° C. and then allowed to cool to room temperature. The isocyanate (NCO) concentration of the prepolymer was 8.7% as measured using the procedure described above (see Example 1).

### Example 3

### Preparation of Reactive-Polyisocyanate-Prepolymer 3 (RP3)

In a reactor vessel containing a nitrogen blanket 450 grams of 400 MW polycaprolactone, 109 grams of 750 MW polycaprolactone, 114.4 grams of trimethylol propane, 3000 grams of Pluronic L62D, and 3500 grams of Desmodur W, were mixed together at room temperature to obtain NCO/OH equivalent ratio of 3.50. Desmodur W (4,4′-methylenebis(cyclohexyl isocyanate) containing 20% of the trans,trans isomer and 80% of the cis,cis and cis, trans isomers) was obtained from Bayer Corporation. Pluronic L62D (a polyethylene oxide-polypropylene oxide block polyether diol and was obtained from BASF. The reaction mixture was heated to a temperature of 65° C. and then 30 ppm of dibutyltindilaurate catalyst (obtained from Aldrich) was added and the heat source was removed. The resulting exotherm raised the temperature of the mixture to 112° C. The reaction was then allowed to cool to a temperature of 100° C., and 131 grams of UV absorber Cyasorb 5411 (obtained from American Cyanamid/Cytec) and 32.66 grams of Irganox 1010 (obtained from Ciba Geigy) were added with 0.98 grams of one weight percent solution of Exalite Blue 78-13 (obtained from Exciton) dissolved in Desmodur W (4,4′-methylenebis(cylohexylisocyanate)). The mixture was stirred for an additional two hours at 100° C. and then allowed to cool to room temperature. The isocyanate (NCO) concentration of the prepolymer was 10.8% as measured in accordance with the procedure described above (see Example 1).

### Example 4

### Preparation of Reactive Polyisocyanate Prepolymer 4 (RP4)

In a reactor vessel containing a nitrogen blanket, 508 grams of 400 MW polycaprolactone, 114.4 grams of trimethylol propane, 3000 grams of Pluronic L62D, and 4140 grams of Desmodur W, were mixed together at room temperature to obtain NCO/OH equivalent ratio of 4.10. Desmodur W (4,4′-methylenebis(cyclohexyl isocyanate) containing 20% of the trans,trans isomer and 80% of the cis,cis and cis, trans isomers) was obtained from Bayer Corporation. Pluronic L62D (polyethylene oxide-polypropylene oxide block polyether diol) was obtained from BASF. The reaction mixture was heated to a temperature of 65° C. and then 30 ppm of dibutyltindilaurate catalyst (obtained from Aldrich) was added and the heat source was removed. The resulting exotherm raised the temperature of the mixture to 112° C. The reaction was then allowed to cool to a temperature of 100° C., and 150 grams of UV absorber Cyasorb 5411 (obtained from American Cyanamid/Cytec) and 37.5 grams of Irganox 1010 (obtained from Ciba Geigy) were added with 1.13 grams of one weight percent solution of Exalite Blue 78-13 (obtained from Exciton) dissolved in Desmodur W, 4,4′-methylenebis(cylohexylisocyanate). The mixture was stirred for an additional two hours at 100° C. and then allowed to cool to room temperature. The isocyanate (NCO) concentration of the prepolymer was 12.2% as measured in accordance with the procedure described above (see Example 1).

### Example 5

30.0 g of RP1 and 10.0 g of bis-epithiopropyl sulfide (formula XXXII) were mixed in a reactor by stirring at a temperature of 50° C. until a homogeneous mixture was obtained. 4.00 g of PTMA, 2.67 g of DETDA and 5.94 g of MDA were mixed in a reactor by stirring at a temperature of 50° C. until a homogeneous mixture was obtained. Both mixtures were degassed under vacuum at 50° C. Then the mixtures were combined and mixed at this temperature and homogenized by gentle stirring for 1-2 minutes. The resulting clear mixture was immediately charged between two flat glass molds. The molds were heated at a temperature of 130° C. for 5 hours, yielding a transparent plastic sheet with the refractive index (e-line), Abbe number, density and impact values shown in Table 1.

### Example 6

24.0 g of RP1 and 20.0 g of bis-epithiopropyl sulfide (formula XXXII) were mixed in a reactor by stirring at a temperature of 50° C. until a homogeneous mixture was obtained. 2.00 g of DMDS, 2.14 g of DETDA, 4.75 g of MDA and 0.12 g Irganox 1010 (obtained from Ciba Specialty Chemicals) were mixed in a reactor by stirring at a temperature of 50° C. until a homogeneous mixture was obtained. Both mixtures were degassed under vacuum at 50° C. The mixtures were then combined and mixed at this temperature and homogenized by gentle stirring for 1-2 minutes. The resulting clear mixture was immediately charged between two flat glass molds. The molds were heated to a temperature of 130° C. for 5 hours, yielding a transparent plastic sheet with the refractive index (e-line), Abbe number, density and impact resistance values shown in Table 1.

### Example 7

30.0 g of RP1 and 20.0 g of bis-epithiopropyl sulfide (Formula XXXII) were mixed in a reactor by stirring at a temperature of 50° C. until a homogeneous mixture was obtained. 2.40 g of PTMA, 5.34 g of DETDA and 3.96 g of MDA were mixed in a reactor by stirring at a temperature of 50° C. until a homogeneous mixture was obtained. Both mixtures were degassed under vacuum at 50° C. The mixtures were then combined and mixed at this temperature and homogenized by gentle stirring for 1-2 minutes. The resulting clear mixture was immediately charged between two flat glass molds. The molds were heated to a temperature of 130° C. for 5 hours, yielding a transparent plastic sheet with the refractive index (e-line), Abbe number, density and impact values shown in Table 1.

### Example 8

24.0 g of RP1 and 20.0 g of bis-epithiopropyl sulfide (Formula XXXII) were mixed in a reactor by stirring at s temperature of 50° C. until a homogeneous mixture was obtained. 2.85 g of DETDA and 3.96 g of MDA were mixed in a reactor by stirring at a temperature of 50° C. until homogeneous mixture was obtained. Both mixtures were degassed under vacuum at 50° C. The mixtures were then combined and mixed at this temperature and homogenized by gentle stirring for 1-2 minutes. The resulting clear mixture was immediately charged between two flat glass molds. The molds were heated to a temperature of 130° C. for 5 hours, yielding a transparent plastic sheet with the refractive index (e-line), Abbe number, density and impact values shown in Table 1.

### Example 9

30.0 g of RP3 and 25.0 g of bis-epithiopropyl sulfide (Formula XXXII) were mixed in a reactor by stirring at a temperature of 50° C. until a homogeneous mixture was obtained. 3.75 g of DMDS, 2.45 g of DETDA and 4.66 g of MDA were mixed in a reactor by stirring at a temperature of 50° C. until homogeneous mixture was obtained. Both mixtures were degassed under vacuum at 50° C. The mixtures were then combined and mixed at this temperature and homogenized by gentle stirring for 1-2 minutes. The resulting clear mixture was immediately charged between two flat glass molds. The molds were heated to a temperature of 130° C. for 5 hours, yielding a transparent plastic sheet with the refractive index (e-line), Abbe number, density and impact values shown in Table 1.

### Example 10

30.0 g of RP4 and 25.0 g of bis-epithiopropyl sulfide (Formula XXXII) were mixed in a reactor by stirring at a temperature of 50° C. until a homogeneous mixture was obtained. 3.75 g of DMDS, 2.71 g of DETDA and 5.17 g of MDA were mixed in a reactor by stirring at a temperature of 50° C. until homogeneous mixture was obtained. Both mixtures were degassed under vacuum at 50° C. The mixtures were then combined and mixed at this temperature and homogenized by gentle stirring for 1-2 minutes. The resulting clear mixture was immediately charged between two flat glass molds. The molds were heated to a temperature of 130° C. for 5 hours, yielding a transparent plastic sheet with the refractive index (e-line), Abbe number, density and impact values shown in Table 1.

### Example 11

30.0 g of RP2 and 21.4.0 g of bis-epithiopropyl sulfide (Formula XXXII) were mixed in a reactor by stirring at a temperature of 50° C. until a homogeneous mixture was obtained. 3.21 g of DMDS, 1.92 g of DETDA and 3.67 g of MDA were mixed in a reactor by stirring at a temperature of 50° C. until homogeneous mixture was obtained. Both mixtures were degassed under vacuum at 50° C. The mixtures were then combined and mixed at this temperature and homogenized by gentle stirring for 1-2 minutes. The resulting clear mixture was immediately charged between two flat glass molds. The molds were heated to a temperature of 130° C. for 5 hours, yielding a transparent plastic sheet with the refractive index (e-line), Abbe number, density and impact values shown in Table 1.

TABLE 1

| | Refractive | | | |
|---|---|---|---|---|
| Experiment | Index | Abbe | Density | Impact Energy* |
| # | (e-line) | Number | (g/cm³) | (J) |
| 5 | 1.58 | 38 | 1.195 | 3.99 |
| 6 | 1.61 | 36 | 1.231 | 2.13 |
| 7 | 1.59 | 38 | 1.217 | 2.47 |
| 8 | 1.60 | 37 | 1.222 | 2.77 |
| 9 | 1.60 | 38 | 1.227 | >4.95 |
| 10 | 1.59 | 37 | 1.211 | 3.56 |
| 11 | 1.59 | 38 | 1.218 | >4.95 |

*The Impact Energy was measured in accordance with the Impact Energy Test previously described herein. The ball sizes that were used in this test and the corresponding impact energies are listed below.

| Ball weight, kg | Impact Energy, J |
|---|---|
| 0.016 | 0.20 |
| 0.022 | 0.27 |
| 0.032 | 0.40 |
| 0.045 | 0.56 |
| 0.054 | 0.68 |
| 0.067 | 0.83 |
| 0.080 | 1.00 |
| 0.094 | 1.17 |
| 0.110 | 1.37 |
| 0.129 | 1.60 |
| 0.149 | 1.85 |
| 0.171 | 2.13 |
| 0.198 | 2.47 |
| 0.223 | 2.77 |
| 0.255 | 3.17 |
| 0.286 | 3.56 |
| 0.321 | 3.99 |
| 0.358 | 4.46 |
| 0.398 | 4.95 |

### Example 12

### Synthesis of Polythioether (PTE) Dithiol 1

NaOH (44.15 g, 1.01 mol) was dissolved in 350 ml of H₂O. The solution was allowed to cool to room temperature and 500 ml of toluene were added, followed by the addition of dimercaptodiethyl sulfide (135 ml, 159.70 g, 1.04 mol). The reaction mixture was heated to a temperature of 40° C., stirred and then cooled to room temperature. 1,1-Dichloroacetone (DCA) (50 ml, 66.35 g, 0.52 mol) was dissolved in 250 ml of toluene and then added drop-wise to the reaction mixture while the temperature was maintained at from 20-25° C. Following the drop-wise addition, the reaction mixture was stirred for an additional 20 hours at room temperature. The organic phase was than separated, washed with 2×100 ml of H₂O, 1×100 ml of brine and dried over anhydrous MgSO₄. The drying agent was filtered off and the toluene was evaporated using a Buchi Rotaevaporator. The hazy residue was filtered through Celite to provide 182 g (96% yield) of PTE Dithiol 1 as a colorless clear oily liquid.

The results of the Mass Spectra were ESI-MS: 385 (M+Na) and the molecular weight was calculated as 362.

The results of the NMR were ¹H NMR (CDCl₃, 200 MHz): 4.56 (s, 1H), 2.75 (m, 16H), 2.38 (s, 3H), 1.75 (m, 1.5H)).

The SH groups within the product were determined using the following procedure. A sample size (0.1 g) of the product was combined with 50 mL of tetrahydrofuran (THF)/propylene glycol (80/20) solution and stirred at room temperature until the sample was substantially dissolved. While stirring, 25.0 mL of 0.1 N iodine solution (commercially obtained from Aldrich 31, 8898-1) was added to the mixture and allowed to react for a time period of from 5 to 10 minutes. To this mixture was added 2.0 mL concentrated HCl. The mixture was titrated potentiometrically with 0.1 N sodium thiosulfate in the millivolt (mV) mode. The resulting volume of titrant is represented as “mLs Sample” in the below equation. A blank value was initially obtained by titrating 25.0 mL of iodine (including 1 mL of concentrated hydrochloric acid) with sodium thiosulfate in the same manner as conducted with the product sample. This resulting volume of titrant is represented as “mLs Blank” in the below equation.

$$\begin{matrix}\% SH = \frac{( mLsBlank - mLsSample ) ( Normality {Na}_{2} {S}_{2} {O}_{3} ) ( 3.307 )}{sample weight , g} \\ = 13.4\end{matrix}$$

The refractive index was 1.618 (20° C.) and the Abbe number was 35.

The product sample (100 mg, 0.28 mmol) was acetylated by dissolving it in 2 ml of dichloromethane at room temperature. Acetic anhydride (0.058 ml, 0.6 mmol) was added to the reaction mixture, and triethylamine (0.09 ml, 0.67 mmol) and dimethylaminopyridine (1 drop) were then added. The mixture was maintained at room temperature for 2 hours. The mixture was then diluted with 20 ml of ethyl ether, washed with aqueous NaHCO₃ and dried over MgSO₄. The drying agent was filtered off; the volatiles were evaporated off under vacuum and the oily residue was purified by silica gel flash chromatography (hexane/ethyl acetate 8:2 volume per volume) to provide 103 mg (83% yield) of diacetylated product with the following results:

¹H NMR (CDCl₃, 200 MHz): 4.65 (s, 1H), 3.12-3.02 (m, 4H), 2.75-2.65 (m, 4H), 2.95-2.78 (m, 8H), 2.38 (s, 3H), 2.35 (s, 6H).

ESI-MS: 385 (M+Na).

### Example 13

### Synthesis of PTE Dithiol 2

NaOH (23.4 g, 0.58 mol) was dissolved in 54 ml of H₂O. The solution was cooled to room temperature and DMDS (30.8 g, 0.20 mol) was added. Upon stirring the mixture, dichloroacetone (19.0 g, 0.15 mol) was added dropwise while maintaining the temperature from 20-25° C. After the addition of dichloroacetone was completed, the mixture was stirred for an additional 2 hours at room temperature. The mixture was neutralized with 10% HCl to a pH of 9, and 100 ml of dichloromethane were then added, and the mixture was stirred. Stirring was terminated; the mixture was transferred to a separatory funnel and allowed to separate. Following phase separation, the organic phase washed with 100 ml of H₂O, and dried over anhydrous MgSO₄. The drying agent was filtered off and the solvent was evaporated using a Buchi Rotaevaporator, which provided 35 g (90% yield) of transparent liquid having a viscosity (73° C.) of 38 cP; refractive index (e-line) of 1.622 (20° C.), Abbe number of 36, and SH group analysis of 8.10%.

### Example 14

### Synthesis of PTE Dithiol 3

NaOH (32.0 g, 0.80 mol) was dissolved in 250 ml of H₂O. The solution was cooled to room temperature and 240 ml of toluene were added followed by the addition of DMDS (77.00 g, 0.50 mol). The mixture was heated to a temperature of 40° C., stirred and then cooled under nitrogen flow until room temperature was reached. DCA (50.8 g, 0.40 mol) was dissolved in 70 ml of toluene and added dropwise to the mixture with stirring, while the temperature was maintained from 20-25° C. After the addition was completed, the mixture was stirred for additional 16 hours at room temperature. Stirring was stopped, the mixture was transferred to a separatory funnel and allowed to separate. The organic phase was separated, washed with 2×100 ml of H₂O, 1×100 ml of brine and dried over anhydrous MgSO₄. The drying agent was filtered off and toluene was evaporated using a Buchi Rotaevaporator to provide 89 g (90% yield) of transparent liquid having viscosity (73° C. of 58 cP; refractive index (e-line) of 1.622 (20° C.), Abbe number of 36; and SH group analysis of 3.54%.

### Example 15

### Synthesis of PTE Dithiol 4

NaOH (96.0 g, 2.40 mol) was dissolved in 160 ml of H₂O and the solution was cooled to room temperature. DMDS (215.6 g, 1.40 mol), 1,1-dichloroethane (DCE) (240.0 g, 2.40 mol) and tetrabutylphosphonium bromide (8.14 g, 1 mol. %) were mixed and added to the NaOH mixture dropwise under nitrogen flow and vigorous stirring while the temperature was maintained between 20-25° C. After the addition was completed, the mixture was stirred for an additional 15 hours at room temperature. The aqueous layer was acidified and extracted to give 103.0 g of unreacted DMDS. The organic phase washed with 2×100 ml of H₂O, 1×100 ml of brine and dried over anhydrous MgSO₄. The drying agent was filtered off and the excess DCE was evaporated using a Buchi Rotaevaporator to yield 78 g (32% yield) transparent liquid having viscosity (73° C.) of 15 cP; refractive index (e-line) of 1.625 (20° C.), Abbe number of 36; and SH group analysis of 15.74%.

### Example 16

### Synthesis of PTE Dithiol 5

NaOH (96.0 g, 2.40 mol) was dissolved in 140 ml of H₂O and the solution was cooled to a temperature of 10° C. and charged in a three necked flask equipped with mechanical stirrer and, inlet and outlet for Nitrogen. DMDS (215.6 g, 1.40 mol) was then charged and the temperature was maintained at 10° C. To this mixture was added dropwise solution of tetrabutylphosphonium bromide (8.14 g, 1 mol. %) in DCE (120 g, 1.2 mol) under Nitrogen flow and vigorous stirring. After the addition was completed the mixture was stirred for an additional 60 hours at room temperature. 300 ml of H₂O and 50 ml of DCE were then added. The mixture was transferred to a separatory funnel, shaken well, and following phase separation, 200 ml toluene were added to the organic layer; it was then washed with 150 ml H₂O, 50 ml 5% HCl and 2×100 ml H₂O and dried over anhydrous MgSO₄. The drying agent was filtered off and the solvent was evaporated on rotaevaporator to yield 80 g (32% yield) of transparent liquid having viscosity (73° C.) of 56 cP; refractive index (e-line) of 1.635 (20° C.), Abbe number of 36; and SH group analysis of 7.95%.

### Example 17

### Synthesis of Polythiourethane Prepolymer (PTUPP)1

Desmodur W (62.9 g, 0.24 mol) and PTE Dithiol 1 (39.4 g, 0.08 mol) were mixed and degassed under vacuum for 2.5 hours at room temperature. Dibutyltin dilaurate (0.01% by weight of the reaction mixture) was then added and the mixture was flushed with nitrogen and heated for 32 hours at a temperature of 86° C. SH group analysis showed complete consumption of SH groups. The heating was stopped. The resulting mixture had viscosity (73° C.) of 600 cP refractive index (e-line) of 1.562 (20° C.), Abbe number of 43; and NCO groups of 13.2% (calculated 13.1%). The NCO was determined according to the procedure described in Example 1 herein.

### Example 18

### Synthesis of PTUPP 2

Desmodur W (19.7 g, 0.075 mol) and PTE Dithiol 2 (20.0 g, 0.025 mol) were mixed and degassed under vacuum for 2.5 hours at room temperature. Dibutyltin dichloride (0.01 weight percent) was then added to the mixture, and the mixture was flushed with nitrogen and heated for 18 hours at a temperature of 86° C. SH group analysis showed complete consumption of SH groups. The heating was stopped. The resulting mixture had viscosity (at 73° C.) of 510 cP refractive index (e-line) of 1.574 (20° C.), Abbe number of 42; and NCO groups of 10.5% (calculated 10.6%).

### Example 19

### Synthesis of PTUPP 3

Desmodur W (31.0 g, 0.118 mol) and PTE Dithiol 3 (73.7 g, 0.039 mol) were mixed and degassed under vacuum for 2.5 hours at room temperature. Dibutyltin dichloride was then added (0.01 weight percent) to the mixture, and the mixture was flushed with nitrogen and heated for 37 hours at a temperature of 64° C. SH group analysis showed complete consumption of SH groups. The heating was stopped. The resulting mixture had viscosity (at 73° C.) of 415 cP, refractive index (e-line) of 1.596 (20° C.), Abbe number of 39; and NCO groups of 6.6% (calculated 6.3%).

### Example 20

### Chain Extension of Polythiourethane Prepolymer with Aromatic Amine

PTUPP 1 (30 g) was degassed under vacuum at a temperature of 70° C. for 2 hours. DETDA (7.11 g) and PTE Dithiol 1 (1.0 g) were mixed and degassed under vacuum at a temperature of 70° C. for 2 hours. The two mixtures were then mixed together at the same temperature and charged between a preheated glass plates mold. The material was cured in a preheated oven at a temperature of 130° C. for 5 hours. The cured material was transparent and had a refractive index (e-line) of 1.585 (20° C.), Abbe number of 39 and density of 1.174 g/cm³.

### Example 21

PTUPP 2 (25 g) was degassed under vacuum at a temperature of 65° C. for 3 hours. DETDA (3.88 g) and PTE Dithiol 1 (3.83 g) were mixed and degassed under vacuum at a temperature of 65° C. for 2 hours. The two mixtures were then mixed together at the same temperature and charged between a preheated glass plates mold. The material was cured in a preheated oven at a temperature of 130° C. for 10 hours. The cured material was transparent and had refractive index (e-line) of 1.599 (20° C.), Abbe number of 39 and density of 1.202 g/cm³.

### Example 22

PTUPP 3 (40 g) was degassed under vacuum at a temperature of 65° C. for 2 hours. DETDA (3.89 g) and PTE Dithiol 1 (3.84 g) were mixed and degassed under vacuum at a temperature of 65° C. for 2 hours. The two mixtures were then mixed together at the same temperature and charged between a preheated glass plates mold. The material was cured in a preheated oven at a temperature of 130° C. for 10 hours. The cured material was transparent and had refractive index (e-line) of 1.609 (20° C.), Abbe number of 39 and density of 1.195 g/cm³.

### Example 23

### Synthesis of 2-Methyl-2-Dichloromethyl-1,3-Dithiolane

In a three-necked flask equipped with a magnetic stirrer and having a nitrogen blanket at the inlet and outlet, were added 13.27 grams (0.104 mol) of 1,1-dichloroacetone, 11.23 grams (0.119 mol) of 1,2-ethanedithiol, 20 grams of MgSO₄ anhydrous, and 5 grams of Montmorilonite K-10 (commercially obtained from Aldrich) in 200 ml toluene. The mixture was stirred for 24 hours at room temperature. The insoluble product was filtered off and the toluene was evaporated off under vacuum to yield 17.2 grams (80% yield) of crude 2-methyl-2-dichloromethyl-1,3-dithiolane.

The crude product was distilled within a temperature range of from 102 to 112° C. at 12 mm Hg. ¹H NMR and ¹³C NMR results of the distilled product were: ¹H NMR (CDCl₃, 200 MHz): 5.93 (s, 1H); 3.34 (s, 4H); 2.02 (s, 3H); ¹³C NMR (CDCl₃, 50 MHz): 80.57; 40.98; 25.67.

### Example 24

### Synthesis of PTE Dithiol 6 (DMDS/VCH, 1:2 Mole Ratio)

Charged into a 1-liter 4-necked flask equipped with a mechanical stirrer, thermometer and two gas passing adapters (one for inlet and one for outlet), was dimercaptodiethyl sulfide (DMDS) (888.53 g, 5.758 moles). The flask was flushed with dry nitrogen and 4-vinyl-1-cyclohexene (VCH) (311.47 g, 2.879 moles) was added with stirring during a time period of 2 hours and 15 minutes. The reaction temperature increased from room temperature to 62° C. after 1 hr of addition. Following addition of the vinylcyclohexene, the temperature was 37° C. The reaction mixture was then heated to a temperature of 60° C., and five 0.25 g portions of free radical initiator Vazo-52 (2,2′-azobis(2,4-dimethylpentanenitrile) obtained from DuPont) were added. Each portion was added after an interval of one hour. The reaction mixture was evacuated at 60° C./4-5 mm Hg for one hour to yield 1.2 kg (yield: 100%) of colorless liquid with the following properties viscosity of 300 cps @ 25° C. refractive index (e-line) of 1.597 (20° C.); Abbe Number of 39; and SH groups content of 16.7%.

### Example 25

### Synthesis of PTE Dithiol 7 (DMDS/VCH, 5:4 Mole Ratio)

In a glass jar with magnetic stirrer were mixed 21.6 grams (0.20 mole) of 4-vinyl-1-cyclohexene (VCH) from Aldrich and 38.6 grams (0.25 mole) of dimercaptodiethyl sulfide (DMDS) from Nisso Maruzen. The mixture had a temperature of 60° C. due to the exothermicity of the reaction. The mixture was then placed in an oil bath at a temperature of 47° C. and stirred under a nitrogen flow for 40 hours. The mixture was cooled to room temperature. A colorless, viscous oligomeric product was obtained, having the following properties: viscosity of 10860, cps @ 25° C.; refractive index (e-line) of 1.604 (20° C.); Abbe Number of 41; and SH groups content of 5.1%.

### Example 26

### Synthesis of Star Polymer (SP)

In a glass-lined reactor of 7500 lb capacity, were added 1,8-dimercapto-3,6-dioxaoctane (DMDO) (3907.54 lb, 21.43 moles), ethyl formate (705.53 lb, 9.53 moles), and anhydrous zinc chloride (90.45 lb, 0.66 mole). The mixture was stirred at a temperature of 85° C. for 20 hours, then cooled to a temperature of 52° C. Added to the mixture was 96.48 lb of a 33% solution of 1,4-diazabicyclo[2.2.2]octane (DABCO) (0.28 mole) for one hour. The mixture was then cooled to a temperature of 49° C., and filtered through a 200-micron filter bag to provide liquid polythioether with the following properties: viscosity of 320 cps @ 25° C.; n_{D}²⁰ of 1.553; Abbe Number of 42; and SH groups content of 11.8% (thiol equivalent weight of 280).

### Example 27

### Synthesis of 2:1 Adduct of DMDS and Ethylene Glycol Dimethacrylate

Dimercaptodiethyl sulfide (42.64 g, 0.276 mole) was charged into a 100 ml, 4-necked flask equipped with a mechanical stirrer, thermometer, and two gas-passing adapters (one for inlet and the other for outlet). The flask was flushed with dry nitrogen and charged under stirring with 1,8-diazabicyclo[5.4.0]undec-7-ene (0.035 g) obtained from Aldrich. Ethylene glycol dimethacrylate (27.36 g, 0.138 mole) obtained from Sartomer under the trade name SR-206 was added into stirred solution of dithiol and base over a period of 12 minutes. Due to exotherm, the reaction temperature had increased from room temperature to 54° C. during the addition step. Following completion of the addition of dimethacrylate, the temperature was 42° C. The reaction mixture was heated at a temperature of 63° C. for five hours and evacuated at 63° C./4-5 mm Hg for 30 minutes to yield 70 g (yield: 100%) of colorless liquid (thiol equivalent weight of 255), having SH groups content of 12.94%.

### Example 28

### Synthesis of 3:2 Adduct of DMDS and Ethylene Glycol Dimethacrylate

Dimercaptodiethyl sulfide (16.20 grams, 0.105 mole) and ethylene glycol dimethacrylate (13.83 grams, 0.0698 mole) were charged into a small glass jar and mixed together using a magnetic stirrer. N,N-dimethylbenzylamine (0.3007 gram) obtained from Aldrich was added, and the resulting mixture was stirred and heated using an oil bath at a temperature of 75° C. for 52 hours. A colorless to slightly yellow liquid was obtained having thiol equivalent weight of 314, viscosity of 1434 cps at 25° C. and SH group content of 10.53%.

### Example 29

### Synthesis of 3:2 Adduct of DMDS and 2,2′-Thiodiethanethiol Dimethacrylate

Dimercaptodiethyl sulfide (13.30 grams, 0.0864 mole) and 2,2′-thiodiethanethiol dimethacrylate (16.70 grams, 0.0576 mole) obtained from Nippon Shokubai under the trade name S2EG were charged into a small glass jar and mixed together using a magnetic stirrer. N,N-dimethylbenzylamine (0.0154 gram) obtained from Aldrich was added, and the resulting mixture was stirred at ambient temperature (21-25° C.) for 75 hours. A colorless to slightly yellow liquid was obtained having thiol equivalent weight of 488, viscosity of 1470 cps at 25° C., refractive index n_{D}²⁰ of 1.6100, Abbe Number of 36, and SH group content of 6.76%.

### Example 30

### Synthesis of 4:3 Adduct of DMDS and Allyl Methacrylate

Allylmethacrylate (37.8 g, 0.3 mol) and dimercapto diethyl sulfide (61.6 g, 0.4 mol) were mixed at room temperature. Three drops of 1,8-diazabicyclo[5.4.0]undec-7-ene were added upon stirring. The temperature of the mixture increased to 83° C. due to the exothermicity of the reaction. The reactor containing the reaction mixture was put in an oil bath at a temperature of 65° C. and was stirred for 21 hours. Irgacure 812 (0.08 g) obtained from Ciba was added and the mixture was irradiated with UV light for 1 minute. The UV light source used was a 300-watt FUSION SYSTEMS UV lamp, with a D-Bulb, which was positioned at a distance of 19 cm above the sample. The sample was passed beneath the UV light source at a linear rate of 30.5 cm/minute using a model no. C636R conveyor belt system, available commercially from LESCO, Inc. A single pass beneath the UV light source as described imparted 16 Joules/cm² of UV energy (UVA) to the sample. A SH titration analysis conducted 10 minutes following the UV irradiation, showed SH group content of 6.4% and SH equivalent weight of 515 g/equivalent. The viscosity of this product was 215 cps at 73° C. the refractive index was n_{D} was 1.5825, and the Abbe number was 40.

### Example 31

### Synthesis of PTUPP 4

4,4-dicyclohexylmethane diisocyanate (Desmodur W) from Bayer (20.96 g, 0.08 mole): isophorone diisocyanate (IPDI) from Bayer (35.52 g, 0.16 mole) and PTE Dithiol 6 (32.0 g, 0.08 mole) were mixed and degassed under vacuum for 2.5 hours at room temperature. Dibutyltin dilaurate (0.01%) obtained from Aldrich was then added to the mixture and the mixture was flushed with Nitrogen and heated for 16 hours at a temperature of 90° C. SH group analysis showed complete consumption of SH groups. The heating was terminated. The resulting clear mixture had viscosity (73° C.) of 1800 cP, refractive index (e-line) of 1.555 (20° C.), Abbe number of 44; and NCO groups of 14.02%.

### Example 32

### Chain Extension of PTUPP 4

PTUPP 4 (30 g) was degassed under vacuum at a temperature of 60° C. for two hours. DETDA (7.57 g) and PTE Dithiol 6 (2.02 g) were mixed and degassed under vacuum at a temperature of 60° C. for 2 hours. The two mixtures were then mixed together at the same temperature and charged between a preheated glass plates mold. The material was cured in a preheated oven at a temperature of 130° C. for five hours. The cured material was clear and had refractive index (e-line) of 1.574 (20° C.) and Abbe number of 40.

### Example 33

### Synthesis of PTUPP 5

4,4-dicyclohexylmethane diisocyanate (Desmodur W) from Bayer (99.00 g, 0.378 mole), PTE Dithiol 6 (47.00 g, 0.118 mole) and Star Polymer (Example 26, 4.06 g, 0.0085 mole) were mixed and degassed under vacuum for 2.5 hours at room temperature. Dibutyltin dilaurate (Aldrich) was then added (0.01%) and the mixture was flushed with Nitrogen and heated for 16 hours at a temperature of 90° C. SH group analysis showed complete consumption of SH groups. The heating was stopped. The resulting clear mixture had viscosity (73° C.) of 1820 cP, refractive index (e-line) of 1.553 (20° C.), Abbe number of 46; and NCO groups of 13.65%.

### Example 34

### Chain Extension of PTUPP 5

PTUPP 5 (30 g) was degassed under vacuum at a temperature of 60° C. for two hours. DETDA (6.94 g) and DMDS (1.13 g) were mixed together and degassed under vacuum at a temperature of 60° C. for two hours. The two mixtures were then mixed together at the same temperature and charged between preheated glass plates mold. The material was cured in a preheated oven at a temperature of 130° C. for five hours. The cured material was clear and had refractive index (e-line) of 1.575 (20° C.) and Abbe number of 41.

### Example 35

### One Pot Synthesis of Polythiourea/Urethane Material

4,4-dicyclohexylmethane diisocyanate (Desmodur W) from Bayer (42.00 g, 0.16 mole) was degassed under vacuum at room temperature for two hours. PTE Dithiol 6 (32.00 g, 0.08 mole), DETDA (11.40 g, 0.064 mole) and DMDS (2.46 g, 0.016 mole) were mixed together and degassed under vacuum at room temperature for two hours. The two mixtures were then mixed together at the same temperature and charged between a preheated glass plates mold. The material was cured in a preheated oven at a temperature of 130° C. for 24 hours. The cured material was clear. The results were as follows: refractive index (e-line) of 1.582 (20° C.) and Abbe number of 40.

### Example 36

### Synthesis of Dithiol Oligomers

The starting materials shown in Table 2 were prepared according to the method specified in Table 2 and described below to yield a resulting dithiol oligomer having the properties shown in Table 2 for Entries 1-16.

TABLE 2
Oligomeric dithiols by reaction of
dithiol and mixture of dienes.

| | | | Calc. | | |
|---|---|---|---|---|---|
| | | | Mₙ | | |
| | Starting | | based | | |
| | Components | | on SH | | Viscosity^{□} |
| | Synthesis | Molar | analysis | Measured | Cp |
| Entry | Method | ratio | result | n_{D}, Abbe | (73° C.) |
| 1 | VCH/AM/DMDS | 2/2/5 | 1218 | 1.588, 41 | 236 |
| | Method 2 | | | | |
| 2 | VCH/1,5HD/DMDS | 2/2/5 | 1218 | Solid at | 152 |
| | Method 1 | | | RT | |
| 3 | VNB/EGDM/DMDS | 2/2/5 | 1346 | 1.580, 44 | 362 |
| | Method 2 | | | | |
| 4 | VNB/AM/DMDS | 2/2/5 | 1292 | 1.593, 41 | 329 |
| | Method 2 | | | | |
| 5 | VNB/AM/DMDS | 3/2/6 | 1529 | 1.596, 42 | 483 |
| | Method 2 | | | | |
| 6 | VNB/DEGDVE/ | 3/2/6 | 1630 | 1.590, 42 | 485 |
| | DMDS Method 1 | | | | |
| 7 | VNB/DEGDVE/ | 4/2/7 | 1888 | 1.593, 42 | 670 |
| | DMDS Method 1 | | | | |
| 8 | VNB/BDDVE/DMDS | 4/2/7 | 1792 | 1.606, | 993 |
| | Method 1 | | | | |
| 9 | VNB/DEGDVE/ | 4/2/7 | 1887 | 1.595, 42 | 861 |
| | DMDS Method 3 | | | | |
| 10 | VNB/BDDVE/ | 4/1/1/7 | 1824 | 1.595, 43 | 790 |
| | DEGDVE/DMDS | | | | |
| | Method 3 | | | | |
| 11 | VNB/DEGDVE/ | 2/1/4 | 1002 | 1.595, 42 | 272 |
| | DMDS Method 3 | | | | |
| 12 | VNB/DEGDVE/ | 2.33/ | 1308 | 1.590, 42 | 415 |
| | DMDS Method 3 | 1.28/ | | | |
| | | 4.65 | | | |
| 13 | DIPEB/DEGDVE/ | 2/1/ | 904 | 1.600, 38 | 191 |
| | DMDS Method 1 | 4.25 | | | |
| 14 | VCH/EGDM/DMDS | 2/1/4 | 1048 | 1.587 42 | 224 |
| | Method 2 | | | | |
| 15 | L/VNB/DMDS | 2/1/4 | 1024 | 1.597, 41 | 374 |
| | Method 3 | | | | |
| 16 | DIPEB/VNB/DMDS | 2/1/4 | 1086 | 1.614, 36 | 459 |
| | Method 3 | | | | |

DMDS - 2-mercaptoethylsulfide (DMDS, obtained from Nisso-Maruzen Chemical Company)
VCH - vinylcyclohexene
AM - allyl methacrylate (from Sartomer, USA)
VNB - 5-vinyl-2-norbornene (mixture of endo and exo isomers from Ineos Oxide, Belgium)
EGDM - ethylene glycol dimethacrylate (from Sartomer, USA)
DEGDVE - diethylene glycol divinyl Ether (from BASF, Germany)
BDDVE - 1,4-butanediol divinyl Ether (from BASF, Germany)
1,5-HD - 1,5-hexadiene (from Aldrich, USA)

Method 1. Synthesis of Dithiol Oligomer by Radical Initiated Polymerization.

Table 2, Entry 8: In a three-necked glass flask equipped with thermometer, using a magnetic stirrer, were mixed 48.0 grams (0.4 mole) of VNB and 28.4 grams (0.2 mole) of (BDDVE). The flask was emersed in an oil bath having a temperature between 40-42° C. With slight heating, 0.400 grams (0.5%) Vazo 52 radical initiator (2,2′-azobis(2,4-dimethylpentanenitrile, obtained from DuPont) was dissolved in 107.8 grams (0.7 mole) of DMDS. This solution was charged in a dropping funnel and the solution was added drop-wise to the mixture of two dienes. The reaction was exothermic and the temperature of the mixture did not exceed 60° C. After the addition was completed (total addition time was 4 hours), the temperature of the oil bath was increased to a temperature of 60° C. and the mixture was stirred at this temperature for 16 hours. The temperature was then increased to 75° C. and the mixture was stirred for another 4 hours. The SH analysis was conducted and showed SHEW (SH (mercaptan) equivalent weight) of 894. The mixture was stirred at a temperature of 60° C. for another 24 hours. The SH analysis was conducted and showed SHEW of 896. The Mₙ for the oligomeric mixture was calculated based on SHEW as 1792. The measured refractive index n_{D} (at 20° C.) was 1.606 and the viscosity of the mixture at 73° C. was 993 cP.

The mixture slowly crystallized upon cooling to room temperature but melted again upon heating with essentially no change in the SH content or the viscosity.

The polythiol oligomers in Entries 2, 6, 7 and 13 were also prepared according to Method 1 as described above, with the exception that the starting compounds and corresponding molar ratios as shown in Table 2 were used.

Method 2. Stepwise Synthesis of Block-Type Dithiol Oligomer, Using Base Catalysis and then Radical Initiation.

(Table 2, Entry 4): In a glass jar, equipped with magnetic stirrer, 63 grams (0.5 mole) of AM were mixed with 192.5 grams (1.25 mole) DMDS. To this mixture, upon stirring at room temperature, 3 drops of 1,8-diazabicyclo[5.4.0]undec-7-ene (DBU, obtained from Aldrich) were added. The temperature of the mixture increased slightly due to the exothermic reaction. The mixture was stirred at room temperature for 2 hours, and then 60 grams (0.5 mole) of VNB were added drop-wise with a rate such that the temperature of the reaction did not exceed 70° C. After the addition was completed (over a time period of 2 hours), 0.180 grams (0.5%) radical initiator Vazo 64 (2,2′-azobisisobutyronitrile, obtained from DuPont) was added and the mixture was heated at 70° C. for 15 hours. The SH group analysis was conducted and showed SHEW of 636 and viscosity at 73° C. of 291 cP. The mixture was heated for another 15 hours at 65° C. and the SH analysis then showed SHEW of 646 and viscosity of 329 cP at 73° C. The Mₙ for the oligomeric mixture based on SHEW was calculated as 1292. The measured refractive index n_{D} (at 20° C.) was 1.593 and the Abbe number was 41.

The mixture was a clear liquid and did not crystallize upon cooling.

The polythiol oligomers in Entries 1, 3, 5 and 14 were also prepared according to Method 2 as described above, with the exception that the starting compounds and corresponding molar ratios as shown in Table 2 were used.

Method 3. Stepwise Synthesis of Block-Type Dithiol Oligomers by Radical Initiation.

(Table 2, Entry 9): In a three-necked glass flask supplied with thermometer, dropping funnel and magnetic stirrer, were placed 215.6 grams (1.4 mole) of DMDS. The flask was emersed in an oil bath having a temperature between 40-42° C., and then 96.0 grams (0.8 mole) of VNB were added drop-wise with a rate such that the temperature of the reaction did not exceed 70° C. After the addition was completed (total addition time was 4 hours), the mixture was stirred until the temperature reached 60° C. The SH group analysis was conducted and showed SHEW of 250. Then 0.100 grams (0.03%) of Vazo 52 radical initiator was added and the mixture was stirred for 4 hours at a temperature of 60° C. To this mixture was added drop-wise at the same temperature, 63.2 grams (0.4 mole) of DEGDVE. After the addition was completed (total addition time was 1 hour). The mixture was stirred at this temperature for 1 hour. Then 0.100 grams (0.03%) of Vazo 52 radical initiator was added and the mixture was stirred for 15 hours at a temperature of 60° C. The SH analysis was conducted and showed SHEW of 943 and viscosity at 73° C. of 861 cP. The Mₙ for the oligomeric mixture based on SHEW was measured as 1887. The measured refractive index n_{D} (at 20° C.) was 1.595 and the Abbe number was 42.

The mixture was a clear liquid but it slowly crystallized upon cooling to room temperature.

The polythiol oligomers in Entries 10, 11, 12, 15 and 16 were also prepared according to Method 3 as described above, with the exception that the starting compounds and corresponding molar ratios as shown in Table 2 were used.

### Example 37

### Synthesis of PTE Dithiol 8 (DMDS/VNB 2:1 Mole Ratio)

308 grams of DMDS (2 moles) were charged to a glass jar and the contents were heated to a temperature of 60° C. To the jar was slowly added 120 grams of VNB (1 mole) with mixing. The addition rate was adjusted such that the temperature of the mixture did not exceed 70° C. Once the addition of VNB was completed, stirring of the mixture was continued at 60° C., and five 0.04 gram portions of VAZO 52 were added (one portion added once every hour). The mixture was then stirred at a temperature of 60° C. for an additional 3 hours, after which time the product was titrated and found to have an SH equivalent weight of 214 g/equivalent. The viscosity was 56 cps at 73° C., the refractive index n_{D}²⁰ was 1.605, and the Abbe number was 41.

### Example 38

### Synthesis of PTE Dithiol 9 (DMDS/DIPEB 2:1 Mole Ratio)

524.6 g of DMDS (3.4 moles) was charged to a glass jar, and the contents were heated to a temperature of 60° C. To the jar was slowly added 269 g of DIPEB (1.7 moles) with mixing. Once the addition of DIPEB was completed, the jar was placed in an oven heated to 60° C. for 2 hours. The jar was then removed from the oven; 0.1 g VAZO 52 was dissolved into the contents of the jar; and the jar was returned to the oven for a period of 20 hours. The resulting sample was titrated for SH equivalents and was found to have an equivalent weight of 145 g/equivalent. 0.1 g VAZO 52 was dissolved into the reaction mixture, which was then returned to the oven. Over a time period of 8 hours, the reaction mixture was kept in the 60° C. oven, and two more additions of 0.2 g VAZO 52 were made. After 17 hours, the final addition of VAZO 52 (0.2 g) was made, and the resulting sample was titrated, giving an equivalent weight of 238 g/equivalent. The viscosity of the material at 25° C. was 490 cps.

### Example 39

### Synthesis of PTE Dithiol 10 (2:1 DMDS/DIPEB)/VNB (2:1 Mole Ratio)

(Table 2, Entry 16): At ambient temperature, 285.6 g of PTE Dithiol 9 (0.6 moles) and 36.1 g VNB (0.3 moles) were charged to a glass jar and mixed. 0.1 g VAZO 52 was dissolved into the mixture, and the jar was subsequently placed in an oven heated to 72° C. After 16.5 hours the mixture was removed from the oven and, the resulting sample was titrated for SH equivalents and had an equivalent weight of 454 g/equivalent. An additional 0.1 g VAZO 52 was then added to the mixture, and the mixture was returned to the oven for 24 hours. After this time the mixture was removed from the oven and the equivalent weight of the resulting material was titrated and showed 543 g/equivalent. The viscosity at 73° C. was 459 cps, the refractive index n_{D}²⁰ was 1.614, and the Abbe number was 36.

### Example 40

### Synthesis of Polythiourethane Prepolymer and Chain Extension

TABLE 3
Polyurethane prepolymers from dithiol oligomers and their chain extended and cured products.

| | | Prepolymer | Catalyst, | | | Chain extension |
|---|---|---|---|---|---|---|
| | | SH/NCO eq. | Reaction | | | mixture (w/w) |
| | Isocyanates | ratio, | temperature, | | Prepolymer | Cured product, |
| Dithiol | Ratio by | NCO - | Reaction | Prepolymer | viscosity | n_{D}, Abbe, d, |
| components | weight | content (%) | time | n_{D}, Abbe | cP (73° C.) | Appearance |
| VCH/AM/DMDS | TMXDI/IPDI | 1/4 | DBTDL, | 1.554, 43 | 670 | DETDA/DMDS = |
| 2/2/5 | 3/7 | NCO = 12.5% | Polycat 8, | | | 2.8/1 |
| Mₙ = 1218 | | | No heating | | | 1.581, 39, |
| (Table 2, | | | 2 hours | | | d = 1.160 |
| Entry 1) | | | | | | Clear |
| VNB/AM/DMDS | TMXDI/IPDI | 1/4 | No catalyst | 1.566, 43 | 1404 | DETDA/DMDS = |
| 3/2/6 | 1/2 | NCO = 9.82% | 50° C., | | | 2.8/1 |
| Mₙ = 1529 | | | 16 hrs. | | | 1.589, 39 |
| (Table 2, | | | | | | d = 1.173 |
| Entry 5) | | | | | | Clear |
| VNB/AM/DMDS | Des W | 1/4 | No catalyst | 1.564, 46 | 1596 | DETDA/DMDS = |
| 3/2/6 | | NCO = 9.46% | 50° C., | | | 2.8/1 |
| Mₙ = 1529 | | | 16 hrs. | | | 1.584, 43 |
| (Table 2, | | | | | | d = 1.162 |
| Entry 5) | | | | | | Hazy |
| VNB/DEGDVE/DMDS | TMXDI/IPDI | 1/4 | Polycat 8 | 1.567, 43 | 910 | DETDA/DMDS = |
| 4/2/7 | 1/2 | NCO = 8.72% | No heating | | | 2.8/1 |
| Mₙ = 1888, | | | 2 hours | | | 1.590, 39 |
| (Table 2, | | | | | | d = 1.181 |
| Entry 7) | | | | | | Clear |
| VNB/DEGDVE/DMDS | TMXDI/IPDI | 1/4 | Polycat 8 | 1.567, 43 | 910 | DETDA only |
| 4/2/7 | 1/2 | NCO = 8.72% | No heating | | | 1.584, 40 |
| Mₙ = 1888 | | | 2 hours | | | d = 1.159 |
| (Table 2, | | | | | | Clear |
| Entry 7) | | | | | | |
| VNB/DEGDVE/DMDS | TMXDI/IPDI | 1/4 | Polycat 8 | 1.567, 43 | 910 | DETDA/DMDS = |
| 4/2/7 | 1/2 | NCO = 8.72% | No heating | | | 2.8/1 |
| Mₙ = 1888 | | | 2 hours | | | 1.588, 40 |
| (Table 2, | | | | | | d = 1.171 |
| Entry 7) | | | | | | Clear |
| VNB/DEGDVE/DMDS | Des W | 1/4.4 | Polycat 8 | 1.559, 46 | 888 | DETDA/HITT |
| 2.33/1.28/4.65 | | NCO = 11.71% | 65-70° C. | | | 1/1.35 |
| Mₙ = 1308 | | | 12 hours | | | 1.594, 41 |
| (Tasble 2 | | | | | | Clear |
| Entry 12) | | | | | | ≧13.3 J at CT 1 mm* |
| VNB/DEGDVE/DMDS | Des W | 1/3.75 | Polycat 8 | 1.561, 46 | 1175 | DETDA/ |
| 2/1/4 | | NCO = 11.78% | 70° C. | | | DT M_{N} = 1000 |
| Mₙ = 1002 | | | 12 hours | | | 1/1.12 |
| (Table 2 | | | | | | 1.584, 41 |
| Entry 11) | | | | | | Clear |
| | | | | | | ≧13.3 J at CT 1 mm* |
| DIPEB/DEGDVE/DMDS | Des W | 1/4.0 | Polycat 8 | 1.559, 44 | 719 | DETDA/HITT |
| 2/1/4.25 | | NCO = 12.66% | 70° C. | | | 1/1.40 |
| Mₙ = 904 | | | 12 hours | | | 1.592, 39 |
| (Table 2 | | | | | | Clear |
| Entry 13 | | | | | | ≧13.3 J at CT 1 mm* |
| DIPEB/VNB/DMDS | Des W | 1/4.2 | Polycat 8 | 1.560, 44 | 1363 | DETDA/ |
| 2/1/4 | | NCO = 11.90% | 70° C. | | | DIPEB.2DMDS |
| Mₙ = 1086 | | | 2 hours | | | 1/1.52 |
| (Table 2 | | | | | | Clear |
| Entry 16) | | | | | | 1.598, 38 |
| | | | | | | ≧13.3 J at CT 1 mm* |
| DIPEB/VNB/DMDS | Des W/ | 1/4.4 | Polycat 8 | 1.560, 43 | 1173 | DETDA/ |
| 2/1/4 | IPDI = | NCO = 12.30% | 65° C. | | | DIPEB.2DMDS |
| Mₙ = 1086 | 9/1 (by | | 2 hours | | | 1/1.52 |
| (Table 2 | weight) | | | | | Clear |
| Entry 16) | | | | | | 1.597, 38 |
| | | | | | | ≧13.3 J at CT 1 mm* |

DIPEP.2DMDS refers to dithiol oligomer prepared with 2 eq. Of DMDS with 1 eq. Of DIPEB
Des W - 4,4-dicyclohexylmethane diisocyanate (from Bayer, USA)
IPDI - 3-isocyanato-methyl-3,5,5-trimethyl cyclohexyl-isocyanate (from Degussa, Germany)
TMXDI - 1,3-bis(1-isocyanato-1-methylethyl)benzene (from Cytec, USA)
DETDA - 2,4-diamino-3,5-diethyl-toluene, 2,6-diamino-3,5-diethyl-toluene and mixtures thereof (collectively “diethyltoluenediamine” or “DETDA”), which is commercially available from Albemarle Corporation under the trade name Ethacure 100
DBTDL - dibutyltin dilaurate (obtained from Aldrich)
Polycat 8 - N,N-dimethylcyclohexylamine (from Air Products, USA)
d density in g/cm³
DT Mₙ = 1000 This is the dithiol oligomer described in (Table 2, Entry 11)
HITT is trithiol synthesized as described in Example 41.

The above Table 3 refers to the following ball sizes used and the corresponding impact energy.

| Ball weight, kg | Impact Energy, J |
|---|---|
| 0.016 | 0.20 |
| 0.022 | 0.27 |
| 0.032 | 0.40 |
| 0.045 | 0.56 |
| 0.054 | 0.68 |
| 0.067 | 0.83 |
| 0.080 | 1.00 |
| 0.094 | 1.17 |
| 0.110 | 1.37 |
| 0.129 | 1.60 |
| 0.149 | 1.85 |
| 0.171 | 2.13 |
| 0.198 | 2.47 |
| 0.223 | 2.77 |
| 0.255 | 3.17 |
| 0.286 | 3.56 |
| 0.321 | 3.99 |
| 0.358 | 4.46 |
| 0.398 | 4.95 |
| 1.066 | 13.30 |

The isocyanate and the dithiol components shown in Table 3 in the molar ratios shown in Table 3 were mixed at room temperature under a nitrogen atmosphere. The catalyst identified in Table 3 was then added and the mixture was stirred at the temperature and for the period of time specified in Table 3. The SH group analysis was performed for monitoring the progress of the reaction. The reaction was considered completed when the SH groups analysis showed substantially no SH group present in the reaction mixture. The properties of the prepolymer including NCO content (%), viscosity at 73° C. (cP) and refractive index (d-line) were measured and are shown in Table 3.

Wherein the prepolymer was chain extended with diamine and polythiol, the prepolymer was degassed under vacuum at a temperature of 60° C. for two hours and diamine and polythiol were mixed and degassed under vacuum at room temperature for 2 hours. The weight ratio of diamine/polythiol was as shown in Table 3 for each experiment. The molar ratio (NH₂+SH)/NCO was in all cases 0.95. The two mixtures were then mixed together at a temperature of 60° C. and charged between a preheated glass plates mold. The material was cured in a preheated oven at a temperature of 130° C. for 16 hours. The cured material had the appearance, refractive index, density and impact resistance as shown in Table 3.

### Example 41

### Synthesis of HITT (Formula (IV′m))

HITT material identified in Table 3 was prepared according to the following procedure. 1,2,4-trivinylcyclohexane (43.64 g, 0.269 mol) and DMDS (124.4 g, 0.808 mol) were mixed at room temperature. The mixture was heated to a temperature of 60° C. and maintained at this temperature for 1 hour. 50 mg Vazo 64 radical initiator obtained from DuPont was then added and the mixture was stirred for 16 hours at 60° C. The addition of 50 mg Vazo 64 radical initiator and subsequent heating for 16 hours at 60° C. was conducted two additional times. SH titration analysis of the mixture was conducted and showed SHEW=222. This analysis showed essentially the same value after one more cycle of catalyst addition and heating at 60° C. for 16 hours. The product was clear liquid having viscosity of 85 cP (73° C.), refractive index n_{d} of 1.606, Abbe of 39, refractive index nₑ of 1.610, and Abbe of 39. MS (Electrospray) showed signal at m/e 647 (M⁺+Na).

The invention has been described with reference to non-limiting embodiments. Obvious modifications and alterations can occur to others upon reading and understanding the detailed description. It is intended that the invention be construed as including all such modifications and alterations insofar as they come within the scope of the appended claims or the equivalents thereof.

We claim:

1. A sulfur-containing polyureaurethane adapted to have a refractive index of at least 1.57, an Abbe number of at least 32 and a density of less than 1.3 grams/cm³, when at least partially cured.

2. The sulfur-containing polyureaurethane of claim 1 wherein said Abbe number is at least 35.

3. The sulfur-containing polyureaurethane of claim 1 wherein said Abbe number is from 32 to 46.

4. The sulfur-containing polyureaurethane of claim 1 wherein said refractive index is at least 1.60.

5. The sulfur-containing polyureaurethane of claim 1 wherein said refractive index is at least 1.65.

6. The sulfur-containing polyureaurethane of claim 1 wherein said density is from 1.15 to less than 1.3 grams/cm³.

7. The sulfur-containing polyureaurethane of claim 1 wherein said density is from 1.0 to less than 1.3 grams/cm³.

8. The sulfur-containing polyureaurethane of claim 1 further comprising an impact strength of at least 2 joules using the Impact Energy Test.

9. The sulfur-containing polyureaurethane of claim 1 that is prepared by the reaction of:
(a) a sulfur-containing polyurethane prepolymer; and
(b) an amine-containing curing agent.

10. The sulfur-containing polyureaurethane of claim 9 wherein the sulfur-containing polyurethane prepolymer comprises the product of the reaction of:
(a) a sulfur-containing polyisocyanate, polyisothiocyanate, or mixture thereof; and
(b) an active hydrogen-containing material.

11. The sulfur-containing polyureaurethane of claim 10 wherein the sulfur-containing polyisocyanate, polyisothiocyanate, or mixture thereof; comprises a polyisothiocyanate.

12. The sulfur-containing polyureaurethane of claim 10 wherein the sulfur-containing polyisocyanate, polyisothiocyanate, or mixture thereof; comprises a mixture of a polyisothiocyanate and a polyisocyanate.

13. The sulfur-containing polyureaurethane of claim 10 wherein the active hydrogen-containing material comprises polyol.

14. The sulfur-containing polyureaurethane of claim 10 wherein the active hydrogen-containing material comprises polythiol.

15. The sulfur-containing polyureaurethane of claim 10 wherein the active hydrogen-containing material comprises a mixture of polyol and polythiol.

16. The sulfur-containing polyureaurethane of claim 10 wherein the active hydrogen-containing material is a hydroxyl functional polysulfide.

17. The sulfur-containing polyureaurethane of claim 16 wherein said hydroxyl functional polysulfide further comprises SH-functionality.

18. The sulfur-containing polyureaurethane of claim 15 wherein said polyol is chosen from polyester polyols, polycaprolactone polyols, polyether polyols, polycarbonate polyols, and mixtures thereof.

19. The sulfur-containing polyureaurethane of claim 10 wherein said active hydrogen-containing material has a number average molecular weight of from 200 grams/mole to 32,000 grams/mole as determined by GPC.

20. The sulfur-containing polyureaurethane of claim 19 wherein said active hydrogen-containing material has a number average molecular weight of from about 2,000 to 15,000 grams/molel as determined by GPC.

21. The sulfur-containing polyureaurethane of claim 9 wherein said prepolymer has a polyisocyanate plus polyisothiocyanate to hydroxyl equivalent ratio of from 2.0:1.0 to less than 5.5:1.0.

22. The sulfur-containing polyureaurethane of claim 13 wherein said polyol comprises a polyether polyol.

23. The sulfur-containing polyureaurethane of claim 22 wherein said polyether polyol is a block copolymer represented by the following structural formula:
HO—(CHR₁CHR₂—O)ₐ—(CHR₃CHR₄—O)_{b}—(CHR₅CHR₆—O)_{c}—H
wherein R₁, R₂, R₅, and R₆ are hydrogen and R₃ and R₄ are each independently chosen from hydrogen and methyl, with the proviso that R₃ and R₄ are different from one another; a, b, and c are each independently an integer from 1 to 300, wherein a, b and c are chosen such that the number average molecular weight of the polyol does not exceed 32,000 grams/mol as determined by GPC

24. The sulfur-containing polyureaurethane of claim 9 wherein said sulfur-containing polyurethane prepolymer comprises the reaction product of polyisocyanate, polyisothiocyanate and said active hydrogen-containing material, which are present such that the equivalent ratio of (NCO+NCS) to (SH+OH) is from 2.0:1.0 to less than 5.5:1.0. BOB/NINA—CONFIRM THIS RATIO.

25. The sulfur-containing polyureaurethane of claim 9 wherein said sulfur-containing polyurethane prepolymer and said amine-containing curing agent are present such that the equivalent ratio of (NH+SH+OH) to (NCO+NCS) is from 0.80:1.0 to 1.1:1.0.

26. The sulfur-containing polyureaurethane of claim 9 wherein the sulfur-containing polyurethane prepolymer comprises the product of the reaction of:
i. a polyisocyanate; and
ii. a sulfur-containing active hydrogen material.

27. The sulfur-containing polyureaurethane of claim 26 wherein the polyisocyanate is chosen from aliphatic polyisocyanates, cycloaliphatic polyisocyanates, aromatic polyisocyanates, and mixtures thereof.

28. The sulfur-containing polyureaurethane of claim 26 wherein said polyisocyanate is chosen from aliphatic diisocyanates, cycloaliphatic diisocyanates, aromatic diisocyanates, cyclic dimers and cyclic trimers thereof, and mixtures thereof.

29. The sulfur-containing polyureaurethane material of claim 26 wherein said polyisocyanate is chosen from 4,4′-methylenebis(cyclohexyl isocyanate) and isomeric mixtures thereof.

30. The sulfur-containing polyureaurethane of claim 26 wherein said polyisocyanate is chosen from trans, trans isomer of 4,4′-methylenebis(cyclohexyl isocyanate).

31. The sulfur-containing polyureaurethane of claim 26 wherein said polyisocyanate is chosen from 4,4′-methylene bis(cyclohexyl isocyanate); 3-isocyanato-methyl-3,5,5,-trimethyl-cyclohexyl isocyanate and mixtures thereof.

32. The sulfur-containing polyureaurethane of claim 26 wherein said polyisocyanate is chosen from 4,4′-methylene bis(cyclohexyl isocyanate); 3-isocyanato-methyl-3,5,5-trimethyl-cyclohexyl isocyanate; 1,3-bis(1-isocyanato-1-methylethyl-benzene), and mixtures thereof.

33. The sulfur-containing polyureaurethane of claim 26 wherein the sulfur-containing active hydrogen material is a SH-containing material.

34. The sulfur-containing polyureaurethane of claim 33 wherein the SH-containing material is a polythiol.

35. The sulfur-containing polyureaurethane of claim 34 wherein said polythiol is chosen from aliphatic polythiols, cycloaliphatic polythiols, aromatic polythiols, polymeric polythiols, polythiols containing ether linkages, polythiols containing one or more sulfide linkages or mixtures thereof.

36. The sulfur-containing polyureaurethane of claim 34 wherein the polythiol comprises at least one material represented by the following structural formulas:

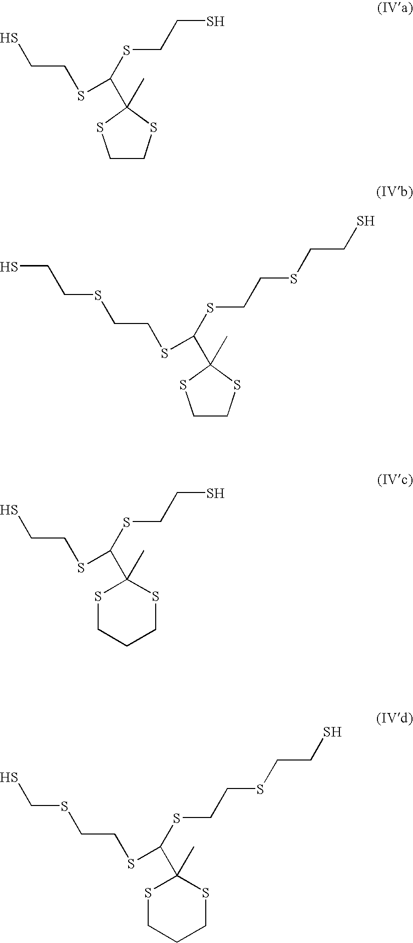

37. The sulfur-containing polyureaurethane of claim 34 wherein the polythiol comprises at least one material represented by the following structural formula: 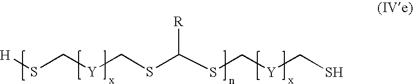
wherein R can represent CH₃, CH₃CO, C₁ to C₁₀ alkyl, cycloalkyl, aryl alkyl, or alkyl-CO; Y can represent C₁ to C₁₀ alkyl, cycloalkyl, C₆ to C₁₄ aryl,
wherein m can be an integer from 1 to 5 and, p and q can each be an integer from 1 to 10; n can be an integer from 1 to 30; and x can be an integer from 0 to 10.

38. The sulfur-containing polyureaurethane of claim 34 wherein the polythiol comprises at least one material represented by the following structural formulas: 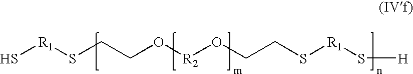
wherein R₁ is selected from C₂ to C₆ n-alkylene; C₃ to C₆ alkylene unsubstituted or substituted wherein substituents can be hydroxyl, methyl, ethyl, methoxy or ethoxy; or C₆ to C₈ cycloalkylene; R₂ is selected from C₂ to C₆ n-alkylene, C₂ to C₆ branched alkylene, C₆ to C₈ cycloalkylene, C₆ to C₁₀ alkylcycloalkylene or —[(CH₂—)ₚ—O—]_{q}—(—CH₂—)ᵣ—; m is a rational number from 0 to 10, n is an integer from 1 to 20, p is an integer from 2 to 6, q is an integer from 1 to 5, and r is an integer from 2 to 10. 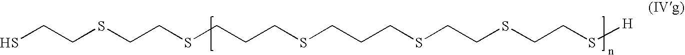
wherein n is an integer from 1 to 20 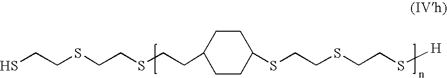
wherein n is an integer from 1 to 20 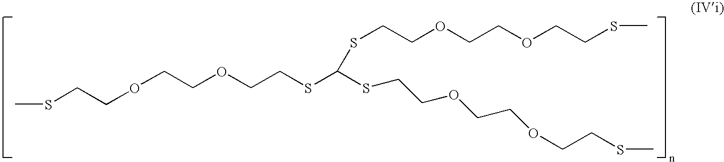
wherein n is an integer from 1 to 20 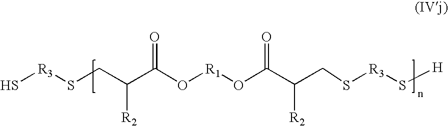
wherein n is an integer from 1 to 20; R₁ and R₃ are independently selected from C₁ to C₆ n-alkylene, C₂ to C₆ branch cycloalkylene, C₆ to C₁₀ alkylcycloalkylene, C₆ to C₈ aryl, C₆ to C₁₀ alkyl-aryl, C₁-C₁₀ alkyl containing ether linkages or thioether linkages or ester linkages or thioester linkages or combinations thereof, —[(CH₂—)ₚ—X—]_{q}—(—CH₂—)—ᵣ—, wherein X is selected from O or S, p is independently an integer from 2 to 6, q is independently an integer from 1 to 5, r is independently an integer from 0 to 10; R₂ is selected from hydrogen or methyl; 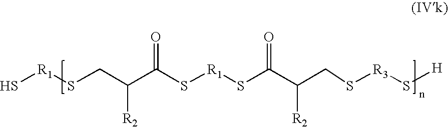
wherein n, R₁, R₂, and R₃ are as defined in Formula IV′ j. 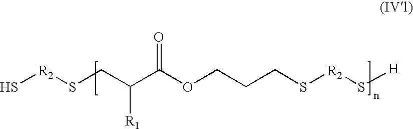
wherein n is an integer from 1 to 20; R₁ is selected from hydrogen or methyl; R₂ is selected from C₁ to C₆ n-alkylene, C₂ to C₆ branched alkylene, C₆ to C₈ cycloalkylene, C₆ to C₁₀ alkylcycloalkylene, C₆ to C₈ aryl, C₆ to C₁₀ alkyl-aryl, C₁-C₁₀ alkyl containing ether linkages or thioether linkages or ester linkages or thioester linkages or combinations thereof, or —[(CH₂—)ₚ—X—]_{q}—(—CH₂—)ᵣ—, wherein X is selected from O or S, p is independently an integer from 2 to 6, q is independently an integer from 1 to 5, r is independently an integer from 0 to 10; and 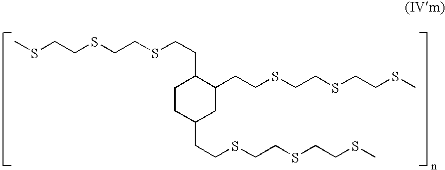
wherein n is an integer from 1 to 20

39. The sulfur-containing polyureaurethane of claim 34 wherein said polythiol is polythiol oligomer.

40. The sulfur-containing polyureaurethane of claim 39 wherein said polythiol oligomer is the reaction product of at least two different dienes and at least one dithiol; and wherein the stoichiometric ratio of the sum of the number of equivalents of dithiol to the sum of the number of equivalents of diene is greater than 1.0:1.0.

41. The sulfur-containing polyureaurethane of claim 39, wherein said polythiol oligomer is the reaction product of at least two different dienes, at least one dithiol, and at least one trifunctional or higher-functional polythiol; wherein the stoichiometric ratio of the sum of the number of equivalents of polythiol to the sum of the number of equivalents of diene is greater than 1.0:1.0.

42. The sulfur-containing polyureaurethane of claim 40 wherein said at least two different dienes comprises at least one non-cyclic diene and at least one cyclic diene.

43. The sulfur-containing polyureaurethane of claim 42 wherein said cyclic diene is selected from monocyclic non-aromatic dienes, polycyclic non-aromatic dienes and mixtures thereof, and aromatic ring-containing dienes.

44. The sulfur-containing polyureaurethane of claim 40 wherein said at least two different dienes comprises at least one aromatic ring-containing diene and at least one non-aromatic cyclic diene.

45. The sulfur-containing polyureaurethane of claim 44 wherein said non-aromatic cyclic diene is selected from monocyclic non-aromatic dienes, polycyclic non-aromatic dienes and mixtures thereof.

46. The sulfur-containing polyureaurethane of claim 40 wherein said at least two different dienes comprises at least one monocyclic non-aromatic diene and at least one polycyclic non-aromatic diene.

47. The sulfur-containing polyureaurethane of claim 26, wherein said sulfur-containing active hydrogen material comprises polythiol and at least one material selected from polyol, material containing both hydroxyl and SH groups, or combinations thereof.

48. The sulfur-containing polyureaurethane of claim 39 wherein said sulfur-containing active hydrogen material further comprises at least one material selected from polyol, or material containing both hydroxyl and SH groups, or mixtures thereof.

49. The sulfur-containing polyureaurethane of claim 33 wherein the SH-containing material comprises a mixture of polythiol and polyol free of sulfur.

50. The sulfur-containing polyureaurethane of claim 26 wherein the sulfur-containing active hydrogen material is a hydroxyl functional polysulfide.

51. The sulfur-containing polyureaurethane of claim 50 wherein said hydroxyl functional polysulfide further comprises SH-functionality.

52. The sulfur-containing polyureaurethane of claim 9 wherein said amine-containing curing agent comprises amine-containing and sulfur-containing materials.

53. The sulfur-containing polyureaurethane of claim 52 wherein said amine-containing curing agent comprises amine-containing material and at least one material chosen from polythiol, polyol or mixtures thereof.

54. The sulfur-containing polyureaurethane of claim 40, wherein amine-containing curing agent comprises amine-containing and sulfur-containing materials.

55. The sulfur-containing polyureaurethane of claim 54 wherein said amine-containing curing agent comprises amine-containing material and at least one material chosen from polythiol, polyol or mixtures thereof.

56. The sulfur-containing polyureaurethane of claim 26 wherein said sulfur-containing active hydrogen material is polythiol oligomer.

57. The sulfur-containing polyureaurethane of claim 56 wherein said sulfur-containing active hydrogen material further comprises polyol.

58. The sulfur-containing polyureaurethane of claim 56 wherein said sulfur-containing active hydrogen material further comprises at least one material selected from polyol and material containing both hydroxyl and SH groups.

59. The sulfur-containing polyureaurethane of claim 1 that is prepared by the reaction of:
i. a sulfur-containing polyisocyanate, polyisothiocyanate or mixture thereof;
ii. an active hydrogen-containing material; and
iii. an amine-containing curing agent.

60. The sulfur-containing polyureaurethane of claim 59 wherein (a) is polyisothiocyanate.

61. The sulfur-containing polyureaurethane of claim 59 wherein (a) is a mixture of polyisothiocyanate and a polyisocyanate.

62. The sulfur-containing polyureaurethane of claim 59 wherein the active hydrogen-containing material comprises polyol.

63. The sulfur-containing polyureaurethane of claim 59 wherein the active hydrogen-containing material comprises polythiol.

64. The sulfur-containing polyureaurethane of claim 59 wherein the active hydrogen-containing material comprises a mixture of polyol and polythiol.

65. The sulfur-containing polyureaurethane of claim 62 wherein said polyol is chosen from polyester polyols, polycaprolactone polyols, polyether polyols, polycarbonate polyols, and mixtures thereof.

66. The sulfur-containing polyureaurethane of claim 59 wherein said active hydrogen-containing material has a number average molecular weight of from 200 to 32,000 grams/moles as determined by GPC.

67. The sulfur-containing polyureaurethane of claim 65 wherein said polyether polyol is a block copolymer represented by the following structural formula:
HO—(CHR₁CHR₂—O)ₐ—(CHR₃CHR₄—O)_{b}—(CHR₅CHR₆—O)_{c}—H
wherein R₁, R₂, R₅, and R₆ are hydrogen and R₃ and R₄ are each independently chosen from hydrogen and methyl, with the proviso that R₃ and R₄ are different from one another; a, b, and c are each independently an integers from 1 to 300, wherein a, b and c are chosen such that the number average molecular weight of the polyol does not exceed 32,000 grams/mol as determined by GPC.

68. The sulfur-containing polyureaurethane of claim 1 that is prepared by the reaction of:
(a) polyisocyanate;
(b) sulfur-containing active hydrogen material; and
(c) amine-containing curing agent.

69. The sulfur-containing polyureaurethane of claim 68 wherein said amine-containing curing agent is sulfur-containing amine-containing curing agent.

70. The sulfur-containing polyureaurethane of claim 68, wherein said amine-containing curing agent comprises amine-containing and sulfur-containing materials.

71. The sulfur-containing polyureaurethane of claim 70 wherein said amine-containing curing agent comprises amine-containing material and at least one material chosen from polythiol, polyol or mixtures thereof.

72. The sulfur-containing polyureaurethane of claim 68 wherein the polyisocyanate is selected from aliphatic polyisocyanates, cycloaliphatic polyisocyanates, aromatic polyisocyanates, and mixtures thereof.

73. The sulfur-containing polyureaurethane of claim 68 wherein said polyisocyanate is chosen from aliphatic diisocyanates, cycloaliphatic diisocyanates, aromatic diisocyanates, cyclic dimers and cyclic trimers thereof, and mixtures thereof.

74. The sulfur-containing polyureaurethane of claim 68 wherein said polyisocyanate is chosen from 4,4′-methylene bis(cyclohexyl isocyanate); 3-isocyanato-methyl-3,5,5-trimethylcyclohexyl isocyanate and mixtures thereof.

75. The sulfur-containing polyureaurethane of claim 68 wherein said polyisocyanate is chosen from 4,4′-methylene bis(cyclohexyl isocyanate); 3-isocyanato-methyl-3,5,5,-trimethyl-cyclohexyl isocyanate, 1,3-bis(1-isocyanato-1-methylethyl-benzene), and mixtures thereof.

76. The sulfur-containing polyureaurethane of claim 68 wherein the sulfur-containing active hydrogen material is a SH-containing material.

77. The sulfur-containing polyureaurethane of claim 76 wherein the SH-containing material is polythiol.

78. The sulfur-containing polyureaurethane of claim 77 wherein said polythiol is chosen from aliphatic polythiols, cycloaliphatic polythiols, aromatic polythiols, polymeric polythiols, polythiols containing ether linkages, polythiols containing one or more sulfide linkages.

79. The sulfur-containing polyureaurethane of claim 77 wherein the polythiol comprises at least one of the following materials:

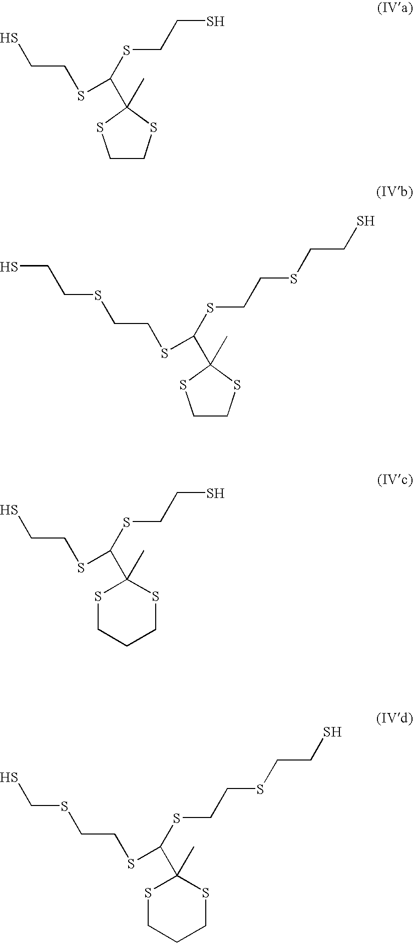

80. The sulfur-containing polyureaurethane of claim 77 wherein the polythiol comprises at least one material represented by the following structural formula: 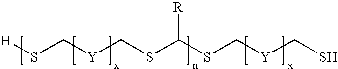
wherein R can represent CH₃, CH₃CO, C₁ to C₁₀ alkyl, cycloalkyl, aryl alkyl, or alkyl-CO; Y can represent C₁ to C₁₀ alkyl, cycloalkyl, C₆ to C₁₄ aryl, (CH₂)ₚ(S)ₘ(CH₂)_{q}, (CH₂)ₚ(Se)ₘ(CH₂)_{q}, (CH₂)ₚ(Te)ₘ(CH₂)_{q} wherein m can be an integer from 1 to 5 and, p and q can each be an integer from 1 to 10; n can be an integer from 1 to 20; and x can be an integer from 0 to 10.

81. The sulfur-containing polyureaurethane of claim 77 wherein the polythiol comprises at least one of the following materials: 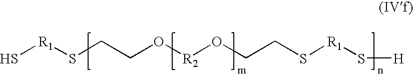
wherein R₁ is selected from C₂ to C₆ n-alkylene; C₃ to C₆ alkylene unsubstituted or substituted wherein substituents can be hydroxyl, methyl, ethyl, methoxy or ethoxy; or C₆ to CB cycloalkylene; R₂ is selected from C₂ to C₆ n-alkylene, C₂ to C₆ branched alkylene, C₆ to C₈ cycloalkylene, C₆ to C₁₀ alkylcycloalkylene or —[(CH₂—)ₚ—O—]_{q}—(—CH₂—)ᵣ—; m is a rational number from 0 to 10, n is an integer from 1 to 20, p is an integer from 2 to 6, q is an integer from 1 to 5, and r is an integer from 2 to 10. 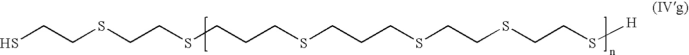
wherein n is an integer from 1 to 20. 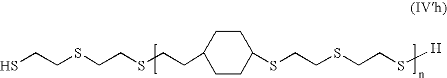
wherein n is an integer from 1 to 20. 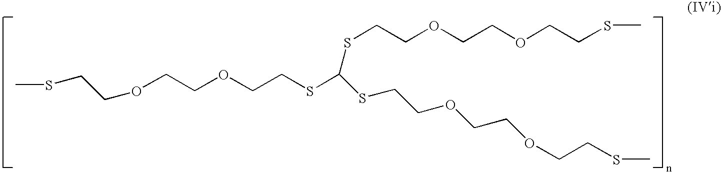
wherein n is an integer from 1 to 20. 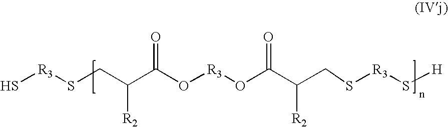
wherein n is an integer from 1 to 20; R₁ and R₃ are independently C₁ to C₆ n-alkylene, C₂ to C₆ branched alkylene, C₆ to C₈ cycloalkylene, C₆ to C₁₀ alkylcycloalkylene, C₆ to C₈ aryl, C₆ to C₁₀ alkyl-aryl, C₁-C₁₀ alkyl containing ether linkages or thioether linkages or ester linkages or thioester linkages or combinations thereof, —[(CH₂—)ₚ—X—]_{q}—(—CH₂—)ᵣ—, X is selected from O or S, p is independently an integer from 2 to 6, q is independently an integer from 1 to 5, r is independently an integer from 0 to 10; R₂ is selected from hydrogen or methyl; 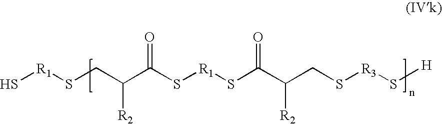
wherein n, R₁, R₂, and R₃ are as defined in Formula IV′j 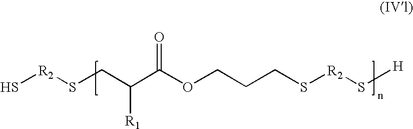
wherein n is an integer from 1 to 20; R₁ is selected from hydrogen or methyl; R₂ is selected from C₁ to C₆ n-alkylene, C₂ to C₆ branched alkylene, C₆ to C₈ cycloalkylene, C₆ to C₁₀ alkylcycloalkylene, C₆ to C₈ aryl, C₆ to C₁₀ alkyl-aryl, C₁-C₁₀ alkyl containing ether linkages or thioether linkages or ester linkages or thioester linkages or combinations thereof, or —[(CH₂—)ₚ—X—]_{q}—(—CH₂—)ᵣ—, X is selected from O or S, p is independently an integer from 2 to 6, q is independently an integer from 1 to 5, r is independently an integer from 0 to 10;
and 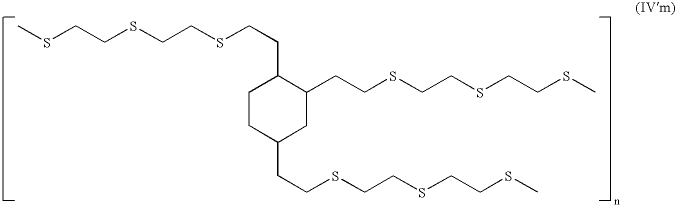
wherein n is an integer from 1 to 20.

82. The sulfur-containing polyureaurethane of claim 68 wherein said sulfur-containing active hydrogen material comprises at least one polythiol oligomer.

83. The sulfur-containing polyureaurethane of claim 82 wherein said polythiol oligomer is the reaction product of at least two different dienes and at least one dithiol, wherein the stoichiometric ratio of the sum of the number of equivalents of dithiol to the sum of the number of equivalents of diene is greater than 1.0:1.0.

84. The sulfur-containing polyureaurethane of claim 82, wherein said polythiol oligomer is the reaction product of at least two different dienes, at least one dithiol, and at least one trifunctional or higher-functional polythiol.

85. The sulfur-containing polyureaurethane of claim 83 wherein said at least two different dienes comprises at least one non-cyclic diene and at least one cyclic diene.

86. The sulfur-containing polyureaurethane of claim 85 wherein said cyclic diene is selected from monocyclic non-aromatic dienes, polycyclic non-aromatic dienes and mixtures thereof, and aromatic ring-containing dienes.

87. The sulfur-containing polyureaurethane of claim 83 wherein said at least two different dienes comprises at least one aromatic ring-containing diene and at least one non-aromatic cyclic diene.

88. The sulfur-containing polyureaurethane of claim 87 wherein said non-aromatic cyclic diene is selected from monocyclic non-aromatic dienes, polycyclic non-aromatic dienes and mixtures thereof.

89. The sulfur-containing polyureaurethane of claim 83 wherein said at least two different dienes comprises at least one monocyclic non-aromatic diene and at least one polycyclic non-aromatic diene.

90. The sulfur-containing polyureaurethane of claim 76 wherein the SH-containing material comprises a mixture of polythiol and polyol.

91. The sulfur-containing polyureaurethane of claim 76 wherein the SH-containing material comprises a mixture of polythiol and polyol free of sulfur.

92. The sulfur-containing polyureaurethane of claim 68 wherein the sulfur-containing active hydrogen material is a hydroxyl functional polysulfide.

93. The sulfur-containing polyureaurethane of claim 92 wherein said hydroxyl functional polysulfide further comprises SH-functionality.

94. The sulfur-containing polyureaurethane of claim 68 wherein said amine-containing curing agent is a mixture of amine-containing material and at least one material chosen from polythiol, polyol and mixtures thereof.

95. The sulfur-containing polyureaurethane of claim 94 wherein said polythiol is polythiol oligomer.

96. The sulfur-containing polyureaurethane of claim 9 wherein said amine-containing curing agent is a polyamine having at least two functional groups independently chosen from primary amine (—NH₂), secondary amine (—NH—), and combinations thereof.

97. The sulfur-containing polyureaurethane of claim 96 wherein said polyamine is chosen from aliphatic polyamines, cycloaliphatic polyamines, aromatic polyamines, and mixtures thereof.

98. The sulfur-containing polyureaurethane of claim 96 wherein said polyamine is represented by the following structural following formula and mixtures thereof: 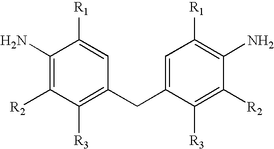
wherein R₁ and R₂ are each independently chosen from methyl, ethyl, propyl, and isopropyl groups, and R₃ is chosen from hydrogen and chlorine.

99. The sulfur-containing polyureaurethane of claim 9 wherein said amine-containing curing agent is 4,4′-methylenebis(3-chloro-2,6-diethylaniline).

100. The sulfur-containing polyureaurethane of claim 9 wherein said amine-containing curing agent is chosen from 2,4-diamino-3,5-diethyl-toluene; 2,6-diamino-3,5-diethyl-toluene and mixtures thereof.

101. The sulfur-containing polyureaurethane of claim 9 wherein said prepolymer and amine-containing curing agent are present in amounts such that the NCO/NH₂ equivalent ratio is from 1.0 NCO/0.60 NH₂ to 1.0 NCO/1.20 NH₂.

102. A sulfur-containing polyureaurethane adapted to have a refractive index of at least 1.57, an Abbe number of at least 32 and a density of less than 1.3 grams/cm³, when at least partially cured, that is prepared by the reaction of:
(a) a polyurethane prepolymer; and
(b) an amine-containing curing agent,
wherein at least one of (a) and (b) is a sulfur-containing material.

103. The sulfur-containing polyureaurethane of claim 102 wherein said polyurethane prepolymer comprises the reaction product of:
(a) polyisocyanate, polyisothiocyanate, or mixtures thereof; and
(b) active hydrogen-containing material.

104. The sulfur-containing polyureaurethane of claim 103 wherein said active hydrogen material is chosen from polyols, polythiols, and mixtures thereof.

105. The sulfur-containing polyureaurethane of claim 102 wherein said amine-containing curing agent comprises polyamine having at least two functional groups independently chosen from primary amine (—NH₂), secondary amine (—NH—), and combinations thereof.

106. The sulfur-containing polyureaurethane of claim 105 wherein said amine-containing curing agent further comprises at least one material chosen from polyol, polythiol, and mixtures thereof.

107. The sulfur-containing polyureaurethane of claim 106 wherein said polythiol is polythiol oligomer.

108. A method of preparing a sulfur-containing polyureaurethane comprising:
(a) reacting polyisothiocyanate or a mixture of polyisocyanate and polyisothiocyanate, and an active hydrogen-containing material to form polyurethane prepolymer; and
(b) reacting said polyurethane prepolymer with amine-containing curing agent,
wherein said polyureaurethane is adapted to have a refractive index of at least 1.57, an Abbe number of at least 32 and a density of less than 1.3 grams/cm³, when at least partially cured.

109. The method of claim 108 further comprising reacting said polyurethane prepolymer in step (a) with an episulfide-containing material.

110. The method of claim 108 wherein said active hydrogen-containing material comprises a polyol free of sulfur.

111. The method of claim 108 wherein said active hydrogen-containing material comprises polythiol.

112. The method of claim 108 wherein said active hydrogen-containing material comprises a mixture of polyol free of sulfur and polythiol.

113. A method of preparing a sulfur-containing polyureaurethane comprising:
(a) reacting polyisocyanate with sulfur-containing active hydrogen-containing material to form polyurethane prepolymer; and
(b) reacting said polyurethane prepolymer with amine-containing curing agent,
wherein said polyureaurethane is adapted to have a refractive index of at least 1.57, an Abbe number of at least 32 and a density of less than 1.3 grams/cm³, when at least partially cured.

114. The method of claim 113 wherein said polyisocyanate is chosen from aliphatic polyisocyanates, cycloaliphatic polyisocyanates, aromatic polyisocyanates, and mixtures thereof.

115. The method of claim 113 wherein said sulfur-containing active hydrogen-containing material is SH-containing material.

116. The method of claim 115 wherein said SH-containing material is polythiol.

117. The method of claim 113 wherein said sulfur-containing active hydrogen-containing material comprises a mixture of polythiol and polyol.

118. The method of claim 115 wherein said SH-containing material comprises a mixture of polythiol and polyol free of sulfur.

119. The method of claim 113 wherein said sulfur-containing active hydrogen-containing material is a hydroxyl functional polysulfide.

120. The method of claim 113 further comprising reacting said polyurethane prepolymer in step (a) with an episulfide-containing material.

121. The method of claim 113 wherein said amine-containing curing agent is a sulfur-containing amine-containing curing agent.

122. The method of claim 113 wherein said amine-containing curing agent comprises amine-containing and sulfur-containing materials.

123. The method of claim 113 wherein said amine-containing curing agent comprises amine-containing material and at least one polythiol, and optionally polyol.

124. An optical article comprising a sulfur-containing polyureaurethane, wherein said polyureaurethane is adapted to have a refractive index of at least 1.57, an Abbe number of at least 32 and a density of less than 1.3 grams/cm³ when at least partially cured.

125. An ophthalmic lens comprising a sulfur-containing polyureaurethane, wherein said polyureaurethane is adapted to have a refractive index of at least 1.57, an Abbe number of at least 32 and a density of less than 1.3 grams/cm³, when at least partially cured.

126. A photochromic article comprising a sulfur-containing polyureaurethane, wherein said polyureaurethane is adapted to have a refractive index of at least 1.57, an Abbe number of at least 32 and a density of less than 1.3 grams/cm³.

127. The photochromic article of claim 126 wherein it comprises an at least partially cured substrate, and at least a photochromic amount of a photochromic substance.

128. The photochromic article of claim 127 wherein said photochromic substance is at least partially imbibed into said substrate.

129. The photochromic article of claim 127 wherein said substrate is at least partially coated with a coating composition comprising at least a photochromic amount of a photochromic substance.

130. The photochromic article of claim 127 wherein said photochromic substance comprises at least one naphthopyran.

131. The photochromic article of claim 127 wherein said photochromic substance is chosen from spiro(indoline)naphthoxazines, spiro(indoline)benzoxazines, benzopyrans, naphthopyrans, organo-metal dithizonates, fulgides and fulgimides, and mixtures thereof.

132. A photochromic article comprising a sulfur-containing polyureaurethane, an at least a partially cured substrate, a photochromic amount of a photochromic material wherein said photochromic is at least partially imbibed into said substrate, and
